(19) United States
(12) Patent Application Publication
(10) Pub. No.: US 2024/0300054 A1
(43) Pub. Date: Sep. 12, 2024

(54) Circular Saws, Miter Saws, And Table Saws That Replace Blades With High Power Laser Emitters

(71) Applicant: Glowforge, Inc., Seattle, WA (US)

(72) Inventors: Daniel Shapiro, Seattle, WA (US); Mark Gosselin, Seattle, WA (US); Michael Natkin, Seattle, WA (US)

(21) Appl. No.: 18/600,847

(22) Filed: Mar. 11, 2024

Related U.S. Application Data
(60) Provisional application No. 63/451,182, filed on Mar. 9, 2023.

(51) Int. Cl. B23K 26/38; B23K 26/08

(52) U.S. Cl. CPC B23K 26/38; B23K 26/0869

(57) ABSTRACT

Disclosed embodiments include laser cutting tools. Some laser cutting tool embodiments include (i) at least one laser source configured to generate at least one laser beam having sufficient power to cut material, (ii) one or more processors, and (iii) tangible, non-transitory computer-readable memory comprising program instructions executable by the one or more processors to cause the laser cutting tool to perform laser cutting tool functions. In some embodiments, the functions include causing a cutting path to be projected onto a surface of a material, and controlling the at least one laser source to apply the at least one laser beam onto the material sufficient to implement a cut along the cutting path projected onto the surface of the material.

### CROSS-REFERENCE TO RELATED APPLICATIONS

This application claims priority to U.S. Prov. App. 63/451,182, titled “Laser Tools, Three-Dimensional Laser Printers, and Methods for Use Therewith,” filed on Mar. 9, 2023, and currently pending. The entire contents of App. No. 63/451,182 are incorporated herein by reference.

### OVERVIEW

Computer-controlled manufacturing systems, such as “3-D printers,” laser cutter/engravers, computer numerically-controlled (CNC) milling machines, and the like, can be used to fabricate complicated objects. Such manufacturing systems typically operate based on instructions that specify the cuts, engravings, patterns, and other actions to be performed by a Computer Numerical Control (CNC) machine. The instructions implemented by the CNC machine to process materials are often in the form of computer files transferred to the memory of a computer controller for the CNC machine and interpreted at run-time to provide a series of steps in the manufacturing process.

The embodiments disclosed herein relate to new types of laser cutting tools for new use cases that present several technical challenges which are addressed by new features and functions implemented by the new laser cutting tools disclosed herein. For example, some of the disclosed laser cutting tool embodiments are sometimes generally referred to herein as miter lasers. However, the laser cutting tool embodiments disclosed herein include many other types of laser cutting tools as well.

Traditional miter saws, also called chop saws, have a circular blade that is attached to a rotating arm that can be used to cut material in a single axis. So called compound miter saws enhance this by allowing for movement of the saw blade parallel to the blade, so that the saw can cut more widely. Radial arm saws increase this capability with more sliding travel and more rotation options.

Some laser cutting tools overcome some of the drawbacks of traditional miter saws and provide additional capabilities not available with traditional miter saws by offering omni-directional cutting of material among multiple angles as well as precision design cuts or engravings within or upon a material.

Accordingly, the embodiments disclosed herein employ certain aspects and features of laser CNC machines to implement laser-based tools, including but not limited to laser-based cutting tools, referred to herein generally as laser cutting tools.

Some example embodiments disclosed herein include a laser cutting tool that comprises (i) at least one laser source configured to generate at least one laser beam having sufficient power to cut material, (ii) one or more processors, and (iii) tangible, non-transitory computer-readable memory comprising program instructions, wherein the program instructions, when executed by the one or more processors, cause the laser cutting tool to perform one or more functions. The laser source may be any type of laser source now known or later developed, including but not limited to Carbon Dioxide (CO₂) lasers, Quantum Cascade Lasers (QCL), or any other type of laser suitable for cutting and/or engraving materials such as wood, metal, plastics, stone/rock, glass, wood-plastic composites, or other building, fabrication, construction, or fabrication materials.

In some embodiments, the functions include (i) causing a cutting path to be projected onto a surface of a material, and (ii) controlling the at least one laser source to apply the at least one laser beam onto the material sufficient to implement a cut along the cutting path projected onto the surface of the material.

In some examples, causing the cutting path to be projected onto the surface of the material includes causing a design to be projected onto the surface of the material, where the design includes the cutting path. In some instances, the cutting path includes one or more of (i) a cross cut, (ii) a rip cut, (iii) one or more holes, (iv) one or more notches, (v) one or more engravings, or (vi) one or more etchings.

Causing the cutting path to be projected onto the surface of the material in some examples includes projecting the cutting path onto the surface of the material via at least one of (a) a physical projector incorporated within the laser cutting tool or (b) a physical projector separate from the laser cutting tool. In some embodiments, causing the cutting path to be projected onto the surface of the material in some examples includes projecting the cutting path onto the surface of the material within an augmented reality space viewable by a user via an augmented reality headset or other suitable augmented realty device.

Causing the cutting path to be projected onto the surface of the material in some examples includes detecting at least one of (i) whether a projector configured to project the cutting path onto the surface of the material has moved relative to the material or (ii) whether the material has been moved relative to the projector configured to project the cutting path onto the surface of the material.

After detecting that the projector has moved relative to the material, some embodiments include updating the projection of the cutting path such that the cutting path projected along the surface of the material after the projector was moved is substantially the same as the cutting path along the surface of the material before the projector was moved. Additionally or alternatively, after detecting that the material has moved relative to the projector, some embodiments include updating the projection of the cutting path such that the cutting path projected along the surface of the material after the material was moved is substantially the same as the cutting path along the surface of the material before the material was moved.

In some embodiments, causing the cutting path to be projected onto the surface of the material includes determining one or more points of the cutting path based on one or more dimensions of the material detected by one or more sensors associated with the laser cutting tool.

In some laser tool embodiments, the at least one laser source includes several laser sources. In some examples, the laser tool includes one or more lasers configured to apply one or more laser beams to the top of a material (e.g., via downward-firing lasers) and/or one or more lasers configured to apply one or more laser beams to the bottom of a material (e.g., via upward-firing lasers). The several lasers may have different configurations and orientations relative to each other in different embodiments, depending on the particular laser cutting tool. Further, in some embodiments with several lasers, individual lasers are configured to apply laser beams at differing focal lengths to accommodate thicker materials, where each laser is configured to cut the material at different depths.

Controlling at least one laser source to apply the at least one laser beam onto the material sufficient to implement a cut along the cutting path projected onto the surface of the material in some embodiments includes, among other aspects, (i) monitoring the application of the laser beam to the material during operation of the laser tool, and (ii) adjusting the application of the laser beam to the material so that the laser beam follows the cutting path projected onto the surface of the material. Adjusting the application of the laser beam to the material so that the laser beam follows the cutting path projected onto the surface of the material in some examples includes moving the laser beam (e.g., via a laser head, mirrors, galvanometers, or other laser control mechanisms) to track an intended design, thereby generating much more accurate cuts than a traditional, user-operated saw tools.

Controlling the at least one laser source to apply the at least one laser beam onto the material sufficient to implement a cut along the cutting path projected onto the surface of the material in some embodiments includes, while applying the at least one laser beam onto the material sufficient to implement the cut along the cutting path, detecting at least one of (i) whether the laser cutting tool has been moved relative to the material or (ii) whether the material has been moved relative to the laser cutting tool.

After detecting that the laser cutting tool has been moved relative to the material, some embodiments include determining whether the laser cutting tool can continue to apply the at least one laser beam onto the material sufficient to implement the cut along the cutting path. After determining that the laser cutting tool can continue to apply the at least one laser beam onto the material sufficient to implement the cut along the cutting path after the laser cutting tool has been moved relative to the material, some examples further include controlling application of the at least one laser beam such that the at least one laser beam continues to be applied onto to the material sufficient to implement the cut along the cutting path. After determining that the laser cutting tool cannot continue to apply the at least one laser beam onto the material sufficient to implement the cut along the cutting path after the laser cutting tool has been moved relative to the material, some examples include shutting off the at least one laser beam.

After detecting that the material has been moved relative to the laser cutting tool, some embodiments include determining whether the laser cutting tool can continue to apply the at least one laser beam onto the material sufficient to implement the cut along the cutting path. After determining that the laser cutting tool can continue to apply the at least one laser beam onto the material sufficient to implement the cut along the cutting path after the material has been moved relative to the laser cutting tool, some examples include controlling application of the at least one laser beam such that the at least one laser beam continues to be applied onto to the material sufficient to implement the cut along the cutting path. And after determining that the laser cutting tool cannot continue to apply the at least one laser beam onto the material sufficient to implement the cut along the cutting path after the material has been moved relative to the laser cutting tool, some examples include shutting off the at least one laser beam.

Some laser tool embodiments additionally include (i) a base configured to support at least a portion of the material while the laser cutting tool (a) causes the cutting path to be projected onto the surface of the material and (b) controls the at least one laser source to apply the at least one laser beam onto the material sufficient to implement the cut along the cutting path projected onto the surface of the material, and (ii) an arm configured to apply the at least one laser beam onto the material while at least a portion of the material is supported on the base.

In some such laser tool embodiments, the at least one laser beam comprises a first laser beam and a second laser beam, and while at least a portion of the material is supported on the base, (i) the arm is configured to apply the first laser beam onto a top of the material and (ii) the base is configured to apply the second laser beam onto a bottom of the material.

Some disclosed laser tool embodiments additionally include at least one riving knife configured to fit within a kerf created by the at least one laser beam while implementing the cut along the cutting path projected onto the surface of the material. Some embodiments additionally include at least one beam dump configured to absorb laser power of the at least one laser source that passes through the kerf while implementing the cut along the cutting path projected onto the surface of the material.

And some laser tool embodiments further include a cooling system. In some examples, the cooling system is configured to pass pneumatic air across at least one laser diode of the at least one laser source and out of a nozzle at an air pressure sufficient to blow fumes and debris away from where the at least one laser beam is applied onto the material.

Laser tools having the above-described features and additional features and variations thereon are disclosed and described further herein.

### BRIEF DESCRIPTION OF THE DRAWINGS

FIG. 1A shows a side view of selected internal components of an example laser cutting tool according to some embodiments.

FIG. 1B shows a top view of selected internal components of an example laser cutting tool according to some embodiments.

FIG. 2 depicts a system diagram illustrating an example of a computer numerically controlled processing system according to some embodiments.

FIG. 3 depicts a block diagram illustrating an example computing system according to some embodiments.

FIG. 4A shows several perspective views of an example portable laser cutter according to some embodiments.

FIG. 4B shows a perspective view of an example portable laser cutter according to some embodiments.

FIG. 5 shows a perspective view of an example portable laser cutter according to some embodiments, including an inset illustrating an example user interface screen on the top of the portable laser cutter, where the user interface screen shows an image of an object upon which the portable laser cutter is implementing a design.

FIG. 6 shows a perspective view of an example portable laser cutter implementing a design onto a material beneath the portable laser cutter according to some embodiments.

FIG. 7 shows a plurality of example portable laser cutters configured to operate in a coordinated fashion under the direction and control of a network connected computer processing device.

FIG. 8A shows an example large design on a wall that can be implemented by one or more portable laser cutters according to some embodiments.

FIG. 8B shows several example portable laser cutters implementing a portion of the design depicted in FIG. 8A.

FIG. 9A shows a top view of an example handheld laser straight-line cutter cutting a material according to some embodiments.

FIG. 9B shows a side view of an example handheld laser straight-line cutter cutting a material according to some embodiments.

FIG. 9C shows a side view of an example handheld laser straight-line cutter cutting material according to some embodiments.

FIG. 9D shows a side view of an example handheld laser straight-line cutter with a cup according to some embodiments, where the cup is arranged to reflect laser power back to the handheld laser straight-line cutter when the laser of the handheld laser straight-line cutter has cut through the material.

FIG. 9E shows a side view of an example handheld laser straight-line cutter with a cup according to some embodiments, where the cup is arranged to decohere and/or scatter laser light of the laser of the handheld laser straight-line cutter when the laser of the handheld laser straight-line cutter has cut through the material.

FIG. 9F shows a side view of an example handheld laser straight-line cutter with a cup according to some embodiments, where during operation of the handheld laser straight-line cutter, the cup is held in place under the material by magnets in the handheld laser straight-line cutter.

FIG. 9G shows another side view of an example handheld laser straight-line cutter with a cup according to some embodiments, where during operation of the handheld laser straight-line cutter, the cup is held in place under the material by magnets in the handheld laser straight-line cutter.

FIG. 10A shows a top view of an example handheld laser omni-directional saw cutting material according to some embodiments.

FIG. 10B shows a side view of an example handheld laser omni-directional saw projecting a design onto the surface of a material being cut by the handheld laser omni-directional saw according to some embodiments.

FIG. 10C shows a side view of an example handheld laser omni-directional saw projecting a design onto the surface of a material being cut by the handheld laser omni-directional saw according to some embodiments, where the handheld laser omni-directional saw includes magnets arranged to hold a cup under the surface of the material.

FIG. 10D shows a side view of an example handheld laser omni-directional saw with a cup according to some embodiments, where the cup is arranged to reflect laser power back to the handheld laser omni-directional saw when the laser of the handheld laser omni-directional saw has cut through the material.

FIG. 10E shows a side view of an example handheld laser omni-directional saw with a cup according to some embodiments, where the cup is arranged to decohere and/or scatter laser light of the laser of the handheld laser omni-directional saw when the laser of handheld laser omni-directional saw has cut through the material.

FIG. 10F shows a side view of an example handheld laser omni-directional saw with a cup according to some embodiments, where during operation of the handheld laser omni-directional saw, the cup is held in place under the material by magnets in the handheld laser omni-directional saw.

FIG. 10G shows another side view of an example handheld laser omni-directional saw with a cup according to some embodiments, where during operation of the handheld laser omni-directional saw, the cup is held in place under the material by magnets in the handheld laser omni-directional saw.

FIG. 10H shows a top view and a side view of an example handheld laser omni-directional saw cutting a design into a material according to some embodiments.

FIG. 11A shows a side view of an example free-standing laser tool cutting a material according to some embodiments.

FIG. 11B shows another side view of an example free-standing laser tool cutting a material according to some embodiments.

FIG. 11C shows a top view of an example free-standing laser tool cutting material according to some embodiments.

FIG. 11D shows another top view of an example free-standing laser tool cutting material according to some embodiments.

FIG. 12 shows a perspective view of an example glass CO₂ laser tube.

FIG. 13 shows a perspective view of an example laser tube according to some embodiments.

FIG. 14 shows a side view of an example laser tube according to some embodiments.

FIG. 15 shows a rear view of an example laser tube according to some embodiments.

FIG. 16 shows another perspective view of an example laser tube according to some embodiments.

FIG. 17 shows another rear view of an example laser tube according to some embodiments.

FIG. 18A shows a side view of an example arrangement of downward firing lasers for use in laser cutting tools according to some embodiments.

FIG. 18B shows a side view of another example arrangement of downward firing lasers for use in laser cutting tools according to some embodiments.

FIG. 18C shows a side view of an example arrangement of downward firing and

upward firing lasers for use in laser cutting tools according to some embodiments.

FIG. 18D shows a side view of an example arrangement of upward firing lasers for use in laser cutting tools according to some embodiments.

FIG. 18E shows a side view of an example laser cutting tool with rollers according to some embodiments.

FIG. 18F shows a side view of an example laser cutting tool with rollers and a riving knife according to some embodiments.

FIG. 19 shows side and top views of an example laser cutting tool with a cup according to some embodiments.

The details of one or more variations of the subject matter described herein are set forth in the accompanying drawings and the description below. Other features and advantages of the subject matter described herein will be apparent from the description and drawings, and from the claims. While certain features of the currently disclosed subject matter may be described for illustrative purposes in relation to performing certain functions, it should be readily understood that such features are not intended to be limiting.

Various embodiments are possible, and each of the embodiments can be used alone or together in combination.

### DETAILED DESCRIPTION

A computer numerically controlled (CNC) machine may affect, in a material, one or more changes (e.g., cuts, scores, engravings, and/or the like) corresponding to one or more user-specified designs. With subtractive manufacturing, the computer numerically controlled machine may achieve the intended final appearance of the material by removing portions of the material. The CNC machines disclosed and described herein are capable of processing many different types of materials (e.g., paper, leather, acrylic, wood, metal, etc.). Additionally, the materials processed by the CNC machines may have different thicknesses.

In some scenarios, the material to be processed is placed on a material bed within the CNC machine or on the bottom of the CNC machine (with the CNC machine's material bed removed), and the CNC machine moves a downward-firing laser over the material (and/or moves the material under the laser) to process the material.

In some scenarios, the material to be processed is placed on a surface or suspended between two supports, and the CNC machine is placed over the material, and the CNC machine moves a downward-firing laser over the material to process the material.

In some scenarios, the material is fed through the CNC machine (through openings that allow the material to pass through the machine), and the CNC machine moves a downward-firing laser over the material to process the material.

In other scenarios, the material may be held by or otherwise affixed to an arm, jig, or similar mechanism, and the CNC machine moves a horizontally-firing laser over the material (and/or moves the material relative to the laser) to process the material. For example, in some embodiments, the material may be placed on a rotary jig that rotates the material while the laser beam is applied to the material as the material is rotated on the jig.

Further, in some scenarios, the material to be processed by the CNC machine may exhibit certain features and characteristics that prevent the designs from being placed anywhere on the material. For example, non-uniform and/or non-ideal portions of the material (e.g., voids, defects, and/or the like) may be unsuitable for the designs. The size, shape, and/or contours of the material may render the material (or portions of the material) unsuitable for the designs.

In some cases, the material may be disposed at a suboptimal position where the CNC machine is unable to process at least a portion of the material. Thus, the process of converting the user-specified design into a motion plan controlling the corresponding actions of the computer numerically controlled machine may include adapting the motion to the properties of the material. A “motion plan” contains the data that determines the actions of components of the CNC machine at different points in time. The motion plan may be generated on the CNC machine itself or at least partially on another computing system. The motion plan may include a stream of data that describes, for example, electrical pulses that indicate exactly how motors should turn, a voltage that indicates the desired output power of a laser, a pulse train that specifies the rotational speed of a mill bit, etc. Unlike the source files and the machine files such as G-code, the motion plan may be defined by the presence of a temporal element, either explicit or inferred, indicating the time or time offset at which each action should occur. This allows for one of the key functions of a motion plan, coordinated motion, wherein multiple actuators coordinate to have a single, pre-planned effect.

In some implementations of the current subject matter, various features and characteristics of the material may be identified in order to determine one or more optimal regions of the material for placing the user-specified designs. In some scenarios, one or more aspects of the features and characteristics of the material are used as inputs for determining a motion plan for implementing a design on the material.

Precise and detailed information regarding various features and characteristics of a material (including the distance between the laser head and/or optical assembly within the laser head and the material to be processed) may, in some instances, be required in order for the CNC machine to process the material such that the final appearance of the material is consistent with an intended final appearance of the material. Such information is helpful for ensuring that the CNC machine cuts the material to a desired depth or perhaps entirely through the material, depending on the intended design. Such information may also increase the efficiency of the material processing including by minimizing scrap material and maximizing output. The availability of information on the features and characteristics of the material may be crucial for decentralized small-scale manufacturing, where the degree of user skill is typically low and batch sizes are relatively small (e.g., fabricating a single item for home use or producing several hundred (or low thousands) of an item for a small business operation).

The technical and economic advantages that increase the robustness and reliability of commercial-scale production are not practical or accessible to more decentralized, modest-scale productions for at-home hobbyists and small businesses. This deficiency limits the appeal and ease of use as well as increases costs associated with decentralized, modest-scale manufacturing. Thus, the efficiency of the computer numerically controlled fabrication and the quality of the output may be improved if more information on the features and characteristics of the material are incorporated into the manufacturing process without requiring skilled professionals to assist in the design and manufacturing process. Obviating specialty knowledge from the manufacturing process may increase the appeal and adoption of computer numerically controlled fabrication for decentralized, modest-scale manufacturing activities.

As used herein, the term “cutting” can generally refer to altering the appearance, properties, and/or state of a material. Cutting can include, for example, making a through-cut, engraving, bleaching, curing, burning, etc. Engraving, when specifically referred to herein, indicates a process by which a computer numerically controlled machine modifies the appearance of the material without fully penetrating it. For example, in the context of a laser cutter, it can mean removing some of the material from the surface and/or discoloring the material (e.g. through an application of focused electromagnetic energy delivering electromagnetic energy as described below).

As used herein, the term “laser” includes any electromagnetic energy or focused or coherent energy source that (in the context of being a cutting tool) uses photons to modify a substrate or cause some change or alteration upon a material impacted by the photons. Some disclosed embodiments may use more than one laser. Some embodiments disclosed herein may additionally use lasers for (i) measuring dimensions and/or features of materials, (ii) measuring the distance between a laser head and the material in connection with controlling the operation of the laser and/or the laser head, and/or (iii) other measurement, diagnostic, and/or control functions. Lasers (whether cutting tools, diagnostic, or measurement) can be of any suitable wavelength, including for example, microwave, lasers, infrared lasers, visible lasers, UV lasers, X-ray lasers, gamma-ray lasers, or the like.

Also, as used herein, “cameras” includes, for example, visible light cameras, black and white cameras, IR or UV sensitive cameras, individual brightness sensors such as photodiodes, sensitive photon detectors such as a photomultiplier tube or avalanche photodiodes, detectors of infrared energy far from the visible spectrum such as microwaves, X-rays, or gamma rays, optically filtered detectors, spectrometers, and other detectors that can include sources providing electromagnetic energy for illumination to assist with acquisition, for example, flashes, UV lighting, etc.

Also, as used herein, reference to “real-time” actions includes some degree of delay or latency, either programmed intentionally into the actions or as a result of the limitations of machine response and/or data transmission. “Real-time” actions, as used herein, are intended to only approximate an instantaneous response, or a response performed quickly, or as quickly as reasonably possible given the limits of the system, and do not imply any specific numeric or functional limitation to response times or the machine actions resulting therefrom.

Also, as used herein, unless otherwise specified, the term “material” is the material to be cut (or otherwise processed) that is within the CNC machine (e.g., on the material bed of the CNC machine) or otherwise positioned within (or near, depending on machine type) the CNC machine for processing by the CNC machine. For example, if the CNC machine is a laser cutter, the material is what is placed in or sufficiently near the computer numerically controlled machine to be cut, for example, the raw materials, stock, or the like. The CNC machine may be a machine that is used to perform subtractive processing (e.g., by removing the material) under the control of a computer, in which case the computer numerically controlled machine may include one or more motors (or other actuators) that move one or more heads performing the removal of the material (or in some instances, move optical components (e.g., mirrors and lenses)) to focus the laser onto the surface of the material.

As used herein, the terms “render” or “rendering” generally refer to the action of displaying an image or other representation on a screen or display device, emitting an auditory sound or signal or series of sounds and/or signals, recreating a physical embodiment of an object or a creative work, printing a document, or the like. A rendering machine may include, for example, a printer, a three-dimensional (3D) printer, a CNC machine, a display screen, an audio device, a personal computing device, a fabricator, or other similar device capable of rendering an object or signal as previously described.

As used herein the terms “fabricating” and/or “printing” generally refer to altering the appearance, properties, and/or state of a material, and can include, for example, making a through-cut, engraving, bleaching, curing, burning, etc. Engraving, when specifically referred to herein, indicates a process by which a computer numerically controlled machine modifies the appearance of the material without cutting completely through the material. For example, in the context of a laser cutter, it can mean removing some of the material from the surface, or discoloring the material e.g., through an application of focused electromagnetic energy delivering electromagnetic energy.

In this disclosure, laser cutting tools, e.g., handheld laser straight-line cutters, handheld laser omni-directional saws, free-standing laser tools, three-dimensional laser printers, and the like are types of CNC machines. Any of the laser tools described herein may (or may not) use or require an enclosure, may (or may not) be portable (or easily portable), may be stand-alone or may operate in a networked manner, and so on. Further, since these laser cutting tools are types of CNC machines, the technical features and functions described with reference CNC machines in general are equally applicable to the disclosed herein laser cutting tools (and vice versa)

### A. Example CNC Machines and Systems

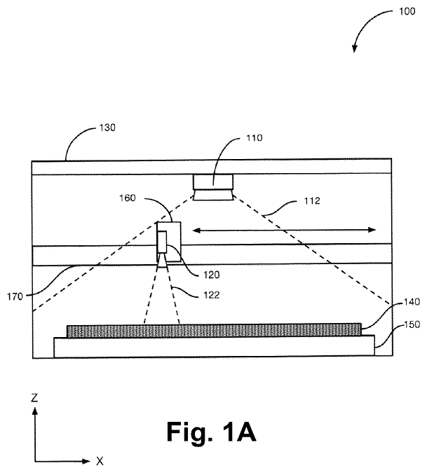

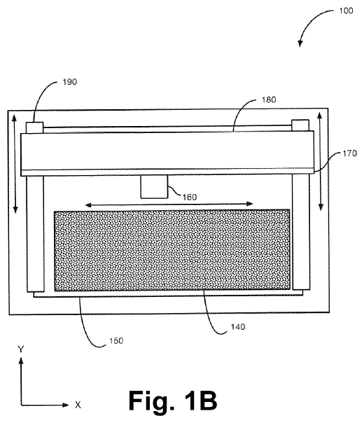

FIG. 1A depicts an elevational view of an example of a computer numerically controlled (CNC) machine 100, consistent with implementations of the current subject matter. The example of the CNC machine 100 shown in FIG. 1A may include a lid camera 110 positioned to capture an image of an entire material bed 150 and another camera 120 positioned to capture an image of a portion of the material bed 150, consistent with some implementations of the current subject matter. FIG. 1B depicts a top view of the example of the CNC machine 100 shown in FIG. 1A.

In some implementations of the current subject matter, the CNC machine 100 may be a laser cutter/engraver that uses electromagnetic energy (e.g., laser) to perform various forms of subtractive processing including, for example, cutting, engraving, and/or the like. While some features are described herein in the context of a laser cutter, this is by no means intended to be limiting. Many of the features described below can be implemented with other types of CNC machines.

As a laser cutter/engraver, the CNC machine 100 may be subject to particularly challenging design constraints. For example, a laser cutter/engraver is subject to regulatory guidelines that restrict the egress of electromagnetic energy from the unit when operating, making it challenging for light to enter or escape the unit safely, for example to view or record an image of the contents. The beam of a laser cutter/engraver may need to be routed from the laser emitter to the area to be processed, potentially requiring a series of optical elements such as lenses and mirrors. The beam of a laser cutter/engraver is easily misdirected, with a small angular deflection of any component relating to the beam path potentially resulting in the beam escaping the intended path, potentially with undesirable consequences. A laser beam may be capable of causing material damage or even material destruction if uncontrolled. A laser cutter/engraver may require high voltage and/or radio frequency power supplies to drive the laser itself.

Liquid cooling is common in laser cutter/engravers to cool the laser, requiring fluid flow considerations. Airflow is important in laser cutter/engraver designs, as air may become contaminated with byproducts of the laser's interaction with the material such as smoke, which may in turn damage portions of the machine for example fouling optical systems. The air exhausted from the machine may contain undesirable byproducts such as, for example, smoke that should be routed or filtered, and the machine may need to be designed to prevent such byproducts from escaping through an unintended opening, for example by sealing components that may be opened.

Addressing kerf is another consideration of machining tools. Kerf refers to the material removed during the machining process. In contrast to other machining tools, the kerf generated laser cutters/engravers tends to be both small and variable depending on the material being processed, the power of the laser, the speed of the laser, and other factors, making it difficult to predict the final size of the object. Nevertheless, even small amounts of kerf can interfere with operation of the laser cutter/engraver and affect the quality of the cutting or engraving. So, some embodiments may include kerf-management systems that use compressed air or other mechanisms to blow debris away from the area where the laser of the laser cutting/engraving tool is applied to the surface of the material.

Also unlike most machining tools, the output of the laser cutter/engraver is very highly dependent on the speed of operation; a momentary slowing can damage or even destroy the workpiece by depositing too much laser energy. In many machining tools, operating parameters such as tool rotational speed and volume of material removed are easy to continuously predict, measure, and calculate, while laser cutter/engravers are more sensitive to material and other conditions. In many machining tools, fluids are used as coolant and lubricant; in laser cutter/engravers, the cutting mechanism does not require physical contact with the material being effected, and air or other gasses may be used to aid the cutting process in a different manner, by facilitating combustion or clearing debris, for example.

Referring again to FIG. 1A, the CNC machine 100 can have a housing surrounding an enclosure or interior area defined by the housing. The housing can include walls, a bottom, and one or more openings to allow access to the CNC machine 100. In addition, the material bed 150 may be disposed at least partially within the housing of the CNC machine 100 and may include a top surface on which the material 140 generally rests.

In the example of the CNC machine 100 shown in FIG. 1A, the CNC machine 100 can also include an openable barrier as part of the housing to allow access between an exterior of the CNC machine and an interior space of the CNC machine. The openable barrier can include, for example, one or more doors, hatches, flaps, lids, and the like that can actuate between an open position and a closed position. The openable barrier can attenuate the transmission of light between the interior space and the exterior when in a closed position. Optionally, the openable barrier can be transparent to one or more wavelengths of light or be comprised of portions of varying light attenuation ability. One type of openable barrier can be a lid 130 that can be opened or closed to put material 140 on the material bed 150 on the bottom of the enclosure.

Various example implementations discussed herein include reference to a lid. It will be understood that absent explicit disclaimers of other possible configurations of the operable barrier or some other reason why a lid cannot be interpreted generically to mean any kind of openable barrier, the use of the term lid is not intended to be limiting. One example of an openable barrier can be a front door that is normally vertical when in the closed position and can open horizontally or vertically to allow additional access. There can also be vents, ducts, or other access points to the interior space or to components of the CNC machine 100. These access points can be for access to power, air, water, data, etc. Any of these access points can be monitored by cameras, position sensors, switches, etc. If they are accessed unexpectedly, the CNC machine 100 can execute actions to maintain the safety of the user and the system, for example, a controlled shutdown. In other implementations, the CNC machine 100 can be completely open (i.e. not having a lid 130, or walls). Any of the features described herein can also be present in an open configuration, where applicable.

The CNC machine 100 can have one or more heads including, for example, the head 160, which can be operated to alter the material 140. The head 160 may be configured to steer a beam of electromagnetic energy (e.g., a laser beam) to a desired location on the material 140 positioned in the working area of the CNC machine 100. For instance, the head 160 may be mobile including by translating and/or rotating to locate a beam of electromagnetic energy from a source configured to generate and/or emit the electromagnetic energy. Alternatively, the head 160 may be stationary and the beam of electromagnetic energy may be located by translating and/or rotating one or more optical components configured to route the electromagnetic energy from the head 160. It should be appreciated that the CNC machine 100 may include multiple heads that operate independently or in unison to locate the beam of electromagnetic energy.

In some implementations of the current subject matter, the head 160 can be configured to include a combination of optical, electronic, and/or mechanical components that can, in response to commands, cause a laser beam or electromagnetic energy to be delivered to cut, score, or engrave the material 140. As used herein, a cut is created when the electromagnetic energy cuts through the material 140 whereas a score is created when the electromagnetic energy effects a shallow line that penetrates the material 140 to a certain depth but does not cut through the material 140. Engraving, as used herein, indicates a process by which a CNC machine 100 modifies the appearance of the material 140 without fully penetrating example, in the context of a laser cutter, it can mean removing some of the material from the surface and/or discoloring the material (e.g. through an application of focused electromagnetic energy delivering electromagnetic energy as described herein). The source (e.g., an emitter and/or the like) generating the electromagnetic energy may be part of the head 160 or separate from the head 160. The CNC machine 100 can also execute operation of a motion plan for causing movement of the head 160 in implementations where the head 160 is configured to be mobile.

In some implementations of the current subject matter, the CNC machine 100 may accept a user drawing, acting as a source file that describes the designs the user wants to create or the cuts that a user wishes to make. Examples of source files include .STL files that define a three-dimensional object that can be fabricated with a 3D printer or carved with a milling machine, .SVG files that define a set of vector shapes that can be used to cut or draw on material, .JPG files that define a bitmap that can be engraved on a surface, and CAD files or other drawing files that can be interpreted to describe the object or operations. Other examples of source files include PDF files, DXF files, and/or the like.

A source file may be converted into a machine file (e.g., by a computer program and/or the like) that can be interpreted by the CNC machine 100 to take certain actions. The machine file may describe the idealized motion of the CNC machine 100 to achieve a desired outcome. As one example, if the source file specifies a rectangle, then the machine file can instruct the CNC machine 100 to translate the head 160 (and/or one or more optical elements) to deliver the electromagnetic energy to effect the rectangle in the material 140. The machine file can omit some information (e.g., the dimensions of the rectangle and/or the like) and/or add information (e.g., an instruction to move the head 160 from its home position to a corner of the rectangle to begin fabrication). The instructions can even depart from the directly expressed intent of the user.

Once the machine file has been created, a motion plan for the CNC machine 100 can be generated. As used herein, a “motion plan” may contain the data that determines the actions of components of the CNC machine 100 at different points in time. The motion plan may be generated on the CNC machine 100 itself or at least partially on another computing system. The motion plan may include a stream of data that describes, for example, electrical pulses that indicate exactly how motors should turn, a voltage that indicates the desired output power of a laser, a pulse train that specifies the rotational speed of a mill bit, etc. In some examples, the motion plan may be defined by the presence of a temporal element, either explicit or inferred, (e.g., as in G-code or similar formats) indicating the time or time offset at which each action should occur. This allows for one of the key functions of a motion plan, coordinated motion, wherein multiple actuators coordinate to have a single, pre-planned affect.

The motion plan renders the abstract, idealized machine file as a practical series of electrical and mechanical tasks. For example, a machine file might include the instruction to “move one inch to the right at a maximum speed of one inch per second, while maintaining a constant number of revolutions per second of a cutting tool.” The motion plan may therefore take into consideration that the motors cannot accelerate instantly, and instead must “spin up” at the start of motion and “spin down” at the end of motion. The motion plan would then specify pulses (e.g. sent to stepper motors or other apparatus for moving the head or other parts of CNC machine 100) occurring slowly at first, then faster, then more slowly again near the end of the motion.

The machine file is converted to the motion plan by the motion controller/planner. Physically, the motion controller can be a general or special purpose computing device, such as a high performance microcontroller or single board computer coupled to a Digital Signal Processor (DSP). The job of the motion controller is to take the vector machine code and convert it into electrical signals that will be used to drive the motors on the CNC machine 100, taking into account the state of the CNC machine 100 at that moment and physical limitations of the machine. The signals can be step and direction pulses fed to stepper motors or location signals fed to servomotors among other possibilities, which create the motion and actions of the CNC machine 100, including the operation of elements like actuation of the head 160, moderation of heating and cooling, and other operations. In some implementations of the current subject matter, a compressed file of electrical signals can be decompressed and then directly output to the motors. These electrical signals can include binary instructions similar to 1's and 0's to indicate the electrical power that is applied to each input of each motor over time to effect the desired motion.

In some implementations of the current subject matter, the motion plan may take into account the detailed physics of the CNC machine 100 itself, and translates the idealized machine file into implementable steps. For example, a particular CNC machine 100 might have a heavier head, and require more gradual acceleration. This limitation is modeled in the motion planner and affects the motion plan. Different models of the CNC machine 100 can require precise tuning of the motion plan based on its measured attributes (e.g. motor torque) and observed behavior (e.g. belt skips when accelerating too quickly). The CNC machine 100 can also tune the motion plan on a per-machine basis to account for variations from machine to machine. In some instances, the CNC machine 100 can additionally or alternatively tune the motion plan for a particular piece of material to account for variations in different materials and/or types of materials.

The motion plan can be generated and fed to the output devices in real-time, or nearly so. The motion plan can also be pre-computed and written to a file instead of streamed to the CNC machine 100, and then read back from the file and transmitted to the CNC machine 100 at a later time. Transmission of instructions to the CNC machine 100, for example, portions of the machine file or motion plan, can be streamed as a whole or in batches from the computing system storing the motion plan. Batches can be stored and managed separately, allowing pre-computation or additional optimization to be performed on only part of the motion plan. In some implementations, a file of electrical signals, which may be compressed to preserve space and decompressed to facilitate use, can be directly output to the motors. The electrical signals can include binary instructions similar to 1's and 0's to indicate actuation of the motor.

Electromagnetic energy effecting one or more changes in the material 140 that is at least partially contained within the interior space of the CNC machine 100 may therefore be delivered by moving the head 160. In one implementation, the position and orientation of the optical elements inside the head 160 can be varied to adjust the position, angle, or focal point of a laser beam. For example, mirrors can be shifted or rotated, lenses translated, etc. The head 160 can be mounted on a translation rail 170 that is used to move the head 160 throughout the enclosure. In some implementations the motion of the head 160 can be linear, for example on an x-axis, a y-axis, or a z-axis. In other implementations, the head 160 can combine motions along any combination of directions in a rectilinear, cylindrical, or spherical coordinate system.

A working area for the CNC machine 100 can be defined by the limits within which the head 160, whether stationary or mobile, can cause delivery of a machining action, or delivery of a machining medium, for example electromagnetic energy. The working area can be inside the interior space defined by the housing. It should be understood that the working area can be a generally three-dimensional volume and not a fixed surface. For example, if the range of travel of a vertically oriented laser cutter is a 10″×10″ square entirely over the material bed 150, and the laser from the laser beam comes out of the laser cutter at a height of 4″ above the material bed of the CNC machine, that 400 in³ volume can be considered to be the working area.

The working area can be defined by the extents of positions in which material 140 can be worked by the CNC machine 100. As such, the boundaries of the working area may not necessarily be defined or limited by the range of travel of any one component. For example, if the head 160 could turn at an angle, then the working area could extend in some direction beyond the travel of the head 160. By this definition, the working area can also include any surface, or portion thereof, of any material 140 placed in the CNC machine 100 that is at least partially within the working area, if that surface can be worked by the CNC machine 100. Similarly, for oversized material, which may extend even outside the CNC machine 100, only part of the material 140 might be in the working area at any one time.

The translation rail 170 can be any sort of translating mechanism that enables movement of the head 160 in the X-Y direction, for example a single rail with a motor that slides the head 160 along the translation rail 170, a combination of two rails that move the head 160, a combination of circular plates and rails, a robotic arm with joints, etc.

Components of the CNC machine 100 can be substantially enclosed in a case or other enclosure. The case can include, for example, windows, apertures, flanges, footings, vents, etc. The case can also contain, for example, a laser, the head 160, optical turning systems, cameras, the material bed 150, etc.

To manufacture the case, or any of its constituent parts, an injection-molding process can be performed. The injection-molding process can be performed to create a rigid case in a number of designs. The injection molding process may utilize materials with useful properties, such as strengthening additives that enable the injection molded case to retain its shape when heated, or absorptive or reflective elements, coated on the surface or dispersed throughout the material for example, that dissipate or shield the case from laser energy. As an example, one design for the case can include a horizontal slot in the front of the case and a corresponding horizontal slot in the rear of the case. These slots can allow oversized material to be passed through the CNC machine 100.

Optionally, there can be an interlock system that interfaces with, for example, the openable barrier, the lid 130, door, and the like. Such an interlock is required by many regulatory regimes under many circumstances. The interlock can then detect a state of opening of the openable barrier, for example, whether a lid 130 is open or closed. In some implementations, an interlock can prevent (or enable) some or all functions of the CNC machine 100 while an openable barrier, for example the lid 130, is in the open state (e.g. not in a closed state). The reverse can be true as well, meaning that some functions of the CNC machine 100 can be prevented (or enabled) while in a closed state. There can also be interlocks in series where, for example, the CNC machine 100 will not operate unless both the lid 130 and the front door are both closed. In some examples, the detection of a change in state of the interlock (e.g., the interlock moving from an open to a closed state or vice-versa) may trigger certain operations within the CNC machine. For example, upon detection that the interlock is moving from an open state to a closed state, a procedure (e.g., calibration procedure, material edge detection procedure, etc.) of the CNC machine may be initiated. Furthermore, some components of the CNC machine 100 can be tied to states of other components of the CNC machine, such as not allowing the lid 130 to open while the laser is on, a movable component moving, a motor running, sensors detecting a certain gas, and/or the like. The interlock can prevent emission of electromagnetic energy from the head 160 when detecting that the lid 130 is not in the closed position.

One or more cameras can be mounted inside the CNC machine 100 to acquire image data during operation of the CNC machine 100. Image data refers to all data gathered from a camera or image sensor, including still images, streams of images, video, structured light image data (i.e., image data obtained and used in connection with projecting a known pattern (often grids or horizontal bars) onto an object or material and analyzing deformation of the known pattern on the surface(s) of the object or material to calculate depth and surface information of the material), audio, metadata such as shutter speed and aperture settings, settings or data from or pertaining to a flash or other auxiliary information, graphic overlays of data superimposed upon the image such as GPS coordinates, in any format, including but not limited to raw sensor data such as a .DNG file, processed image data such as a .JPG file, and data resulting from the analysis of image data processed on the camera unit such as direction and velocity from an optical mouse sensor. For example, there can be one or more cameras mounted such that they gather image data (also referred to as ‘view’ or ‘image’) from an interior portion of the CNC machine 100. The viewing can occur when the lid 130 is in a closed position or in an open position or independently of the position of the lid 130. In one implementation, one or more cameras, for example a camera mounted to the interior surface of the lid 130 or elsewhere within the case or enclosure, can view the interior portion when the lid 130 to the CNC machine 100 is in a closed position. In particular, in some preferred embodiments, the one or more cameras can image the material 140 while the CNC machine 100 is closed and, for example, while machining the material 140. In some implementations, one or more cameras can be mounted within the interior space and opposite the working area. In other implementations, there can be one or more cameras attached to the lid 130. One or more cameras can also be capable of motion such as translation to a plurality of positions, rotation, and/or tilting along one or more axes. One or more cameras mounted to a translatable support, such as a gantry 180, which can be any mechanical system that can be commanded to move (movement being understood to include rotation) the one or more cameras or a mechanism such as a mirror that can redirect the view of the one or more cameras, to different locations and view different regions of the CNC machine. The head 160 is a special case of the translatable support, where the head 160 is limited by the track 190 and the translation rail 170 that constrain its motion.

Lenses can be chosen for wide angle coverage, for extreme depth of field so that both near and far objects may be in focus, or many other considerations. The one or more cameras may be placed to additionally capture the user so as to document the building process, or placed in a location where the user can move the camera, for example on the underside of the lid 130 where opening the CNC machine 100 causes the camera to point at the user. Here, for example, the single camera described above can take an image when the lid is not in the closed position. Such an image can include an object, such as a user, that is outside the CNC machine 100. One or more cameras can be mounted on movable locations like the head 160 or lid 130 with the intention of using video or multiple still images taken while the one or more cameras are moving to assemble a larger image, for example scanning the one or more cameras across the material 140 to get an image of the material 140 in its totality so that the analysis of image data may span more than one image.

As shown in FIG. 1A, a lid camera 110, or multiple lid cameras, can be mounted to the lid 130. In particular, as shown in FIG. 1A, the lid camera 110 can be mounted to the underside of the lid 130. The lid camera 110 can be a camera with a wide field of view 112 that can image a first portion of the material 140. This can include a large fraction of the material 140 and the material bed or even all of the material 140 and material bed 150. The lid camera 110 can also image the position of the head 160, if the head 160 is within the field of view of the lid camera 110. Mounting the lid camera 110 on the underside of the lid 130 allows for the user to be in view when the lid 130 is open. This can, for example, provide images of the user loading or unloading the material 140, or retrieving a finished project. Here, a number of sub-images, possibly acquired at a number of different locations, can be assembled, potentially along with other data like a source file such as an SVG or digitally rendered text, to provide a final image. When the lid 130 is closed, the lid camera 110 rotates down with the lid 130 and brings the material 140 into view.

Also as shown in FIG. 1A, a head camera 120, or multiple head cameras, can be mounted to the head 160. The head camera 120 can have a narrower field of view 122 and take higher resolution images of a smaller area, of the material 140 and the material bed, than the lid camera 110. One use of the head camera 120 can be to image the cut made in the material 140. The head camera 120 can identify the location of the material 140 more precisely than possible with the lid camera 110.

Other locations for cameras can include, for example, on an optical system guiding a laser for laser cutting, on the laser itself, inside a housing surrounding the head 160, underneath or inside of the material bed 150, in an air filter or associated ducting, etc. Cameras can also be mounted outside the CNC machine 100 to view users or view external features of the CNC machine 100.

Multiple cameras can also work in concert to provide a view of an object or material 140 from multiple locations, angles, resolutions, etc. For example, the lid camera 110 can identify the approximate location of a feature in the CNC machine 100. The CNC machine 100 can then instruct the head 160 to move to that location so that the head camera 120 can image the feature in more detail. In some instances, images from multiple cameras can also be used to generate a three-dimensional model of the material.

While the examples herein are primarily drawn to a laser cutter, the use of the cameras for machine vision in this application is not limited to only that specific type of CNC machine 100. For example, if the CNC machine 100 were a lathe, the lid camera 110 can be mounted nearby to view the rotating material 140 and the head 160, and the head camera 120 located near the cutting tool. Similarly, if the CNC machine 100 were a 3D printer, the head camera 120 can be mounted on the head 160 that deposits material 140 for forming the desired piece.

An image recognition program can identify conditions in the interior portion of the CNC machine 100 from the acquired image data. The conditions that can be identified are described at length below, but can include positions and properties of the material 140, the positions of components of the CNC machine 100, errors in operation, etc. Based in part on the acquired image data, instructions for the CNC machine 100 can be created or updated. The instructions can, for example, act to counteract or mitigate an undesirable condition identified from the image data. The instructions can include changing the output of the head 160. For example, where the CNC machine 100 is a laser cutter, the laser can be instructed to reduce or increase power or turn off. Also, the updated instructions can include different parameters for motion plan calculation, or making changes to an existing motion plan, which could change the motion of the head 160 or the gantry 180. For example, if the image indicates that a recent cut was offset from its desired location by a certain amount, for example due to a part moving out of alignment, the motion plan can be calculated with an equal and opposite offset to counteract the problem, for example for a second subsequent operation or for all future operations. The CNC machine 100 can execute the instructions to create the motion plan or otherwise effect the changes described above. In some implementations, the movable component can be the gantry 180, the head 160, and/or the like. An identifiable mark may be disposed on the moveable component to facilitate tracking changes in the position of the moveable component. The movable component, for example the gantry 180, can have a fixed spatial relationship to the head 160. The image data can update software controlling operation of the CNC machine 100 with a position of the head 160 and/or the gantry 180 with their position and/or any higher order derivative thereof.

Because the type of image data required can vary, and/or because of possible limitations as to the field of view of any individual camera, multiple cameras can be placed throughout the CNC machine 100 to provide the needed image data. Camera choice and placement can be optimized for many use cases. Cameras closer to the material 140 can be used for detail at the expense of a wide field of view. Multiple cameras may be placed adjacently so that images produced by the multiple cameras can be analyzed by the computer to achieve higher resolution or wider coverage jointly than was possible for any image individually. Alternatively and/or additionally, images produced by multiple cameras may be used for stereovision, which is a process that includes comparing features found in two or more images to determine the distance between the cameras and the feature. Stereovision may be one example of a technique used to determine the height (or thickness) of the material 140 at various locations across the material 140. Some embodiments of the multipoint distortion correction techniques disclosed herein may include using this stereovision technique (or aspects thereof) in connection with measuring the height (or thickness) of the material above the material bed.

The manipulation and improvement of images can include, for example, stitching of images to create a larger image, adding images to increase brightness, differencing images to isolate changes (such as moving objects or changing lighting), multiplying or dividing images, averaging images, rotating images, scaling images, sharpening images, and so on, in any combination. Further, the system may record additional data to assist in the manipulation and improvement of images, such as recordings from ambient light sensors and location of movable components. Specifically, stitching can include taking one or more sub-images from one or more cameras and combining them to form a larger image.

Some embodiments additionally or alternatively include using artificial intelligence techniques to segment an image, identify objects within the image, and/or recognize normal and/or errant conditions on the object or in the image. For example, in image processing and computer vision, image segmentation is the process of partitioning a digital image into multiple image segments, image regions, or image objects (e.g., corresponding to sets of pixels). Some embodiments use image segmentation to locate objects and boundaries within an image, which can help to determine edges of materials and/or other aspects of a material to be machined. Aspects of using image segmentation and related approaches to identify material boundaries and other material characteristics in the context of laser fabrication is described in more detail in (i) U.S. application Ser. No. 17/668,988 titled “Edge Detection for Computer Numerically Controlled Fabrication,” filed on Feb. 10, 2022, and (ii) U.S. Provisional App. No. 63/227,479, titled “Edge Detection for Computer Numerically Controlled Fabrication,” filed on Jul. 30, 2021. The entire contents of application Ser. No. 17/668,988 and 63/227,479 are incorporated herein by reference.

Some portions of the images can overlap as a result of the stitching process. Other images may need to be rotated, trimmed, or otherwise manipulated to provide a consistent and seamless larger image as a result of the stitching. Lighting artifacts such as glare, reflection, and the like, can be reduced or eliminated by any of the above methods.

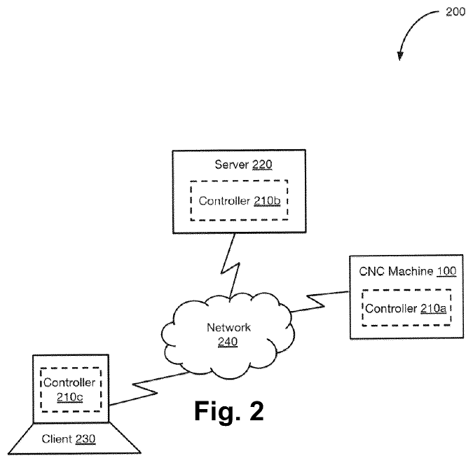

In some implementations of the current subject matter, the CNC machine 100 may be part of a CNC processing system. To further illustrate, FIG. 2 depicts a block diagram illustrating an example of a CNC processing system 200 consistent with implementations of the current subject matter. As shown in FIG. 2, the CNC processing system 200 may include the CNC machine 100 and a controller 210 configured to control the operations of the CNC machine 100. Moreover, as shown in FIG. 2, the controller 210 may be deployed at one or more locations. For example, as shown in FIG. 2, a first controller 210a may be deployed at the CNC machine 100. Alternatively and/or additionally, a second controller 210b may be deployed at a server system 220 and/or a third controller 210c may be deployed at the client device 230. The server system 220 and the client device 230 may be communicatively coupled with the CNC machine 100.

Accordingly, one or more functionalities of the controller 210, including those associated with analyzing the material 140 to identify one or more features and characteristics of the material 140 such as one or more edges of the material 140, may be performed at the CNC machine 100, the server system 220, and/or the client device 230. Whether performed at the CNC machine 100, the server system 220, and/or the client device 230, it should be appreciated that the analysis of the material 140 may be performed as part of a fabrication or fabrication process in which the CNC machine 100 processes, for example, the material 140 to achieve one or more designs.

As shown in FIG. 2, the CNC machine 100 may be communicatively coupled with the server system 220 and/or the client device 230 via a network 240. Moreover, the client device 230 and the server system 220 may also be communicatively coupled via the network 240. The network 240 may be a wired network and/or a wireless network including, for example, a local area network (LAN), a virtual local area network (VLAN), a wide area network (WAN), a public land mobile network (PLMN), the Internet, and/or the like. The client device 230 and the server system 220 may be one or more processor-based computing devices such as, for example, a smartphone, a tablet computer, a laptop computer, a desktop computer, a workstation, a wearable apparatus, an Internet-of-Things (IoT) appliance, and/or the like. The client device 230 and the server system 220 may include computer software and hardware configured to provide one or more functionalities of the controller 210 such that the functionalities of the controller 210 are accessible, via the network 240, to the CNC machine 100. In some instances, the one or more processors in any one or more (or all) of the client device 230, server system 220, and/or CNC machine 100 may include one or more (or all) of (i) traditional computer processors, (ii) dedicated artificial intelligence processors, and/or (iii) quantum processors.

In some implementations of the current subject matter, the controller 210 may be configured to analyze the material 140 to identify one or more features and characteristics of the material 140. For example, the controller 210 may perform edge detection in order to identify one or more edges of the material 140. Edge detection may be performed to identify one or more portions of the material 140 that are obscured by another material. Alternatively and/or additionally, edge detection may be performed to identify one or more portions of the material 140 subjected to previous processing. For instance, a previously engraved region of the material 140 or an area of the material 140 with damage from previous processing (e.g., burns, fraying, and/or the like) may be treated as an edge. Thus, as used herein, an edge of the material 140 may include a boundary between a first portion of the material 140 suitable for placement of a design to a second portion of the material 140 unsuitable for the placement of a design. One example of such a boundary may include an area of the material 140 where a transition from a presence of the material 140 to an absence of the material 140 and/or a presence of a different material occurs. Another example may include an area of the material 140 where a transition from an unprocessed and/or an undamaged portion of the material 140 to a processed and/or damaged portion of the material 140.

It should be appreciated that an edge may be present around an outer perimeter of the material 140 as well as in areas where portions of the material 140 are absent due to a hole or cut out in the material 140, a natural cut feature of the material 140, and/or the like. In cases where the material 140 is a mixed material combining, for example, a first material and a second material, an edge may be present where the first material transitions to the second material. An edge may also be present where the material 140 is partially obscured by another material not intended for processing including, for example, one or more weights, stickers, magnets, pins, tape, and/or the like. For example, in cases where the other material obscuring the material 140 is not intended for processing, the portions of the material 140 obscured may be removed such that the resulting preview of the material 140 includes one or more cutouts corresponding to the other material. The preview of the material 140 obscured by another material not intended for processing may therefore include edges introduced by the other material. Contrastingly, when the material 140 is obscured by another material that is intended for processing, the preview of the material 140 may include the portion of the other material disposed on the material 140 but not the portion of the other material not disposed on the material 140. The preview of the material 140 obscured by another material intended for processing may thus include the edges of the material 140 obscured by the other material.

In some implementations of the current subject matter, the controller 210 may perform edge detection automatically, for example, upon detecting that the lid 130 of the CNC machine 100 is in the closed position. For example, the controller 210 may receive one or more triggers indicating the lid 130 is in the closed position. In one example, a sensor tied to the lid 130 produces a trigger when the lid 130 is closed that is detected by, for example, controller 210a that is deployed at the CNC machine. In another example, the controller 210 may receive a message transmitted from the CNC machine 100 or the controller 210a that is disposed on the CNC machine 100 indicating that the lid 130 is in the closed position. The message may be sent, for example, to the controller 210b and/or 210c via the network 240. Performing edge detection automatically may expedite subsequent calibrations of the CNC machine 100 including, for example, an autofocus technique to adjust the power of electromagnetic energy delivered to the material 140, a scanning technique to detect variations in the height (and/or thickness) of the material 140, and/or the like. Some embodiments of the multipoint distortion correction procedures disclosed herein may include using scanning techniques (or aspects thereof) in connection with measuring the height (or thickness) of the material above the material bed.

In some cases, the controller 210 may perform edge detection to detect changes in a position of the material 140 on the material bed 150. The controller 210 may also automatically adjust a prior placement of one or more designs on the material 140 in order to accommodate any detected changes in the position of the material 140 on the material bed 150.

As noted, edge detection may be performed in order to expedite the calibration of the CNC machine 100. For example, once the material 140 has been placed on the material bed 150 and the lid 130 is in the closed position, the controller 210 may automatically perform edge detection to identify the bounds of the material 140 such that an autofocus technique may be performed to calibrate the power of the electromagnetic energy delivered to the material 140. In some examples, height measurement may be performed as part of the edge detection procedures. Additionally and/or alternatively height measurement may be performed after the edge detection procedures have completed. With autofocus, a z-axis lens (e.g., in the head 160) may be used to focus the beam of electromagnetic energy delivered by the head 160 in accordance with the height (or thickness) of the material 140. In some examples, multipoint autofocus techniques in which the power of the electromagnetic energy is adjusted to account for variations in the height (or thickness) of the material 140 may require measuring the height (or thickness) of the material 140 at multiple locations across the material 140. In operation, and as described further herein, height maps associated with an image of a material determined according to the multipoint distortion correction techniques disclosed herein can be used to alter, modify, or otherwise control aspects of focusing the laser onto the material during laser processing of the material and perhaps other aspects of motion plans associated with implementing a design on a material.

Thus, knowing where the edges of the material 140 are located may improve user experience at least because autofocus techniques (and other calibration techniques) may be performed within the one or more edges of the material 140 where the material 140 is present but not outside of the one or more edges of the material 140 where the material 140 is absent. In some cases, the edges of the material 140 may be located with some user inputs adjusting the edges detected by the controller 210. However, in other cases, the edges of the material 140 may be located without requiring user input to indicate where the material 140 is present and not present. The calibration of the CNC machine 100 may also be performed before the user places a design on the material 140. Precise placement of a design on a material 140 may be challenging without an understanding of the accurate location of the edges of the material 140. For example, the placement of one or more designs on the material 140 may result in an incorrect outcome if the designs are placed beyond the one or more edges of the material 140. In another example, design margins may be established to compensate for an inaccurate understanding of the edge locations, which may result in under-utilization of the material 140.

Edge detection is particularly useful when performing cuts relative to material edges, such as when fabricating joinery pieces. For example, fabricating joinery pieces may require cutting a hole that is ¼″ in from a material edge and 3″ from the bottom of the material. In another example, some joinery pieces may require a butterfly key centered on an edge of the material. Edge detection is useful for other types of cuts for other types of joinery pieces as well.

Edge detection may also improve the efficiency and outcome of material height measurement techniques in which height measurement techniques such as, for example, techniques described in this application, may be performed to determine the height (and/or thickness) of the material 140 at a single point or multiple points across the material, and the resulting measurement is used to adjust the focal point of the electromagnetic energy (e.g., focus the laser power) applied to the surface of the material and/or calibrate the power of the electromagnetic energy (e.g., calibrate the laser power) as well as for correcting distortions that may be present in the image captured by the lid camera 110 (e.g., barrel distortion and/or the like). In some cases, the material height measurement technique may also be used to determine certain features and characteristics of the material 140, such as warpage and/or the like, for generating a model of the material 140. The model of the material 140 may be used to adjust the power of the electromagnetic energy (e.g., by adjusting the z-axis lens in the head 160) such that the power of the electromagnetic energy may be varied to accommodate warpage (or other height variations) in the material 140. The model of the material 140 may also be used to identify cutout pieces of the material 140, which may have fallen through the surface of the material 140 and onto the material bed 150. The cutout pieces of the material 140 may obscure the visual characteristics of the material bed 150 (e.g., honeycomb-like structure) and are thus difficult to identify without the three-dimensional model of the material 140. Alternatively and/or additionally, the model of the material 140 may be used to detect vertical tilt in the placement of the material 140 on the material bed 150 such as, for example, when debris on the material bed 150 is holding the material 140 up on one side. In some embodiments, this approach is further enhanced with multipoint distortion correction techniques that include, among other features, generating a height map or height model for the material as described further herein.

Understanding the bounds of the material 140 through edge detection may allow material height measurement techniques to be performed automatically, for example, without the need for user input to define areas of the material 140 to measure. It should be appreciated that the results of edge detection may, in some cases, minimize (or even eliminate) the need for imposing a margin around the material 140 at least because the results of the edge detection may precisely identify specific edges where one or more designs are at risk for not fitting on the material or within a margin defined relative to the one or more edges of the material 140.

In some implementations of the current subject matter, identifying one or more edges of the material 140 may enable the placement of one or more designs on the material 140. For example, a design may be placed, based at least on the location of the one or more edges, to avoid exceeding the one or more edges and/or a margin defined relative to the one or more edges. Alternatively and/or additionally, the design may be placed relative to the one or more edges, which include, for example, being centered, parallel, adjacent, and/or packed with respect to the one or more edges.

In some cases, the controller 210 may determine that a design may not be placed on the material 140 in its entirety, for example, because one or more dimensions of the design exceed the dimensions of the material 140 (e.g., a design that is too wide and/or too long for the material 140). In those cases, the controller 210 may determine to split the design along one or more edges of the material 140 and provide a recommendation to place the remaining portion of the design on another piece of material. The controller 210 may split the design such that the design may be applied to two or more separate pieces of material that may be subsequently joined to form the intended design.

For instance, upon detecting the edges of the material 140, the controller 210 may respond to one or more user commands by centering the design relative to the edges of the material 140 or rotating the design parallel to the edges of the material 140. In some cases, the controller 210 may retain the placement of the one or more designs when the orientation of the material 140 on the material bed 150 undergoes one or more changes. Thus, after the user moves the material 140, the controller 210 may determine that the same material is still present in the CNC machine 100 and automatically place the designs such that the designs maintains their placement (e.g., centered, parallel, adjacent, packed, and/or the like) relative to the one or more edges of the material 140.

In some instances, such as when the laser tool is implemented in a “chop saw” type of configuration, edge detection can be used to determine where to cut the material to achieve a finished product having certain dimensions. For example, edge detection can be used to find the far edge of a 2×4, and trim the 2×4 to exactly 3′ so as to yield a 3′ long 2×4 plank. In such scenarios, using edge detection with a laser tool to set the length of the plank is akin to using a stop with a traditional chop saw tool to set the length of the plank.

In some examples, the cut point (e.g., length for cross-cut point, width for rip-cut, diameter for circle, etc.) can be determined via a combination of user input(s) and the laser cutter auto detecting the correct distance. For instance, the target dimension (length, width, diameter, etc.) can be provided via user input, such as input from a user via voice, typing, configuration file, etc. In another example, the user may provide input with their finger or a stylus, picked up by cameras or sensors. And then the laser cutting tool can use sensors to determine where the appropriate cut point(s) should be to achieve the desired dimension received via the user input. In some instances, the determining the appropriate cut point(s) could be done using calibrated imaging sensors, rollers or other mechanical features that can move as the material moves over them, and so on.

In some implementations of the current subject matter, the controller 210 may generate a preview of the placement of the design relative to one or more edges of the material 140. This preview may be displayed as part of a user interface, for example, at the CNC machine 100, the client device 230, and/or the server system 220. Furthermore, the controller 210 may provide feedback configured to discourage an incorrect design placement relative to one or more edges of the material 140. For example, the controller 210 may trigger, at the CNC machine 100, the client device 230, and/or the server system 220, an alert if the placement of the design exceeds one or more edges of the material 140. Alternatively and/or additionally, the controller 210 may automatically reposition the design on the material such that the placement of the design is consistent with the one or more edges of the material 140. As will be described in further detail, the feedback, which may be provided at the CNC machine 100, the client device 230, and/or the server system 220, may include a response that corresponds to a proximity of the design relative to an edge of the material 140 to discourage the design from exceeding the edge of the material 140.

As noted, the design may be placed relative to one or more edges of the material 140. In some cases, the placement of the design may be further determined by a margin defined relative to the one or more edges. It should be appreciated that a “margin” may refer to an area of the material 140 where processing by the CNC machine 100 is not recommended or is prohibited. That is, margins may be implemented as “rules” (e.g., processing is prevented from taking place within the margins) or as “guidelines” (e.g., feedback may discourage the placement of designs within the margins margins). Moreover, these margins may be user defined and/or determined by the controller 210 based on the type of the material 140, the type of operation (e.g., cut, score, engrave, and/or the like) required to achieve the design, and/or the presence of previous designs (e.g., to avoid cuts and/or other artifacts from a previous operations). Margins may be displayed as part of the preview in the user interface to help avoid the placement of designs beyond the margins. In some cases, margins are necessary when the location of one or more edges in the material 140 cannot be precisely identified. Thus, in some cases, the presence and size of the margins may be defined based on the accuracy with which the controller 210 is able to determine the location of the edges of the material 140.

In some implementations of the current subject matter, the controller 210 may determine, based at least on the one or more edges of the material 140, an optimal design placement that maximizes an efficiency in the utilization of the material 140 including by minimizing the quantity of scrap material and maximizing the output associated with the processing of the material 140. For example, to maximize material use efficiency, the controller 210 may place designs as closely as possible on the material 140 and/or maximize the quantity of designs (including replicas of the same design) produced from the material 140. Preview of the design placement may include the designs being moved automatically to an optimal placement or being encouraged to move towards the optimal placement, for example, by a perceived increased attractive force, as expressed in the user interface, towards an optimal position on the material 140. The controller 210 may also generate other feedback to encourage an optimal design placement including, for example, a metric indicative of the material use efficiency associated with different design placements. This metric may be computed based on an analysis of the dimensions of the scrap material that is associated with various design placements. As will be described in more detail, the controller 210 may track historical material use including across multiple projects, pieces of material, users, and/or CNC machines.

In further implementations of the current subject matter, the controller 210 may determine, based on the one or more edges of the material 140, how to finish a material for a particular design or use case. For example, if the material 140 is a piece of trim, the controller 210 may determine, based on the one or more edges of the material 140, how and/or where to cut the material 140 to an appropriate length, e.g., with a miter cut. In another example where the material 140 is a cabinet panel, the controller 210 may determine, based on the one or more edges of the material 140, how and/or where to place holes or slots in the material 140 for shelf supports.

In some implementations of the current subject matter, edge detection may be performed in order for the controller 210 to locate, on the material 140, one or more identifiers conveying information associated with the material 140. For example, the one or more identifiers may include a Quick Response (QR) code, a stock keeping unit (SKU) code, a barcode, and/or the like that enable a determination of one or more characteristics of the material 140 such as, for example, the type of the material 140, the thickness of the material 140, the density of the material 140, the composition of the material 140, and/or the like. In cases where the identifier is disposed within a certain region of the material, such as a threshold distance relative to an edge of the material 140, the controller 210 may limit the search for such an identifier to that region of the material 140 (e.g., within the threshold distance relative to one or more edges of the material 140) once the edges of the material have been determined.

Alternatively and/or additionally, the one or more markings may be patterned across the material 140, in which case at least some portions of the material 140 including one or more edges may be identified based on the one or more markings on the material 140. For example, the one or more markings may form a fluorescent pattern (e.g., one or more ultraviolet (UV) barcodes and/or the like) that is invisible in the absence of a fluorescence inducing light source including, for example, a non-laser light source (e.g., light emitting diodes (LEDs) and/or the like), a laser light source (e.g., a Vertical-Cavity Surface Emitting Laser (VCSEL) array), and/or the like. The one or more markings may thus serve to identify various positions across the material 140. For instance, one or more edges in the material 140 may be detected based at least on the presence and/or absence of the one or more markings. Where the material 140 is a mixed material that combines, for example, a first material and a second material, a first identifier may be patterned over the first material while a second identifier may be patterned over the second material to enable a differentiation between the first material and the second material including one or more boundaries between the first material and the second material.

Some examples may additionally or alternatively use artificial intelligence techniques to identify materials. For example, one or more images of the material can be provided to an image classifier (or similar) that has been trained to classify different types of materials within images.

### B. Example Computing System for Implementing Disclosed Embodiments

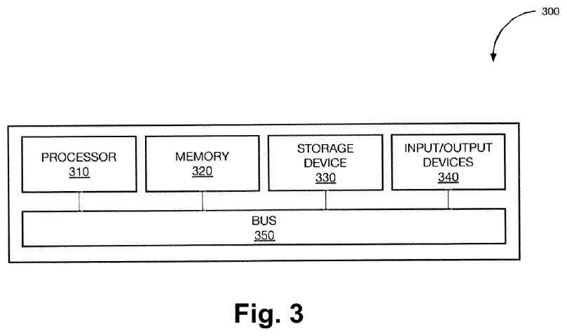

FIG. 3 depicts a block diagram illustrating a computing system 300, consistent with implementations of the current subject matter. Referring to FIG. 3, the computing system 300 may comprise and/or implement the controller 210 (or other computing device/system) and/or any components therein (e.g., one or more processors and tangible, non-transitory computer-readable media).

As shown in FIG. 3, the computing system 300 can include a processor 310, a memory 320, a storage device 330, and an input/output device 340. The processor 310, the memory 320, the storage device 330, and the input/output device 340 can be interconnected via a system bus 350. The processor 310 is capable of processing instructions for execution within the computing system 300. Such executed instructions can implement one or more components of, for example, the controller 210. In some implementations of the current subject matter, the processor 310 can be a single-threaded processor. Alternately, the processor 310 can be a multi-threaded processor. The processor 310 is capable of processing instructions stored in the memory 320 and/or on the storage device 330 to control at least some of the operations of the CNC machine 100.

The memory 320 is a computer readable medium such as volatile or non-volatile that stores information within the computing system 300. The memory 320 can store data structures representing configuration object databases, for example. The storage device 330 is capable of providing persistent storage for the computing system 300. The storage device 330 can be a solid state drive, a floppy disk device, a hard disk device, an optical disk device, or a tape device, or other suitable persistent storage means. The input/output device 340 provides input/output operations for the computing system 300. In some implementations of the current subject matter, the input/output device 340 can provide input/output operations for a network device. For example, the input/output device 340 can include Ethernet ports or other networking ports to communicate with one or more wired and/or wireless networks (e.g., a local area network (LAN), a wide area network (WAN), the Internet).

The following sections provide example embodiments of a CNC machine or a three-dimensional laser printer that can use any suitable ones of the features/functionality described above and can provide distinct advantages (e.g., being portable, physically smaller, handheld, etc.), which can introduce its own set of challenges, many of which are addressed below.

### C. Portable Laser Cutter

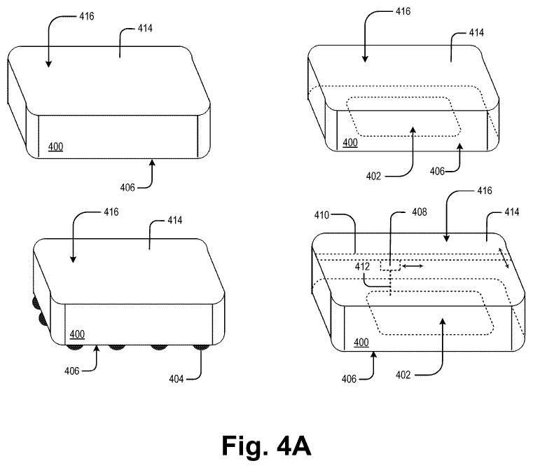

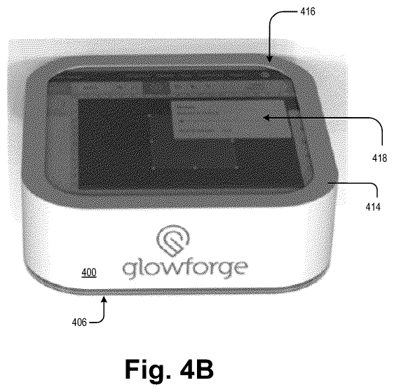

FIGS. 4A and 4B depict aspects of an example portable laser cutter 400 according to some embodiments. A portable laser cutter, also known as a CNC laser cutter and engraver, can be used to cut and engrave materials including, but not limited to, wood, leather, stone, metal, chocolate, paper, iron-on heat transfer material, and peel-and-stick decorations. Using onboard camera(s), the portable laser cutter 400 can engrave and cut enormous projects, one section at a time, using the camera to align sections. Some example applications include, but are not limited to, customizing a skateboard, custom engraving the back of a phone or a coaster, and creating an etching design on a wall or other decal. The following paragraphs describe various functions (e.g., cut-through detection, multi-print, etc.) that can be used with this printer.

In one example implementation shown in FIG. 4A, the portable laser cutter 400 can take the form of an 8″×8″×2″ box with an open bottom 402 that can enclose objects or materials up to about 8″×8″×½″ (e.g., to fit iPhones, coasters, etc.), although any suitable dimensions and shapes can be used. The portable laser cutter 400 can be placed on top of larger material as well, such as a sheet of plywood or drywall for marking or cutting, which may not fit inside the open bottom 402 of the portable laser cutter 400. In one example, the portable laser cutter 400 is self-powered (e.g., using USB-C, which has power and communications, battery power, DC power, etc., but could also be plugged into a power source such as a wall outlet).

In some embodiments, the portable laser cutter 400 may be equipped with wheels, ball bearings, or similar rolling members 404 to facilitate movement across any material upon which the portable laser cutter 400 has been placed, either self-driven with motors or other actuators, or moved by the user by physically sliding it.

Some embodiments may additionally include a Teflon or similar coating along the bottom surface 406 of the portable laser cutter 400 to reduce friction between the bottom surface 406 of the portable laser cutter 400 and a material upon which the portable laser cutter 400 has been placed while the portable laser cutter 400 is moving along the surface of the material. In some embodiments, the portable laser cutter 400 additionally or alternatively includes one or more suction cups, an adhesive, a vacuum system, or similar mechanism configured to cause the portable laser cutter 400 to adhere to an angled surface, such as a wall.

In some embodiments, the portable laser cutter 400 comprises (i) a controller with one or more processors and memory and (ii) at least one solid-state laser diode incorporated in a laser head 408 that is mounted on a two-dimensional gantry system 410, such that the laser head 408 can move in both X-Y dimensions, as described above and in U.S. patent application Ser. No. 17/511,000, titled “Mechanical System For High Positional Computer Numerically Controlled Applications,” filed on Oct. 26, 2021, which is incorporated herein by reference. In some examples, the portable laser cutter 400 can also include a laser head 408 which is configured to instead or additionally steer the laser beam 412 by tilting the laser beam 412, for example, by reflecting it off of mirrors using motors or galvanometers, or tilting the laser directly. The portable laser cutter 400 in some embodiments has additional or other components, some of which (such as a touchscreen) are discussed below.

As mentioned above, the portable laser cutter 400 in some embodiments forms a box or an opening 402 on its bottom side 406 that, when placed on top of a material or an object, forms a box type of enclosure over the region of the opening 402. In use, the portable laser cutter 400 may be placed over a material to process the material when the material is larger than the bottom 406 of the portable laser cutter 400, so that the material forms the final (bottom) side of the enclosure to fully encompass the material for printing. Alternatively, the portable laser cutter 400 may be placed over an object that is smaller so it does not fully complete the enclosure, but that object is placed on a surface such as a table that forms the full enclosure. That is, in contrast to a standard portable laser cutter, the portable printer in this embodiment is placed over/onto the material or object instead of the material or object being placed inside of a printer enclosure.

In some embodiments, the outer enclosure 414 of the portable laser cutter 400 may be in whole or in part transparent (to see the processing), translucent (to filter out some of the light), or opaque (for cost and safety). When the enclosure is opaque, the inside of the portable laser cutter 400 cannot be seen from the outside when placed over the material.

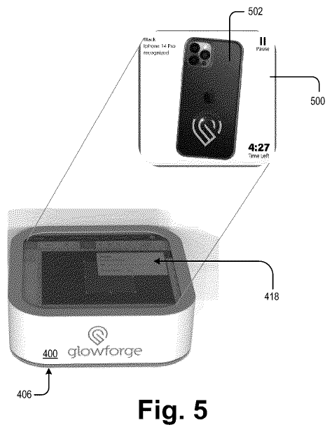

The top 416 (or other) surface of the portable laser cutter 400 in some embodiments can contain a display 418 (e.g., a touchscreen display), as shown in the example embodiment illustrated in FIG. 4B. The display 418 can be used as a user interface for any one or more (or all) of the following purposes:
To indicate the status of the portable laser cutter 400 (e.g., on or off, error, etc.)
To provide an interface allowing a user to control the status of a print using the portable laser cutter 400 (e.g., begin, stop, pause, etc.)
To display the status of a current print job being implemented by the portable laser cutter 400 (e.g., as shown in FIG. 5)
To show a preview of the design to be printed via the portable laser cutter 400 including, for example, a visual representation of the print bed and the placement of the design (e.g., as shown in FIG. 5), a visual representation of the final design, etc.
To allow the user to adjust settings of the portable laser cutter 400 including, for example adjusting network connections of the portable laser cutter 400
To allow the user to adjust settings of the operational functions, (e.g. print power, speed, etc.)
To provide a platform for the user to create or edit the design before printing
To display error messages or alerts related to the print job
To show the estimated time remaining for the print job (e.g., as shown in FIG. 5)
To allow the user to select the material to be used for the print job
To display the progress of the print job in real time or substantially real time (e.g., as shown in FIG. 5)
To allow the user to save and retrieve designs (e.g., from a catalog, previously used designs, AI-generated designs, etc.)
To display sensor measurements, such as, for example, internal temperature of the portable laser cutter 400, temperature of the material, etc.
To provide a platform for the user to calibrate the portable laser cutter 400
To allow the user to perform maintenance tasks such as, for example, cleaning and replacing parts, ordering material or replacement parts, etc.
To provide a platform for the user to update software for the portable laser cutter 400
To provide a platform for the user to order products such as new materials
To allow the user to set up and manage user profiles
To display the portable laser cutter 400 serial number and other identifying information
To provide a method for the user to contact customer support and/or get technical assistance
To display safety and usage instructions for the portable laser cutter 400
To provide a method for the user to access and read a user manual or similar operating instructions for the portable laser cutter 400
To display the portable laser cutter 400 current operating mode (e.g., standby, printing, cooling)
To provide a method for the user to access and use third-party apps compatible with the portable laser cutter 400
To allow the user to track the portable laser cutter 400 usage history and statistics
To display promotional content and updates from the manufacturer
To lay out a larger image that can be fabricated in pieces, as described elsewhere in this disclosure

In some embodiments, the display 418 can also display images captured by one or more image capture devices (e.g., “bed” cameras) inside the portable laser cutter 400, as well as an expected result with (e.g., simulated or real) progress (see FIG. 5). Images captured by the camera(s) may need to be modified to account for distortion (e.g., from wide angle lens of the one or more internal cameras, etc.). Any suitable type of camera and image processing can be used, including, but not limited to those described herein. The camera(s) can be used to capture a “live view” 500 of the enclosed material/object 502 (e.g., before/after/during operation) (see FIG. 5). The camera(s) can also be used for other purposes, including, but not limited to, material identification, height detection, edge detection, etc. and identifying where a design needs to be continued from in the event the print is larger than the area enclosed by the printer, as discussed herein.

The display 418 can display, in whole or in part of the screen, some or all of what is captured from the camera sensor. The information captured from the camera sensor might be a live view 500 (FIG. 5), as the laser beam 412 (FIG. 4A) moves. The information captured from the camera sensor might be recorded, for example taking a snapshot and then continuing to display that snapshot, e.g. to reduce power vs. streaming video. As an alternative to showing the camera sensor, some embodiments may include creating a synthetic image.

For example, consider a square of wood inside of the portable laser cutter 400 sitting on a checkered tablecloth. Instead of showing the wood on a checkered background, the display 418 might show an idealized pattern of wood grain on a white background. Aspects of displaying materials in the manner described above are described in U.S. application Ser. No. 18/492,724, titled “Project Design Preview,” filed on Oct. 23, 2023.

Instead of providing a “live” 500 (FIG. 5), the touchscreen display 418 in some embodiments can “mimic” a view inside the portable laser cutter 400. That is, instead of showing a live view 500 image of the material/object 502 being processed by the portable laser cutter 400, the touchscreen display 418 can present a photo captured of the material/object 502 being processed, a rendering of the material/object 502, etc. For example, the material/object 502 (e.g., an iPhone) inside the portable laser cutter 400 can be identified using image recognition software having artificial intelligence (AI), and an image of the object 502 (e.g., iPhone) can be retrieved (e.g., from the Internet, stored memory, etc.) and displayed via the touchscreen display 418. The touchscreen display 418 can also display a virtual (synthetic) image and/or an augmented reality image of the laser processing a design onto the material/object 502 inside the portable laser cutter 400. This can be used to provide near real-time progress indication of a design cut in a realistic way.

Instead of (or in addition to) the touchscreen display 418 showing a live view 500 of the material/object 502 being processed by the portable laser cutter 400, some embodiments include the portable laser cutter 400 causing an augmented reality (AR) or virtual realty (VR) headset (not shown) to display information about the design, the progress of implementing the design, and/or information about the material/object 502 being processed by the portable laser cutter 400. For example, in some instances, an AR or VR headset can show the live view 500 depicted in FIG. 5, or perhaps a variation on the live view 500 that is suitable for display via an AR or VR headset.

In addition to displaying a live view 500 or rendered image of an object 502 being worked on, the touchscreen display 418 can additionally serve as the primary user interface of the portable laser cutter 400. The user interface can be used to implement any suitable functionality. For example, the user interface can be used to create a design using software tools through the interface or can be used to retrieve a design (e.g., from a network-connected machine, stored memory, etc.) and/or assign/modify a design to a material for printing. The user can set/modify power levels, select laser actions (e.g., cut/engrave, etc.), and initiate a print from the touchscreen display 418.

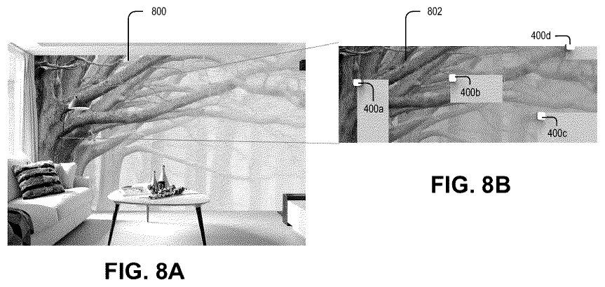

Additionally, as described herein, design(s) can be larger than the area under the bottom 406 of the portable laser cutter 400. For example, FIGS. 8A and 8B show aspects of an example portable laser cutter 400 printing a design 800 onto a wall, where the design 800 is substantially larger than the portable laser cutter 400. In such scenarios, the portable laser cutter 400 can print sections of the larger design followed by a move command (manual or automated) to move the portable laser cutter 400 a distance to complete another section of the design. This can be facilitated with a user interface that shows, e.g., a view of the entire design and a zoomed-in portion of the design that can be cut with the portable laser cutter 400. For example, the touchscreen display 418 can be used to view the entire design and zoom in and/or out on various portions of the overall design.

Also, instead of or in addition to the user interface being located on the portable laser cutter 400, the user interface can be located on a different device, such as, for example, a network-connected computer, a tablet, a phone, a VR headset, an AR headset, etc.

In some embodiments, the user interface can be a browser-based interface on the portable laser cutter 400 and can also be viewed/interacted with on another connected device (e.g., a laptop, tablet, phone, etc.). The connected device can be used for various functionality, such as, but not limited to, motion planning, image processing, etc., with the resulting commands transmitted to the portable laser cutter 400 for execution.

In some embodiments, the portable laser cutter 400 connects to one or more network connected computer processors such as, for example, a cloud server (e.g., server system 220 in FIG. 2) that is configured to control one or more aspects of the portable laser cutter 400.

In operation, advanced software tools on the connected portable laser cutter 400 can be used. For example, artificial intelligence can be used to recognize what objects/materials are to be processed by the portable laser cutter 400, e.g., by classifying images of objects/materials to be processed by the portable laser cutter 400.

Alternatively, the user interface can be local to the portable laser cutter 400 such that network connectivity is not required for operation. In such scenarios, the portable laser cutter 400 can be a self-contained unit (e.g., where motion planning, image processing, user interface, etc. are all done locally).

In some embodiments, the portable laser cutter 400 can provide material recognition using a sensor (e.g., a camera, a barcode reader (such as a ultraviolet (UV) barcode reader), RFID, BT/NFC tag, etc.) or other technologies (e.g., ultrasound, radar, x-ray, etc.) to identify a material type (e.g., drywall, wood, metal, glass, etc.). Recognition can occur by decoding data, for example reading text or a barcode, by image recognition for example using artificial intelligence, by sensing the composition of the material e.g. measuring reflectivity, or other means. Recognized materials can be processed with default settings that are defined in advance by the software or by the user, which can be changed. For an unrecognized material, the portable laser cutter 400 in some embodiments may choose to not print or to issue a warning to the user. In this way, the portable laser cutter 400 can ensure that it only cuts or otherwise processes certain types of materials, such as, for example, Proofgrade® brand materials). Alternatively, it can allow the user to proceed using settings of their own selection, potentially after acknowledging the risks involved.

In some embodiments, the portable laser cutter 400 has a cut-through detection feature that can shut off or not start the laser if a problem is detected, so as to maintain a safe environment in the presence of, for example, gaps or holes in the material, or if the material has been cut through by the portable laser cutter 400. In some embodiments, the portable laser cutter 400 can implement methods to detect if the laser is doing something unexpected (e.g., the material has been cut through and being reflected by metal or passing beyond the material, the laser is cutting over a hole in the material or off the edge of the material, etc.).

In operation the portable laser cutter uses any one or more sensors to detect a cut-through condition, including but not limited to cameras, thermal sensors, microphones, speakers, motion sensors (e.g., accelerometers, etc.), position sensors, infrared sensors, potentiometric sensors, inductive sensors, ultrasonic sensors, optical sensors, eddy-current based sensors, and fiber-optic based sensors, and/or any other type of suitable sensor.

For example, in some implementations, internal sensors within the portable laser cutter 400 can measure an amount of scattered light (in the wavelength of the laser used for cutting) during a cut by, for example, imaging the cutting process with an internal camera in the portable laser cutter 400, detecting light in the cutting wavelength, and comparing the measured power with an expected threshold amount. In some such embodiments, the portable laser cutter 400 shuts off the laser after detecting (or perhaps in response to detecting) more than a threshold level of power at the cutting wavelength, thereby indicating a cut through condition.

In further example implementations, mist around the laser beam can be used to measure stray laser energy refracted anywhere through the mist area. The expected amount of laser light would be less than a threshold if the material is cut through and the light is passing through open air beyond the material. The expected amount would be greater than a threshold if the material is being reflected by a metal piece under the material. Therefore, in some such example implementations, the portable laser cutter 400 shuts off the laser after detecting (or perhaps in response to detecting) less than some threshold amount of laser light in the mist around the laser beam, thereby indicating a cut through condition.

Also, in some example embodiments, the material edge detection techniques discussed above can be used to detect a cut through condition. For example, cameras or other sensors can be configured to detect the edges of the material to be processed before the portable laser cutter 400 starts processing the material. And while the portable laser cutter is processing the material, the cameras or other sensors monitor the material to detect when a new edge has been created, thereby indicating a cut through condition.

In another embodiment, the portable laser cutter 400 may not engage the laser unless it detects material either within the enclosure or under the portable laser cutter 400. Material detection can be done using sensors such as, for example, imaging sensors, capacitive sensors, any material detection method described herein, or other suitable material detection method now known or later developed that is suitable for detecting the presence of material prior to operating the laser of the portable laser cutter.

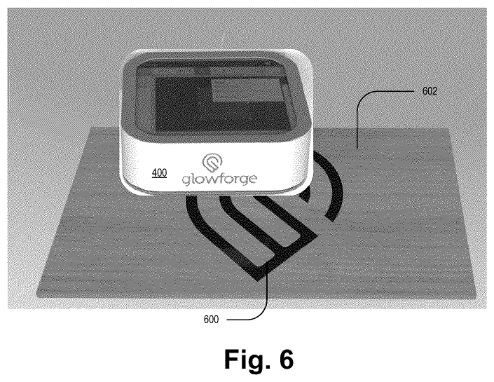

Many applications can take advantage of a portable laser cutter 400. For example, in some embodiments, the portable laser cutter 400 can be picked up, moved (e.g., 7″ when the printer is an 8″×8″ box), set down again, and continue printing for massive creations. For example, FIG. 6 shows a scenario where the portable laser cutter 400 is creating a design 600 on a material 602 that is larger than the portable laser cutter 400. In the example shown in FIG. 6, the portable laser cutter 400 can be picked up and moved to different positions on the material 602 to cut different portions of the design 600.

In some embodiments, and as mentioned earlier with reference to examples shown in FIG. 4A, the portable laser cutter 400 can be self-powered and/or directed to move (e.g., in coordination for a multi-print design or multi-device effort). This “multi-print” feature (to print on work surfaces larger than the X-Y printable area of the portable laser cutter 400) is a variation of a material pass-through feature of a desktop three-dimensional laser printer. Some aspects of material pass-through with a desktop three-dimensional laser printer are shown and described in U.S. App. 15/334,104, titled “Moving material during laser fabrication,” filed on Oct. 25, 2016, and issued as U.S. Pat. No. 10,496,070 on Dec. 3, 2019. The entire contents of U.S. App. 15/334,104 are incorporated herein by reference.

In some embodiments, using images captured by the image capture device (e.g., a camera) of the portable laser cutter, imaging processing functionality provided by the controller in (or in communication with) the portable laser cutter can identify where the printing of the design 600 left off on the material 602 (i.e., previous prints/cuts/etches) and then continue from that point to facilitate the continuation of printing the design 600. The controller can also identify a portion of the design 600 and print another part of design 600 based on what is identified (not necessarily a continuation of where the portable laser cutter 400 previously stopped printing).

In some embodiments, the portable laser cutter 400 can print sections of the larger design 600 followed by a move command (manual or automated) to move the portable laser cutter 400 a distance to complete another section of the design 600. This can be facilitated with a user interface that shows, e.g., a view of the entire design 600 and a zoomed-in portion of the design 600 that can be cut with the portable laser cutter 400.

Identifying location may be based on images captured with one or more cameras (e.g., based on previous cut, material characteristics, etc.), location/rotation identification (e.g., tracking movement of the portable laser cutter 400 using positional sensors, etc.), etc. The portable laser cutter 400 can continue to print (cut/etch, etc.) after the portable laser cutter 400 has been moved by (i) identifying a location relative to the design 600 and (ii) implementing a continuation cutting protocol that may modify power settings, etc. to continue cutting the design 600 in a seamless fashion or a substantially seamless fashion.

In further embodiments, multiple portable laser cutters 400a-l are used to implement a design (e.g., design 800 shown in FIGS. 8A and 8B). In operation, the multiple portable laser cutters 400a-l are configured to interact with each other.

In operation, the multiple portable laser cutters 400a-1 working together to implement a design do not need to be the same size or same type/model of portable laser cutter (i.e., the individual portable laser cutters of the multiple portable laser cutters 400a-l can have different printable areas). The multiple portable laser cutters 400a-1 can be controlled in some embodiments by a central device (e.g., a remote cloud server 700 or similar), or the control can be distributed among some or all of the multiple portable laser cutters 400a-1. Communication can be directly between the multiple portable laser cutters 400a-1, possibly through a coordinator device, or through a connected processing device for coordination. That is, control of multiple coordinated portable laser cutters 400a-l may be centralized or distributed (e.g., mesh network connected). In this way, multiple portable laser cutters 400a-1 can be used in coordination to contribute to the creation of a single design (e.g., a picture) that is larger than the printable area of a single portable laser cutter.

For example, FIGS. 8A and 8B show a scenario where multiple portable laser cutters 400a, 400b, 400c, and 400d work together in a coordinated fashion to implement design 800. In particular, FIG. 8A shows the design 800 covering most of a wall, and FIG. 8B shows four portable laser cutters (400a-d) working together to fabricate a portion 802 of the design 800.

To effectively print a large image (e.g., design 800) using a portable laser cutter 400 with a printable area that is smaller than the area of the image, the portable laser cutter 400 may need be able to locate itself in space after it moves. There are a number of ways to do this.

For example, in some embodiments, the portable laser cutter 400 is configured to use a camera to detect its new location after the portable laser cutter 400 has moved. In operation, the portable laser cutter 400 might see that the interior (i.e., under the portable laser cutter 400) has changed a small amount (e.g. the image viewed by a camera within the portable laser cutter 400 has shifted). Alternatively, the portable laser cutter 400 might use an exterior camera to see that the portable laser cutter 400 has moved a larger amount (e.g. see the prior image a ways away, or see that certain features of the material, such as the wood grain, are in a different location, thereby allowing the portable laser cutter 400 to triangulate its position).

In some embodiments, the portable laser cutter 400 additionally or alternatively uses location sensors to detect its new location. These location sensors in some embodiments comprise one or more (or all) of (i) inertial sensors such as accelerometers, (ii) absolute sensors such as GPS, (iii) sensors that use dead reckoning such as using one or more acoustic beacons, (iv) sensors that work collaboratively with other sensors, such as two similar devices using sound, light, or other signals to locate each other and/or determine relative distances between each other.

In some embodiments, the portable laser cutter 400 additionally or alternatively uses physical interaction to detect motion. For example, as the portable laser cutter 400 is dragged across the surface, a passive rolling wheel measures the distance.

In further embodiments, the portable laser cutter 400 additionally or alternatively moves itself by a measured amount. For example, wheels (e.g., wheels/rollers or other rolling members 404 shown in FIG. 4A) translate the portable laser cutter 400 1 inch in a given direction.

In still further embodiments, the portable laser cutter 400 is configured to employ any combination of the above-mentioned mechanisms and/or techniques to locate itself in space. For example, as a wheel (e.g., wheels/rollers or other rolling members 404 in FIG. 4A) drives (or attempts to drive) the portable laser cutter 400 forward, perhaps while the portable laser cutter 400 uses inertial sensors to validate that the portable laser cutter 400 has moved the desired or expected distance in the desired or expected direction.

### D. Preview Projector

One of the key challenges in fabrication using any tool is understanding what the ultimate result of the process will be. This is exacerbated for handheld power tools. For example, with hand-held circular saws, what is going to happen when the hand-held circular saw actually makes the cut? One approach is to project the results (e.g., an expected cut line) onto the material with a laser or other projection mechanism. Projecting the results in this manner works up to a point with a circular saw, since circular saws cut in a straight line, and such add-ons have become extremely popular for traditional circular saws. However, projecting an expected cut line in the manner performed by some existing hand tools suffers from many shortcomings, particularly in the context of the types of laser tools disclosed and described herein.

Accordingly, some laser tool embodiments include a projector that is more flexible and creates a visual indicator for the user to see the intended operation of the tool on the material to be processed. In addition, the user can create or modify a design for the intended operation, which may be used with or separately from the projector. The projector, and the features performed and/or enabled by the projector, can be used with any of the laser tools disclosed and described herein.

For example, a user may wish to carve out a circular shape from a plywood sheet using a laser tool akin to a woodworking router. After the user defines key characteristics such as the dimensions of the desired circle, the laser tool then projects an outline of the circle onto the plywood, showing where the cut will be made by the laser. After the laser tool has projected the outline onto the plyboard, the user aligns the laser tool along the projected line and proceeds to cut the plyboard with the laser, correctly carving out the desired circular shape from the plywood.

The projector on the laser tool can work in a number of ways. For example, the projector can be a laser projector that uses galvanometers to scan a single color or Red, Green, and Blue (RGB) laser to draw lines on the surface of the material. In other examples, the projector can be a Digital Light Processing (DLP) projector or a Liquid Crystal Display (LCD) projector, projecting the equivalent of a video screen onto the material. In some examples, the projector can use an Augmented Reality (AR) glasses arrangement, where the user can see the physical material through the AR glasses, and the AR glasses shows the cut line overlaid in an augmented reality space on top of the physical material. In some examples, the projector can use a Virtual Reality (VR) system, where sensors detect various aspects of the physical material to be processed and optionally the environment, and the VR system renders a virtual version of the physical material with the preview of the cut line on top of the rendered virtual version of the physical material so that the virtual version of the material and the cut line are viewable by a user via a virtual reality headset or other suitable virtual reality system.

Disclosed embodiments provide many ways for the user to specify what they want to make. For example, some embodiments enable a user to use a different device like a smartphone, tablet, or other computing device to pick a pattern for fabrication via the laser tool. In some examples, the laser tool includes a touch screen, keyboard, or other tool on the laser tool itself that is configured to enable a user to select a design for fabrication, edit a design for fabrication, operate/configure various laser tool parameters, and so on. In some examples, a picture taken with a camera integrated with the laser tool (or a picture taken with a different device like a phone) can be changed, edited, or otherwise altered or revised to create a design for fabrication by the laser tool. For instance, the user can put in limits like a circle and its size, and the laser tool (or a computing device configured to control the laser tool) can generate the design for fabrication. Further, a user can choose a pre-set design like a doorway that is saved on the laser tool, in online storage, or on another device like a phone.

In some embodiments, one or more cameras on the laser tool (or associated with the laser tool, e.g., on a smartphone configured to control/operate the laser tool) detect user hand movements, and the laser tool (or computing device associated with the laser tool) users the detected hand movements to enable the user to specify a design for fabrication, including selecting a design, editing a design, and so on. For instance, a user can trace a line on a material with their finger to indicate where they want to cut, and in response to detecting the user's tracing of the line onto the material, the laser tool projects the traced line onto the surface of the material. Also, the user can make a pinching motion to indicate they wish to resize a design projected onto a material, and in response to detecting the user's pinching motion, the laser tool resizes the design projected onto the material. In another example, the user can touch and drag a projected design off the material to indicate that they wish to remove or delete the design, and in response to detecting the user's dragging the projected design off of the material, the laser tool ceases projecting the design onto the surface of the material.

The user motions can be detected through a number of ways:

In some embodiments, a camera on the laser tool can detect the motion of the user's hand and fingers, for example locating the fingers, hand, and material relative to each other.

Some embodiments additionally or alternatively include a camera located elsewhere (e.g., a camera on a smartphone, tablet, or a camera separate from the laser tool) can detect the motion of the user's hand and fingers. For example, a camera next to the material that is in wireless or wired communication with the laser tool can be configured to detect the motion of the user's hand and fingers by, e.g., locating the fingers, hand, and material relative to each other.

In some embodiments, the laser tool (or smartphone, tablet, or other computing device associated therewith) is configured to detect movement of a glove, ring, and/or other wearable device worn by the user. For example, the user might wear a glove or ring which can be used to detect position by the laser tool. In some examples, the position of the glove or ring is detected via sensors, e.g., sensors embedded in the ring or glove individually or in combination with sensors in the laser tool. In some examples, the position of the glove or ring is detected by other methods, for example by acoustic location.

In some embodiments, the laser tool (or computing device associated therewith) is configured to detect movement of a stylus used by the user to provide inputs relating to the design for fabrication. For example, the user might use a stylus that interacts with the laser tool (or computing device associated therewith), for example acting as an RF beacon that the laser tool (or computing device associated therewith) uses to locate the position of the stylus and/or detect movement of the stylus.

The user's motions can be post processed in various ways. For example, lines drawn by the user can be made straight to offset tremor or imprecise drawing. In some examples, the material edge might be detected, for example of a 2×4 plank, and a cutline made perpendicular to the edge of the 2×4 plank. In some instances, a user's gesture might be interpreted as “clear all designs,” and in response to detecting the “clear all designs” gesture, the laser tool (or computing device associated therewith) “clears” the current design(s) and/or starts a new design session. Another user gesture might be interpreted as “take this shape and drag it over there,” and in response to detecting such a gesture, the laser tool (or computing device associated therewith) moves the selected shape to another area on the surface of the material.

Some embodiments additionally or alternatively use voice inputs to control one or more aspects of the laser tool operation. Voice can function independently or in conjunction with other input methods. For instance, a user may have a 2×4 piece of wood and voice a need for four one-foot pieces. In response to detecting the voiced input for “four one-foot pieces,” the laser tool (or computing device associated therewith) then generates a suitable spacing of lines on the 2×4 as a design. The projector on the laser tool (or separate from but associated with the laser tool as described earlier) then displays this design onto the surface of the 2×4 piece of wood.

Using voice in conjunction with other inputs, the laser tool enables a user to draw a line with their finger, then say “make it straight,” and “make another line 2.5 inches away from this line.” And in response to the set of hand motions and voice inputs, the laser tool (or the computing device associated therewith) generates the design for fabrication, and the projector projects the design for fabrication onto the material.

In operation, the projection of the design onto the material can be modified and adjusted, statically or in real time, to improve its utility.

For example, in some embodiments, one or more sensors (such as a camera) can detect where the material is positioned relative to the projector. Using this information, the system (i.e., laser tool individually or in combination with one or more computing devices associated with the laser tool) can modify the projection so that the projector projects the image to the correct location on the surface of the material. For example, the system can locate a 2×4 plank in space, so that the projector can project a laser line exactly (or nearly exactly) 1 foot from the end of the 2×4 plank, if the user has requested a one-foot cutoff.

In another example, one or more sensors are used to detect that the projector and/or the material have moved relative to each other. And after detecting that one or both of the projector and/or the material has been moved, the system (i.e., the laser tool individually or in combination) updates the projection based on the detected movement of the material (or projector) to ensure that the projection remains in the right place on the surface of the material.

In further embodiments, one or more sensors of the system determine whether the design for fabrication can be adequately projected onto the surface of the material, such as, for example, scenarios where the design is too large for the material or the projector is not located in a position where it can project the complete design onto the surface of the material, or the material has been removed from the work area. In response to detecting that the design for fabrication cannot be adequately projected on the surface of the material, the system causes the projector to project an error message instead of a preview of the design for fabrication.

Some embodiments include using multiple projectors. For example, multiple projectors may be used, to project designs for fabrication onto both the top and bottom of the material. Projecting designs for fabrication onto both the top and the bottom of the material is useful in embodiments where the laser tool has one or more lasers configured to apply one or more laser beams to both the top and the bottom of the material.

In some embodiments, the system is configured to modify the projection to account for the thickness of the material. For instance, if the user is cutting a thick piece of wood with the laser tool, the system in some embodiments is configured to adjust the projection to show the user where the cut will be on both the top and bottom of the wood.

In some embodiments, the system is further configured to adjust the projection to account for the angle of the cut. For example, if the user is using the laser tool for making a bevel cut, the projection can show the user where the cut will start on one side of the material and where the cut will end on the other side of the material.

In some embodiments, the system is also configured to adjust the projection to account for the kerf, or width of the cut. Adjusting the projection to account for the kerf can, in some instances, help the user to understand how much material will be removed by the laser during the cutting process.

In some examples, the system is configured to display a projection that shows the thickness of material that will be removed in addition to the path of the cutline of the laser.

In some examples, the projection can include the results of analysis on the design file, for example optimal locations for clamps or other holding devices to secure the material during the cutting process to avoid interfering with the cutting process, or projecting a red warning sign on a portion of the material that may be heat damaged by the proposed cutting process.

In further examples, the projection can include instructions to the user, such as an indication of how they should manually feed or otherwise manipulate the material during fabrication, and a notification when the feed or other manipulation is complete.

In still further examples, the projection can include typical user interface elements, such as those described on the touchscreen above. In such embodiments, the projection, combined with the ability to detect the user's fingers, hands, voice, or other inputs, enables the material (e.g., a sheet of plywood) into a smartphone-style interface.

In some embodiments, the projection can warn the user if they are moving the material or the laser tool in a way that is suboptimal for successful implementation of the device. For example, a red warning light may be displayed if the user moves the laser tool faster than the laser can cut through the material.

In some examples, the projection can also be used to show a preview of the material after fabrication is complete.

For example, if the user wishes to engrave a decorative image onto the surface of the material, the projection can not only show where the decorative image will be engraved onto the surface of the material, but the projection can also simulate the look of the wood that has been laser engraved with that decorative image.

In some instances, the system is further configured to adjust the projection to highlight the location of any potential hazards, such as knots in the wood or embedded nails or screws. For example, after detecting one or more potential hazards, (e.g., with sensors such as a camera, a magnetic sensor, etc.), the system can update/adjust the projection to indicate the location of the potential hazards on the surface of the material. This can allow the user to change their design file to avoid the potential hazards.

When a laser tool is being used to fabricate a design in a scenario where the user controls positioning of the material and/or positioning of the laser tool (or the position of the laser beam emitted by the laser tool), the user may make small errors. For example, if the user is trying to push a handheld straight-line laser cutter across material, the user may unintentionally move slightly left or right from a cut line projected onto the surface of the material. For example, if a user is trying to advance a 2×4 plank one foot forward in a laser miter saw type device to cut a one foot piece, the user may advance the material slightly more or less than one foot. In these cases, the system (i.e., the laser tool individually or in combination with one or more computing devices associated therewith) may use a variety of strategies to compensate.

In some embodiments, the laser tool uses onboard or offboard sensors to detect the motion of the laser tool relative to the design intention, including for example, detecting the motion of the laser tool relative to cut lines projected onto to the surface of the material, or detecting the motion of the laser tool relative to cut lines incorporated within a design projected onto to the surface of the material. In operation, the onboard or offboard sensor may include any one or more gyroscopes, accelerometers, Global Positioning System (GPS) locators, sensors that read beacons, or cameras that observe the motion of the laser tool and/or track the motion of the laser tool relative to a design projected onto the surface of the material.

After detecting or otherwise determining (via the one or more onboard or offboard sensors) that the laser tool has deviated from an intended or expected path, the system (i.e., the laser tool individually or in combination with one or more associated computing devices) adjusts the cutting action of the laser beam emitted by the laser tool to compensate for the deviation. For example, if the user moves a laser saw slightly to the left of an intended or expected cut line, the laser saw shifts the laser beam slightly to the right so that the laser beam emitted by the laser saw continues to follow the intended or expected cut line even though the movement of the laser saw has drifted slightly off course. In operation, the laser saw may adjust the laser beam using motors on a linear system, galvanometers to deflect the beam, or other systems commonly used for stabilization.

In some instances, the laser tool additionally or alternatively includes a passive motion compensation system, for example a mass and spring system that allows the laser to “float” and absorb small movements, or a physical gyroscope that keeps the laser aligned passively even if the laser tool rotates or otherwise deviates from an intended or expected cut line.

In some instances, the laser tool is configured to detect when the user's motion renders the laser tool unable to render an intended design with sufficient precision, for example if the user moves a laser saw too far from the intended cutline for the design. In some such embodiments, after determining that the laser tool has been moved sufficiently far off course from an intended or expected cut line, the system (i.e., the laser too individually or in combination with one or more associated computing devices) turns off the laser beam, or otherwise halts or pauses emission of the laser beam.

In some embodiments, the laser tool includes a feedback system that alerts the user when the laser tool is on course or deviating from the intended cut line. In some such embodiments, the alert includes any more or more of (i) a visual alert, such as a change in the projected image with an alert or with arrows to guide the user, (ii) an auditory alert, such as a beep or a change in pitch, (iii) a haptic alert, such as a vibration that cautions the user that the laser tool is deviating from an intended or expected path, or (iv) any other type of alert now known or later developed that is suitable for alerting a user of the laser tool that the laser tool has deviated from its intended or expected path.

In some embodiments, the laser tool is configured to physically push the laser tool back on track, for example, by turning rollers (e.g., rolling members 404 shown in FIG. 4A) to tend to move the laser tool back in the correct direction.

### E. Handheld Laser Straight-Line Cutter

In some embodiments, the laser tool comprises a handheld laser straight-line cutter. A handheld laser straight-line cutter can replace a dangerous spinning circular saw with a safe, clean, quiet, precise, maintenance-free laser that, unlike circular saws, does not require replacement blades.

In some embodiments, the handheld laser straight-line cutter may not be in a typical enclosure used with traditional laser cutting tools. Because the handheld laser straight-line cutter is designed to accommodate material that is much larger than the handheld laser straight-line cutter, the handheld laser straight-line cutter may not fully enclose the material. In operation, the handheld laser straight-line cutter is moved by the user by hand, or in some instances, the handheld laser straight-line cutter is moved using rollers or tracks. In some instances, the entirety of the handheld laser straight-line cutter moves while the material remains stationary.

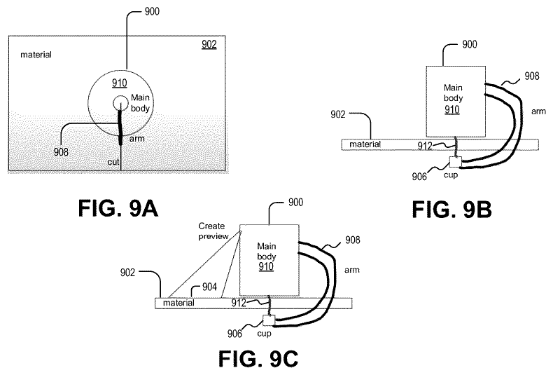

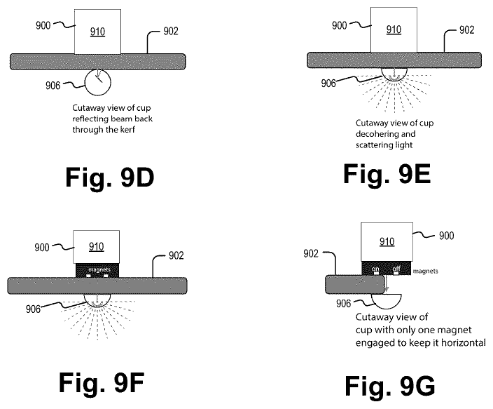

FIG. 9A is a top view of an example handheld laser straight-line cutter 900 cutting a material 902 according to some embodiments, FIG. 9B is a side view of an example handheld laser straight-line cutter 900 cutting a material 902 according to some embodiments, and FIG. 9C is a side view of an example handheld laser straight-line cutter 900 cutting a material 902 according to some embodiments, where the handheld laser straight-line cutter 900 is projecting a created preview image, or projected design 904, onto the surface of the material 902.

As shown in FIGS. 9A-9C, in operation, after a user has placed the handheld laser straight-line cutter 900 (performing a cutting function similar to a saw) down on the material 902, the handheld laser straight-line cutter 900 projects a design 904 (e.g., including at least one cut line) on the surface of the material 902 that shows where the cut implemented by the laser of the handheld laser straight-line cutter 900 will be implemented on the material 902.

As described in more detail below, in some embodiments, the user can adjust the cutline by dragging their fingers across the material 902. As described earlier, a camera on (or associated with) the handheld laser straight-line cutter 900 detects the user's finger movements within the field of vision of the camera. When the user picks up the handheld laser straight-line cutter 900, the projected design 904 (e.g., including at least one cut line) remains steady.

In operation, the user pulls the trigger (to activate the laser of the handheld laser straight-line cutter 900) and slides the handheld laser straight-line cutter 900 approximately down the projected line (of the projected design 904). While the user is moving the handheld laser straight-line cutter 900 along the projected design 904, the handheld laser straight-line cutter 900 adjusts the location of the laser beam applied to the surface of the material 902, for example by using translation or rotation with motors or galvanometers, directly moving the laser or moving optics that translate the laser, to ensure that the handheld laser straight-line cutter 900 will execute a perfectly (or near perfectly) straight and clean cut across the material 902 to implement the projected design 904 onto the surface of the material 902.

In other embodiments, the handheld laser straight-line cutter 900 runs along a track that guides the handheld laser straight-line cutter 900 in a straight line so that the stabilization of the laser is not necessary. In some situations, a hand-held 300-watt solid-state laser can instantly vaporize plywood, sheetrock, and lumber up to 1.5″ thick. As discussed in more detail below, an onboard safety system can, in some embodiments, instantly pause the cut (e.g., by shutting off or pausing the laser beam) if the system (i.e., the handheld laser straight-line cutter 900 individually or in combination with one or more computing devices configured to control one or more aspects of the handheld laser straight-line cutter 900) detects that someone is too close to the operation of the handheld laser straight-line cutter 900 without wearing safety glasses, or in other scenarios where the laser should be shut off or paused to avoid a situation where a person might be harmed by the laser beam or the material (or other objects) might be damaged by accident.

In some embodiments, the handheld laser straight-line cutter 900 uses image stabilization technology to cut a straight line without the use of a rail. Also, as mentioned above the handle or arm 908 holding the cup 906 can be sized to fit within the kerf (i.e., the thickness of the material removed).

The handheld laser straight-line cutter 900 according to embodiments includes one or more of the following features: (i) a motion-stabilized onboard projector that draws a cut line (e.g., a cut line as part of a projected design 904) and locks the handheld laser straight-line cutter 900 in place before the handheld laser straight-line cutter 900 starts to cut the design 904 on the material 902, (ii) one of more sensors (e.g., cameras or other sensors) that allow the user to move the projected cutline (e.g., within projected design 904) with a stylus, their fingers, or another physical interface before the handheld laser straight-line cutter 900 starts implementing the projected design 904, (iv) a motion-stabilized, 300-watt solid-state laser or other suitable laser (e.g., implemented by a laser diode array) that tracks the projected cutline of the projected design 904 exactly (or reasonably close thereto) for perfectly straight (or substantially straight) cuts exactly (or reasonably close thereto) where the user planned the cuts.

A handheld laser straight-line cutter 900 consistent with some embodiments disclosed herein has several advantages over traditional rotary saws.

For example, by monitoring the application of the laser beam to the material 902 during operation of the handheld laser straight-line cutter 900, the system (i.e., the handheld laser straight-line cutter 900 individually or in combination with one or more computing devices associated therewith) can adjust the application of the laser, e.g., by keeping a cut at 90 degrees relative to the edge of the material, or by moving the laser to track an intended design (e.g., a design 904 projected onto the surface of the material 902) to generate much more accurate cuts than a traditional, user-operated saw tool.

Additionally, the handheld laser straight-line cutter 900 is much quieter in operation than a traditional saw tool.

Also, a handheld laser straight-line cutter 900 generates a much smaller kerf compared to a traditional rotary saw. For example, the handheld laser straight-line cutter 900 according to some embodiments generates a small 0.01″ kerf that wastes twelve times less material than a traditional saw with a 0.125″ kerf.

Further, a handheld laser straight-line cutter 900 according to some embodiments can, at least in some instances, be operated more safely than a traditional rotary saw. For example, some embodiments can be used with a Visionguard artificial intelligence system that uses dual cameras to scan a job site and pause the handheld laser straight-line cutter 900 instantly (or very quickly) if a human without safety glasses comes within a certain distance (e.g., six feet) of the handheld laser straight-line cutter 900.

In some embodiments, the handheld laser straight-line cutter 900 can also connect to traditional or novel inputs such as a mouse and keyboard or a haptic or VR/AR system for input and output to preview, configure, and control the cutting operation.

The handheld laser straight-line cutter 900 can be implemented in any suitable way. The following paragraphs provide some example implementation details. It should be understood that these are merely examples and that other implementations are possible.

In some implementations, the handheld laser straight-line cutter 900 can have the size of a traditional circular saw and can be optimized for straight line cuts. Some such embodiments include one or more arrays of diode lasers that are combined to generate hundreds of watts of power (e.g., 300 W or other suitable power levels) to cut through a typical job-site material (e.g., ¾″ piece of plywood, 4×2 studs, finished woods like cherry and walnut, etc.). The laser diodes in the one or more arrays of laser diodes may be in appropriate wavelengths such as 450 nm, 488 nm, or infrared wavelengths.

In some embodiments, the handheld laser straight-line cutter 900 is designed to take power density and air flow into account when operating the laser(s) to cut or otherwise process material 902.

Thus, in at least some embodiments, the handheld laser straight-line cutter 900 can be optimized for straight line cuts, be AC powered, with its main body housing one or more processors, a solid-state laser array to generate high power density laser light, and a cooling system (e.g., fans, liquid cooling, etc.).

Also, in some implementations, the handheld laser straight-line cutter 900 uses a receptacle (e.g., cup 906) designed to catch/absorb laser power as the laser beam 912 cuts through the material 902. In some configurations, an arm 908 (or other support) connects the cup 906 to the main body 910 of the handheld laser straight-line cutter 900. In some embodiments, the arm 908 (or other support) is adjustable in length to accommodate different material thicknesses. In some embodiments, in addition to or instead of the arm 908, the cup 906 (or other receptacle configured to catch/absorb power from the laser beam 912) is magnetically held under the material 902 to capture/absorb the power of the laser beam 912 as the handheld laser straight-line cutter 900 cuts through the material 902.

In some embodiments, the laser array is on an x-axis that moves parallel to the surface of the material 902 to maintain the desired cut, such as a straight line. If the handheld laser straight-line cutter 900 cannot adjust the laser beam so that the laser beam cuts on the line, for example because the laser is translated or rotated beyond the ability of the handheld laser straight-line cutter 900 to compensate for that translation or rotation of the laser, the handheld laser straight-line cutter 900 in some embodiments is configured to one or more of (i) shut off the laser, (ii) notify the user, or (iii) take an another action.

In some configurations, the laser of the handheld laser straight-line cutter 900 can be resumed automatically or manually when the handheld laser straight-line cutter 900 returns to a location where the laser can again be directed to implement the user's intended cutting action.

As mentioned above, in some embodiments, the handheld laser straight-line cutter 900 uses a receptacle (e.g., cup 906) designed to catch laser power as the laser beam 912 cuts through material 902. The cup 906 in some embodiments is in communication with the main body 910 of the handheld laser straight-line cutter 900 using cabling through a physical connection such as an arm 908, or the communication can be wireless (e.g., using RF, Bluetooth, modulating the laser beam 912 itself to contain data, etc.) The cup 906 in some embodiments is designed to catch/absorb power from the laser beam 912 as the handheld laser straight-line cutter 900 cuts through material 902 and safely dispose of the excess power.

FIGS. 9D, 9E, 9F, and 9G show example configurations of a handheld laser straight-line cutter 900 equipped with a cup 906 configured to safely handle excess laser power as the handheld laser straight-line cutter 900 cuts through material 902 according to some embodiments.

The cup 906 can safely dispose of excess laser power in several ways. For example, in some embodiments, the optical power can be sent back to the main body 910 of the handheld laser straight-line cutter 900, which may be better equipped to dissipate or otherwise safely handle the optical power.

For example, the cup 906 can route light back up through an optical fiber that runs through a physical connection such as a flexible cable or rigid arm 908 to the main body 910.

Alternatively, and as illustrated in FIG. 9D, the cup 906 in some embodiments is configured to reflect light directly through the air back into the main body 910 of the handheld laser straight-line cutter 900 (e.g., at a slight angle through the kerf).

Either the cup 906 or the main body 910 of the handheld laser straight-line cutter 900 can safely dispose of the excess laser power. For example, the cup 906, individually or in combination with the main body 910 of the handheld laser straight-line cutter 900 can simply absorb the excess laser light and heat up.

In some configurations, and as illustrated in FIG. 9E, the cup 906 is configured to emit the optical energy in another form or as non-coherent optical energy (for safety reasons). For example, the cup 906 in some examples is configured to diffuse or scatter the light energy, so the cup 906 glows like a lightbulb. In operation, the cup 906 splits the light into smaller, safer beams with reflection. In some instances, the cup 906 converts the energy into another form, such as re-emitting the energy at a different wavelength or decohering the laser light. In some examples, the cup 906 widens the beam such as by putting it through a convex lens. In some embodiments, a super-wide-angle lens with a glass container surrounds the cup 906 (or a substantial portion of the cup 906), where the super-wide angle lens is arranged to spread the beam. In still further examples, electric energy can be pumped into the cup 906 to power cooling mechanisms such as fans, chillers, or thermoelectric coolers.

In further examples, the cup 906 is configured to transfer energy elsewhere, via a cable or rigid connection, for example via heating a liquid that flows through the cable or rigid connection (e.g., arm 908 shown in FIGS. 9A-9C) or via an optical cable, so that the energy may be disposed of in another unit such as a large mass that can simply absorb the excess heat.

The cup 906 in some configurations can be used in a closed-loop system to ensure that the laser is cutting through the material 902. For example, sensor measurements in the cup 906 such as optical power or thermal temperature can be used as a part of a control loop such as a PID loop to regulate parameters of the cut.

In some implementations, the handheld laser straight-line cutter 900 adjusts the laser power so that the power that reaches the cup 906 is within an acceptable band or range. If the user moves the handheld laser straight-line cutter 900 faster than expected, then the material 902 will be exposed to less energy, and the amount of laser power getting through the material 902 and reaching the cup 906 will drop. In such a scenario, the handheld laser straight-line cutter 900 may be configured to increase the laser power. In another example, if the user moves the handheld laser straight-line cutter 900 too quickly, the handheld laser straight-line cutter 900 may shut the laser off (e.g., cut the laser power to zero) if the system determines that the laser no longer has time to cut through the material 902. In such a scenario, the handheld laser straight-line cutter 900 may cut the laser off fully and notify the user. In another example, excess power measured at the cup 906 might mean that the user stopped moving the handheld laser straight-line cutter 900 and the material 902 has already been cut through. And in such an instance, the handheld laser straight-line cutter 900 may then shut off the beam.

The cup 906 and the main body 910 of the handheld laser straight-line cutter 900 both provide an opportunity to mount sensors that can detect stray laser light. Those sensors might detect laser light in amounts or locations where laser light should not be found. For example, if a cup 906 was designed to absorb all light, a shroud of material can be arranged to surround the cup 906 with a sensor coupled to the material that would detect laser light striking the shroud. If the sensor detected light, detection of the light would indicate that light was escaping so that the handheld laser straight-line cutter 900 could then take appropriate safety measures, such as notifying the user or shutting down the laser.

Referring back to FIGS. 9A-9C, the arm 908 used to support the cup 906 can take any suitable form. For example, the arm 908 can take the form of a thin (flat) metal (e.g., Titanium) arm that connects the cup 906 to the main body 910 of the handheld laser straight-line cutter 900 to support the cup 906. The arm 908 can be thin enough (e.g., 0.01″) to slide through the kerf that was just cut by the laser. In addition to serving as a way to keep the cup 906 underneath the beam, the arm 908 in some embodiments also houses communication cabling and/or electric (power) cabling between main body 910 and the cup 906. The arm 908 is also designed in some instances to be used by a user to facilitate moving the handheld laser straight-line cutter 900 over the material 902 to perform a cut.

The handheld laser straight-line cutter 900 in some embodiments includes or uses a safety device to make sure nearby people are safe. For example, the safety device can have one or more cameras with image processing technology for example using AI to determine if there are any people within a certain range who do not have appropriate safety gear. The safety device can be a companion device (e.g., a stand-alone pole mounted with omni-directional camera(s) or can be the tool itself with sensors looking outward in all directions (e.g., panoramic camera(s)). The safety device can set any suitable safety threshold to detect situations, such as, but not limited to, if people are near (e.g., within 6 feet), if there are people in blind spots, and if identified people are wearing safety glasses (e.g., if anyone comes in a zone (say, six feet), the person is identified, and it is determined if they are wearing safety glasses; if not identified to have safety glasses, the cutter can disable the laser). In some situations, uniquely-recognizable safety glasses (e.g., image recognition glasses, glasses with enabled sensors, glasses that transmit an identifier wirelessly, etc.) can be used. These features can be used in any of the embodiments presented herein.

In some implementations, the safety system regularly checks camera data. If the safety system identifies a human in the camera data who is not wearing safety glasses, the safety system sends a signal (e.g., a safety alert signal) to the handheld laser straight-line cutter 900. Upon receipt of that safety alert signal, the handheld laser straight-line cutter 900 takes appropriate action, for example turning off the laser and/or notifying the user about the issue. In some implementations, the safety system additionally or alternatively determines the distance of the humans that the safety system has detected by using camera data, by communicating with special safety glasses that have a transponder, by communicating with wirelessly enabled safety glasses, or another mechanism. In some instances, the safety system only reacts if the humans it detects are within a designated distance, which may be determined by physical markings around the workspace, by calculation of the nominal hazard zone based on information about the laser system, or by other factors.

In some embodiments, and as mentioned above, the handheld laser straight-line cutter 900 uses image stabilization technology to cut a straight line without the use of a rail. Also, as mentioned above the handle or arm 908 holding the cup 906 can be sized to fit within the kerf (i.e., the thickness of the material removed).

In some embodiments, and as illustrated in FIGS. 9F and 9G, the cup 906 can be magnetically held to the bottom of the material 902 during operation of the handheld laser straight-line cutter 900.

As noted above, the handheld laser straight-line cutter 900 can use any of the various features noted above and below. The following paragraphs provide examples of various features and combinations that can be used in some embodiments. It is important to note that these are merely examples and that other/different features and combinations can be used.

In some examples, the handheld laser straight-line cutter 900 can be the size of a traditional circular saw, although other dimensions are possible. The head in the main body 910 in some embodiments of the handheld laser straight-line cutter 900 includes an array of solid-state laser diodes to generate hundreds of watts of power (e.g., 300 W) or other suitable amounts of power. The main body 910 in some embodiments also includes a cooling system (e.g., fans, liquid cooling). In some configurations, a controller is also contained in the main body 910 of the handheld laser straight-line cutter 900. In some embodiments, the handheld laser straight-line cutter 900 acts as a self-contained unit (e.g., motion planning, image processing, user interface, etc., all done locally in the main body 910 of the handheld laser straight-line cutter 900). In some instances, the main body 910 is arranged to rest directly on the material 902, which helps ensure a fixed distance between the array of laser diodes of the handheld laser straight-line cutter 900 and the material 902. Also in arrangements where the main body 910 of the handheld laser straight-line cutter 900 rests directly on the material 902, the main body 910 encloses (or substantially encloses) the laser emitted from the head and applied to the material 902. Movement of the handheld laser straight-line cutter 900 in some embodiments is facilitated by wheels, ball bearings, slides, Teflon material, etc. on the underside of the main body, such as rolling members 404 shown in FIG. 4A. Examples of materials that may be cut by the handheld laser straight-line cutter 900 include typical job-site material (¾″ plywood, 4×2 studs, finished woods, etc.). As described above, a cup 906 is used to catch laser power as the laser passes through the material 902. A thin arm 908 (e.g., thin metal such as Titanium) is used in some embodiments to connect the cup 906 to the main body 910. The thickness of the arm 908 can be thin enough, so that it slides through the kerf generated by the laser as the laser cuts through the material 902 (e.g., 0.01″). The arm 908 in some instances is sufficiently rigid to keep the cup 906 underneath the beam as the handheld laser straight-line cutter 900 moves and cuts through the material 902. The arm 908 in some embodiments additionally houses communication and/or power cabling from the main body 910 to the cup 906, and in some instances, the arm 908 is adjustable in length. In some embodiments, the laser is implemented on a gantry that moves the head to maintain a straight or substantially straight cut. The handheld laser straight-line cutter 900 in some examples is powered using any one or more of AC power, DC power, battery power, etc.

In some embodiments, the handheld laser straight-line cutter 900 also implements an autofocus feature, including multipoint autofocus. In operation, autofocusing the laser helps ensure that a consistent quantity of electromagnetic energy is delivered to the material 902 even when the material 902 exhibits variations in thickness (and/or height). Multipoint autofocus may be performed based on a height map generated, for example, by projecting and measuring structured light on the surface of the material 902. For example, as the handheld laser straight-line cutter 900 moves across the material 902, the handheld laser straight-line cutter 900 adjusts the focusing of laser onto the surface of the material 902 based on a detected distance between the laser and the surface of the material 902, thereby ensuring that variations in the height (and/or thickness) of the material 902 do not give rise to variations in the quantity of laser energy delivered to the material 902. In some cases, autofocus may be combined with edge detection to further ensure that the delivery of the laser energy ceases beyond the one or more edges of the material 902. Additional details of autofocusing a laser, including multipoint autofocus, any of which can be used with the laser tools disclosed and described herein (including but not limited to handheld laser straight-line cutter 900), are described in more detail in (i) U.S. application Ser. No. 17/133,908, titled “Computer numerically controlled fabrication using projected information,” filed on Dec. 24, 2020, and issued as U.S. Pat. No. 11,740,608 on Aug. 29, 2023; (ii) U.S. application Ser. No. 18/155,049, titled “Height Measurement Techniques and Uses Thereof,” filed on Jan. 16, 2023; and (iii) U.S. application Ser. No. 16/691,426, titled “Laser cutter engraver material height measurement,” filed Nov. 21, 2019, and issued as U.S. Pat. No. 11,537,096 on Dec. 27, 2022. The entire contents of U.S. application Ser. Nos. 17/133,908; 18/155,049; and 16/691,426 incorporated herein by reference.

In some embodiments where the handheld laser straight-line cutter 900 includes a gantry to control movement of the laser, controlling the gantry enables the handheld laser straight-line cutter 900 to cut in a straight line, rather than jiggling because of e.g. small unwanted hand motions, because the x-axis gantry allows the head to move horizontally to correct for horizontal movement (e.g., drift as a user moves the main body 910 of the handheld laser straight-line cutter 900 along the material 902) of the main body 910 that would otherwise result in a cut that is not straight.

In some embodiments, a pair of galvanometer scanners and a low-power eye-safe laser can be used to create a preview (e.g., projected design 904 in FIG. 9C) of the cut on the material 902 that shows where the handheld laser straight-line cutter 900 is planning its cut. As described earlier, the location of the preview (e.g., projected design 904 in FIG. 9C) can be manipulated with physical movement (e.g., a user may adjust the location of the preview by interacting with the laser preview with their hands or another device). Image recognition can be used to identify where the line is intended to be relative to the material 902, for example explicitly or implicitly referencing physical features of the material 902 so that the material 902 can be properly located, stabilized, moved, etc. If the main body 910 of the handheld laser straight-line cutter 900 is outside of where the line is intended to be, then the handheld laser straight-line cutter 900 may shut off the laser, as described previously.

### F. Handheld Laser Omni-Directional Saw

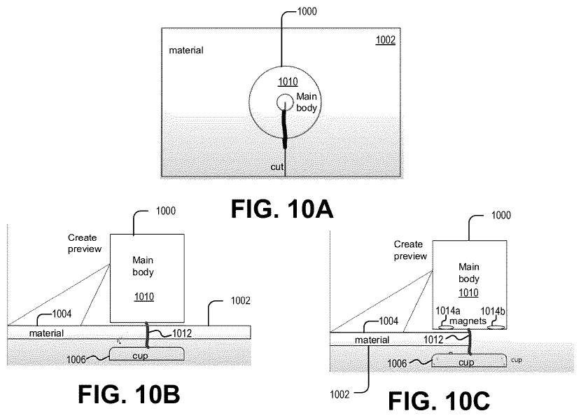

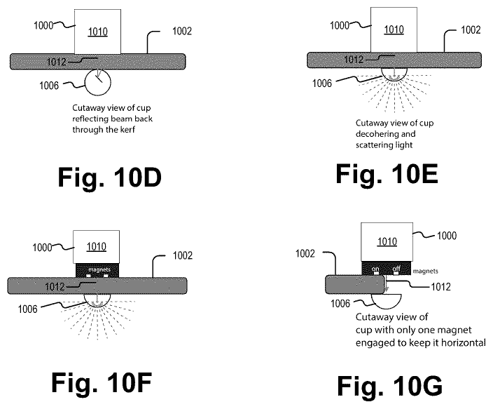

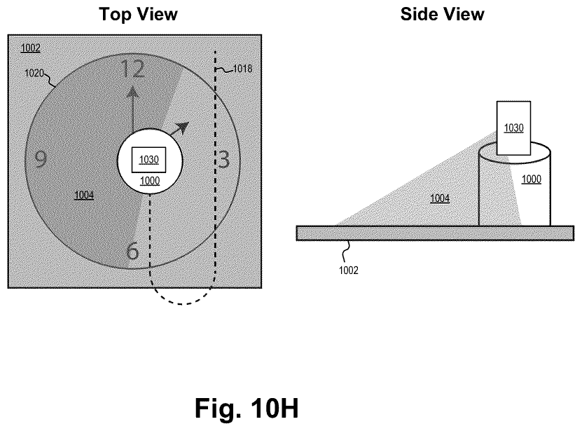

In another embodiment, a single handheld tool (a handheld laser omni-directional saw) is provided that can replace a circular saw, router, table saw, jointer, rotary cutter, drill, reciprocating saw, miter saw, jigsaw, measuring tape, and laser level. FIGS. 10A-10G show examples of handheld laser omni-directional saw 1000 according to some embodiments. Features and aspects of the handheld laser omni-directional saw 1000 are described herein.

In some embodiments, the handheld laser omni-directional saw 1000 functions as a circular saw. When functioning as a circular saw, the handheld laser omni-directional saw 1000 behaves the same as (or substantially the same as) the handheld laser straight-line cutter 900 described above-except that instead of being constrained to only cutting in a straight line as the handheld laser straight-line cutter 900, the handheld laser omni-directional saw 1000 is also capable of other features.

However, constraining the handheld laser omni-directional saw 1000 to cut in a straight line offers certain cost advantages (for example, the laser might only be stabilized in the X direction, and not the Y direction), and allow certain physical design decisions (for example, if the kerf is always straight, then the cup 1006 might be coupled to the main body 1010 of the handheld laser omni-directional saw 1000 with a flat arm that is thin enough to go through the kerf). Creating an omni-directional saw does not preclude the use for straight lines, but trades off some engineering complexity for the capability to perform other actions.

In some configurations, the handheld laser omni-directional saw 1000 can function as a table saw in that the handheld laser omni-directional saw 1000 can be mounted in a stationary manner and the material 1002 may slide over the swathe handheld laser omni-directional saw 1000. The stabilization mechanisms described elsewhere can ensure that the cut is always as intended, taking appropriate action if the material 1002 moves too far off course.

The handheld laser omni-directional saw 1000 can also function as a router in several ways.

For example, routers are often used with a straight bit to cut curved shapes, either freehand or with the help of a template. Like a router, the handheld laser omni-directional saw 1000 can move in any direction in the X direction or the Y direction, so the handheld laser omni-directional saw 1000 can replicate the same functionality as a traditional router.

Additionally, sometimes routers cut with a straight bit to a fixed location. In operation, the laser beam of the handheld laser omni-directional saw 1000 can be modulated to cut only part way into the material 1002 to “engrave” the material 1002 to a specified depth, to replicate this functionality of a traditional router, with a straight, V-groove, circular, or other shape cross section.

Also, sometimes routers are used with angled bits, for example to miter a corner. In operation, the laser beam of the handheld laser omni-directional saw 1000 may be tilted, mechanically moving the laser or using mirrors driven by motors or galvanometers for example, to cut the material 1002 at a tilt. For example, the laser beam of the handheld laser omni-directional saw 1000 might be used with two passes to create the effect of a chamfer bit, cutting twice at different angles, or the laser beam might engrave in a single pass for example by moving the laser perpendicular to the direction of motion of the handheld laser omni-directional saw 1000 with a motor or galvanometer to engrave a chamfer profile. This technique can also be applied to the handheld laser straight-line cutter 900 described above, but the handheld laser omni-directional saw 1000 allows the technique to apply over curves and arbitrary shapes on the material 1002.

In some configurations, the handheld laser omni-directional saw 1000 can perform the functions of a jointer by engraving the surface of the material 1002 so that the surface of the material 1002 is flat.

In some configurations, the handheld laser omni-directional saw 1000 can replace a drill by moving the laser beam of the handheld laser omni-directional saw 1000 so that the laser beam cuts a hole or other shape into the material 1002.

The handheld laser omni-directional saw 1000 in some configurations can also perform the functions of a measuring tape and laser level by using onboard sensors and UI or projectors or other interface elements to convey the appropriate measurement information, thereby obviating the need for a measuring tape or laser level in some instances.

The handheld laser omni-directional saw 1000 can cut freely in any direction-carving complex shapes from materials such as, but not limited to, plywood, sheetrock, and lumber. The user can provide design data (e.g., a pencil mark or a CAD diagram), and the handheld laser omni-directional saw 1000 can ingest that design data to understand the user's intention. Then, optionally, with a projector, the handheld laser omni-directional saw 1000 can project cut lines onto the material 1002 to confirm the design, or show a preview of the expected final results of the fabrication. Then, the user can slide the handheld laser omni-directional saw 1000 over the material, while the laser (e.g., 300-watt laser) of the handheld laser omni-directional saw 1000 slices the material 1002 cleanly through, or engraves the material 1002 to a specified depth. In one application, a user can take a picture (e.g., of a desired design) with their phone, and then transmit the photo to the handheld laser omni-directional saw 1000 for cutting. After the handheld laser omni-directional saw 1000 receives the photo from the phone, the handheld laser omni-directional saw 1000 cuts the desired design precisely (e.g., in plywood, lumber, or sheetrock) to match a complex wall line. From tiny perforations and drill holes to ripping 2×4s and slicing sheetrock profiles, the handheld laser omni-directional saw 1000 can be designed to be precise and powerful enough to handle a variety of fabrication tasks.

The handheld laser omni-directional saw 1000 (and also the handheld laser straight-line cutter 900) are configurable to engrave the material 1002, either while cutting or as a separate pass. To enable the engraving feature, the handheld laser omni-directional saw 1000 moves the laser beam perpendicular to the direction of motion, which is possible because of the stabilization functionality.

For example, FIG. 10H shows a top view and a side view of an example handheld laser omni-directional saw 1000 according to some embodiments.

In the example shown in FIG. 10H, the handheld laser omni-directional saw 1000 is being moved, either by the user or in some motorized fashion e.g. wheels, back and forth to cover the surface of the material 1002 to be processed. In this example, the laser is emitted downward from the handheld laser omni-directional saw 1000 onto the surface of the material 1002 (away from the viewer). In operation, the handheld laser omni-directional saw 1000 is configured to translate the laser in the X direction and/or the Y direction under the handheld laser omni-directional saw 1000. The projector 1030 projects the design 1020 (i.e., the image of a clock face), including a circle that is to be cut, and numbers and arrows that are to be engraved as part of the design 1020. As the user moves the handheld laser omni-directional saw 1000 back and forth over (e.g., along path 1018) the area of the material 1002 to be processed, the laser moves back and forth under the handheld laser omni-directional saw 1000 more quickly and/or at lower power to engrave the arrows and the numbers of the design 1020. And the handheld laser omni-directional saw 1000 moves more slowly and/or at higher power to cut the circle component of the design 1020. In some instances, the handheld laser omni-directional saw 1000 might also perform the cut and engravings in separate passes. As the handheld laser omni-directional saw 1000 performs the cuts and engravings, the handheld laser omni-directional saw 1000 marks and cuts the material 1002 where the projector 1030 indicates, even though the user is moving the handheld laser omni-directional saw 1000 and thus the projector 1030 positioned on the handheld laser omni-directional saw 1000.

In operation, the handheld laser omni-directional saw 1000 is able to engrave simple shapes (like lines), photographs (using processes like dithering or varying power to vary brightness), mechanical features (e.g. varying the laser power to create a 3D engraving which allows it to create a v-groove), and any other standard laser engraving process.

In some embodiments, the handheld laser omni-directional saw 1000 has an omni-directional cutting motion that can cut curves, holes, straight lines, complex shapes, and more. As noted above, the handheld laser omni-directional saw 1000 can accept CAD files, pencil sketches, and camera photographs as design data. Further, as suitable, the handheld laser omni-directional saw 1000 can have any of the features noted above with respect to the handheld laser straight-line cutter 900 or any of the other features of any of the other laser tool embodiments presented herein.

In some embodiments, the handheld laser omni-directional saw 1000 has the dimensions of a traditional router and uses an array of diode lasers combined to generate hundreds of watts of power (e.g., 300 W or another suitable power) to cut through typical job-site material (e.g., ¾″ plywood, 2×4 studs, finished woods like cherry and walnut, etc.). The handheld laser omni-directional saw 1000 in some embodiments is designed with power density and air flow considerations in mind and, in at least some embodiments, the handheld laser omni-directional saw 1000 is optimized for performing circular or straight cuts. The handheld laser omni-directional saw 1000 can be powered from the electrical mains (or via batteries in some configurations), and the main body 1010 of the handheld laser omni-directional saw 1000 in some configurations houses one or more processors, a solid-state laser array configured to generate high power density, and a cooling system (e.g., fans, liquid cooling, etc.).

FIG. 10A shows a top view of an example handheld laser omni-directional saw 1000 cutting a material 1002 according to some embodiments, FIG. 10B shows a side view of an example handheld laser omni-directional saw 1000 cutting a material 1002 according to some embodiments, where the handheld laser omni-directional saw 1000 is projecting a created preview image 1004 on the material 1002, and FIG. 10C shows a side view of an example handheld laser omni-directional saw 1000 cutting a material 1002, where a cup 1006 is held to the bottom surface of the material 1002 saw via magnets 1014a-b within the handheld laser omni-directional saw 1000. Additionally or alternatively, the cup 1006 may also include magnets (not shown in FIGS. 10A-C).

In FIGS. 10A-C, the cup 1006 (or similar receptacle) is used to catch laser power as the laser power emitted by the laser of the handheld laser omni-directional saw 1000 goes through material 1002. The cup 1006 in some embodiments is magnetically held to the bottom surface of the material 1002 via magnets 1014a-b within the main body 1010 of the handheld laser omni-directional saw 1000 (instead of through an arm, e.g., arm 908 of handheld laser straight-line cutter 900). More information about the cup 1006 is provided in the embodiments described above with reference to the handheld laser straight-line cutter 900 and below.

Assuming y-axis motion of the handheld laser omni-directional saw 1000, the laser module of the handheld laser omni-directional saw 1000 can be on an x-axis gantry that moves horizontally to maintain a “straight” cut along the material 1002. Similar to the handheld laser straight-line cutter 900, if the handheld laser omni-directional saw 1000 determines that it cannot cut along the line for some reason, the handheld laser omni-directional saw 1000 shuts off the laser(s) or takes some other action).

In some embodiments, the laser module includes a single laser. In other embodiments, the laser module includes a laser array comprising a plurality of lasers.

Alternatively, in some embodiments where the laser module is instead mounted on an X-Y gantry that allows the laser(s) to move in both the X and Y dimensions to ensure cuts in any direction are aligned with a design. The laser beam(s) can also be tilted, with motors or galvanometers, either directly by moving the laser(s) or indirectly by manipulating optical elements, to accommodate for tilt in the saw or to deliberately cut an angled path. In addition to the laser control features that are specific to the handheld laser omni-directional saw 1000, the laser(s) of the handheld laser omni-directional saw 1000 can be controlled in any of the manners described above with reference to the handheld laser straight-line cutter 900. Similarly, handheld laser omni-directional saw 1000 can receive user inputs (e.g., via hand motions, sensors, voice inputs and so on) to obtain designs and facilitate the manipulation of designs in any of the manners described above with reference to handheld laser straight-line cutter 900.

As mentioned above, in some embodiments, a cup 1006 (or other suitable receptacle component) can be used to catch laser power as the laser 1012 passes through material 1002. In some configurations, the cup 1006 communicates with the main body 1010 of the handheld laser omni-directional saw 1000 wirelessly (e.g., using RF, Bluetooth, data modulated on the laser beam, etc.).

In some embodiments, and similar to handheld laser straight-line cutter 900, one or more electromagnets (e.g., magnets 1014a and 1014b shown in FIG. 10C) in the main body 1010 of the handheld laser omni-directional saw 1000 are configured to hold the cup 1006 magnetically against the bottom surface of the material 1002.

During operation of the handheld laser omni-directional saw 1000, the edge of the handheld laser omni-directional saw 1000 may extend over an edge of the material 1002 as illustrated in FIG. 10C and FIG. 10G. In a such a scenario, a portion of the cup 1006 may also extend past an edge of the material 1002, as illustrated in FIGS. 10C and 10G.

In some embodiments, when a portion of the cup 1006 extends past an edge of the material 1002, the handheld laser omni-directional saw 1000 is configured to disengage one or more of the electromagnets positioned in the portion of the main body 1010 of the handheld laser omni-directional saw 1000 extending over the edge of the material 1002. FIG. 10C and FIG. 10G show a scenario where the handheld laser omni-directional saw 1000 has disengaged magnets within the portions of the main body 1010 of the handheld laser omni-directional saw 1000 that extend past the edge of the material 1002.

The handheld laser omni-directional saw 1000 in some embodiments is configured to (i) determines that the cup 1006 extends past an edge of the material 1002 (in any of the ways described herein), (ii) adjusts the magnetic field or power of one or more of the magnets (including turning off or turning down one magnet, possibly turning up another magnet still inline with the material 1002), and (iii) continues cutting. In some instances, the magnetic force may be determined based on material properties, such as thickness, density and so on. For example, for particularly thick or dense material, operating the magnets at higher power (to generate a stronger magnetic field) may be advantageous to help keep the cup 1006 held against the material 1002. Alternatively, for a thinner or comparatively more delicate material, operating the magnets at lower power (to generate a weaker magnetic field) may be advantageous to avoid damaging the material while holding the cup 1006 against the material 1002

By disengaging the electromagnets positioned in the portion of the main body 1010 of the handheld laser omni-directional saw 1000 extending over the edge of the material 1002, the handheld laser omni-directional saw 1000 prevents the disengaged electromagnets from causing the portion of the cup 1006 extending past the edge of the material 1002 from being drawn to the main body 1010 of the handheld laser omni-directional saw 1000 and angling upward toward the handheld laser omni-directional saw 1000.

The handheld laser omni-directional saw 1000 can determine whether a portion of the main body 1010 is extended over the edge of the material 1002 in a number of ways, including, but not limited to dead reckoning, cameras, capacitive/optical sensors, tilt sensors, light sensors, etc.

In some examples, the magnets are electromagnets to avoid demagnetization, and the cup 1006 can be charged (e.g., wired or wirelessly). In other examples, the cup 1006 has ferrous components with electromagnets on top or permanent magnets with electromagnets on top.

The cup 1006 in some embodiments is designed to catch laser power as the laser 1012 goes through the material 1002. As was the case with the cup 906 for handheld laser straight-line cutter 900 shown and described with reference to FIGS. 9A-G, the energy that cup 1006 captures from the laser of the handheld laser omni-directional saw 1000 can be used to power the sensors or other electronics in the cup 1006. And in the same way that cup 906 of handheld laser straight-line cutter 900 is configured to dissipate energy, the cup 1006 of handheld laser omni-directional saw 1000 is likewise configured to dissipate energy optically (as light) (as depicted in FIGS. 10E and 10F), and at least in some instance, reflect the energy back to the main body 1010 of handheld laser omni-directional saw 1000 (as depicted in FIG. 10D).

In some embodiments, the handheld laser omni-directional saw 1000 additionally includes a cooling mechanism (e.g., powered by battery or by the captured energy from the laser). For example, in some examples, a solar cell generates energy from the laser to circulate water through a heat exchanger allowing the cup 1006 to cool more rapidly than it otherwise would cool absent the cooling mechanism.

In some configurations, the cup 1006 is powered, whereas in other configurations, the cup 1006 is passive (not powered).

In some examples, the cup 1006 is passive, so it can only reflect energy back into the main body 1010 of the handheld laser omni-directional saw 1000, so detection of beam power, disposal of excess energy, and other functions can be done in the main body 1010 of handheld laser omni-directional saw 1000.

In further examples, the main body 1010 of the handheld laser omni-directional saw 1000 is configured to detect the temperature of the cup 1006 to determine how much energy is being absorbed by the cup 1006.

In some examples, the cup includes a rolling mechanism (e.g., a set of wheels, a Teflon coating, a set of ball bearings, etc.) to reduce friction and facilitate movement of the cup 1006 against the material 1002. Additionally, in some embodiments, the cup 1006 has curved corners to help the cup 1006 more easily slide over surface irregularities.

In some scenarios, the cup 1006 can cause the laser beam to be interrupted if the cup 1006 is not in the right location and/or rotated (e.g., if the laser is off of the material 1002). In some examples, one or more sensors on the outside of the cup 1006 are configured to detect laser light in a place that the laser light should not be. In operation, the handheld laser omni-directional saw 1000 in some embodiments is configured to shut off the laser(s) in response to detecting laser light in an area where laser light should be detected. For example, if one or more sensors of (or associated with) the handheld laser omni-directional saw 1000 detect laser light escaping from the cup 1006 while the handheld laser omni-directional saw 1000 is cutting a material, the handheld laser omni-directional saw 1000 may (i) halt operation of the laser(s), (ii) alert the operator of a dangerous laser condition, and (iii) instruct the operator to verify the position/configuration of the cup 1006 before resuming the cut.

In some embodiments, the cup 1006 can be stowed for storing and/or moving the handheld laser omni-directional saw 1000 by attaching the cup 1006 to the main body 1010 of the handheld laser omni-directional saw 1000. In some configurations, the cup 1006 has rechargeable batteries that can be recharged wirelessly, in a separate charger, or by contacting the cup 1006 with the main body 1010 of the handheld laser omni-directional saw 1000.

As noted above, any of the laser tool designs disclosed and described herein can use any (or all) of the various features disclosed and described herein, to the extent that such features are not mutually exclusive. The following paragraphs provide examples of various features and combinations that can be used. It is important to note that these are merely examples and that other/different features and combinations can be used.

In one example, the handheld laser omni-directional saw 1000 is designed to provide cuts in several ways. In some embodiments, the handheld laser omni-directional saw 1000 is about the size of a traditional router, although other dimensions are possible. The head of the handheld laser omni-directional saw 1000 in some embodiments includes an array of solid-state laser diodes configured to generate hundreds of watts of power (e.g., 300 W) incorporated in a main body of the handheld laser omni-directional saw 1000. The laser of the handheld laser omni-directional saw 1000 in some examples is on an x-y-axis gantry that moves the head in two dimensions to maintain a desired cut. The handheld laser omni-directional saw 1000 can be powered using AC power, DC power, battery power, etc. The main body of the handheld laser omni-directional saw 1000 in some configurations also includes a cooling system (e.g., fans, liquid cooling, etc.), as well as a controller. In some embodiments, the handheld laser omni-directional saw 1000 acts as a self-contained unit (e.g., motion planning, image processing, UI, etc., all done locally). The handheld laser omni-directional saw 1000 can accept CAD files, pencil sketches, and camera photographs, among other data. The main body of the handheld laser omni-directional saw 1000 in some configurations may rest directly on the material 1002, which ensures a fixed distance between the array of laser diodes and the material 1002. This may also be used to enclose the laser from the head to the material 1002. Movement of the handheld laser omni-directional saw 1000 may be facilitated in some examples by wheels, ball bearings, slides, Teflon material, etc. on the underside of the main body of the handheld laser omni-directional saw 1000. Example material includes typical job-site material (¾″ plywood, 4×2 studs, finished woods, sheetrock, etc.).

In some configurations, a cup 1006 is used to catch laser power as the laser 1012 passes through the material 1002. The cup 1006 in some examples is magnetically coupled to the main body 1010 of the handheld laser omni-directional saw 1000. The cup 1006 can have wheels, Teflon, ball bearings, or something to reduce friction between the cup 1006 and the material 1002 as the cup 1006 moves across the material 1002. The cup 1006 in some examples has curved corners to facilitate easy sliding over surface irregularities of the material 1002. Wireless communication (RF, BT, etc.) can be used between the cup 1006 and the main body 1010 of the handheld laser omni-directional saw 1000. As described above, when the cup 1006 is partially off of the material 1002 (e.g., a portion of the cup 1006 extends past an edge of the material 1002), the handheld laser omni-directional saw 1000 in some examples disengages the electromagnets within the portion of the main body 1010 of the handheld laser omni-directional saw 1000 extending over the edge of the material 1002, while continuing to power (or perhaps strengthening the power) of the electromagnets within the portions of the main body 1010 of the handheld laser omni-directional saw 1000 still over the material 1002. Any suitable mechanism can be used for edge detection, including but not limited to dead reckoning, cameras, capacitive/optical sensors, etc.

In some examples, the energy captured by the cup 1006 is used to power sensors or other electronics in the cup 1006. In some embodiments, the cup 1006 dissipates the power back to the main body 1010 of the handheld laser omni-directional saw 1000 (as shown in FIG. 10D). For example, the cup 1006 in some examples reflects light directly back into the main body 1010 of the handheld laser omni-directional saw 1000 (e.g., at a slight angle through the kerf). In some embodiments, the main body 1010 of the handheld laser omni-directional saw 1000 is configured to detect the heat of the cup 1006 to determine how much energy is being absorbed by the cup 1006. In some embodiments, the cup 1006 absorbs power and then emits the optical energy in another form or as non-coherent optical energy (e.g., as shown in FIG. 10F). For example, the cup 1006 in some examples can scatter the light energy so the cup 1006 glows (e.g., reflect light with micro-mirrors or other reflecting elements) or absorb energy and then re-emit at a different wavelength, as shown in FIG. 10E. In some examples, the cup 1006 is configured to absorb energy and cool the cup 1006 using electricity from the main body 1010 of the handheld laser omni-directional saw 1000, e.g., through an arm (e.g., arm 908 in FIGS. 9A-C), or scatter the energy using a wide-angle lens with glass container surrounding it.

In some embodiments, sensors monitor the power absorbed by the cup 1006, and based on measured power being absorbed by the cup 1006, the handheld laser omni-directional saw 1000 can decide whether to take action such as turning down the power and/or turning off the power to the laser. For example, the handheld laser omni-directional saw 1000 in some examples can (i) detect a high level of power in the cup 1006 (laser shuts off (e.g., 10 W good, 100 W bad)) which might indicate that the laser has cut through the material 1002 or (ii) detect low level of power in the cup 1006 (less than a threshold), which might indicate that the laser is not cutting through the material 1002 properly (e.g., indicate to slow down movement of the laser or turn up the laser power). Based on the measurements of the power at the cup 1006, the handheld laser omni-directional saw 1000 can regulate the laser power (up/down) as needed to cut the material 1002. Sensors can be inside the cup 1006 or outside the cup 1006 and used to detect stray energy. Sensors in the main body 1010 of the handheld laser omni-directional saw 1000 may detect the heat of the cup 1006 to determine how much energy is being absorbed at the cup 1006.

### G. Free-Standing Laser Tool

In some embodiments, the laser tool is or comprises a free-standing laser tool 1100, which can turn a jobsite into an instant factory, prepping materials in a fraction of the time as compared to traditional cutting tools. Materials, such as plywood, lumber, and sheetrock, can be fed into one side of the tool either by human pushing detected by sensors or via power rollers, and precise cuts, marks, engraving, and complex carvings can come out the other side of the tool. The free-standing laser tool 1100 can help users complete projects that are time consuming and often prone to errors, such as building stairs or creating custom cabinetry or shelving for a space. The design capabilities of the free-standing laser tool 1100 in some examples can help estimate the amount materials required for a project, and in some instances, facilitate ordering the materials for a project.

For example, since the free-standing laser tool 1100 can cut arbitrary shapes on both the face and ends of a board, the free-standing laser tool 1100 enables users to create intricate decorative joinery that would be extraordinarily difficult with ordinary hand tools.

In another example, a camera on (or associated with) the free-standing laser tool 1100 can obtain images and/or laser range a whole door or room, and by using design tools executed by the one or more processors of the free-standing laser tool 1100, the free-standing laser tool 1100 can calculate all the trim pieces required for the project. For a user creating crown molding or a window sill and frame, for example, the user can input the material to be used for implementing the project, and the free-standing laser tool 1100 measures the dimensions of the room, window sill and frame, etc., including the little imperfections, and the user can just feed material through the free-standing laser tool 1100, and the free-standing laser tool 1100 cuts/miters/compound miters/copes or performs other cuts required to complete the pieces for the project.

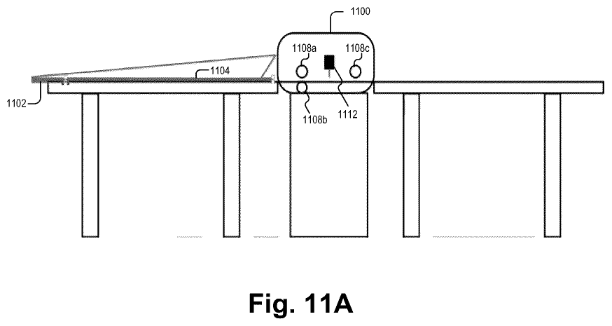

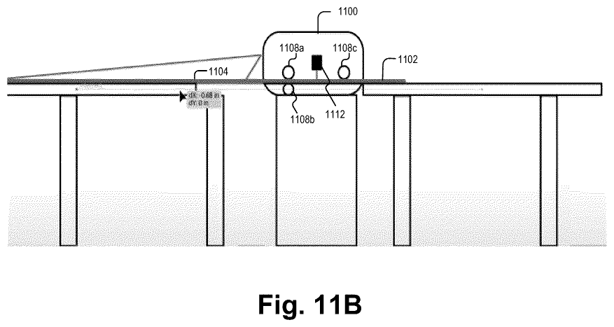

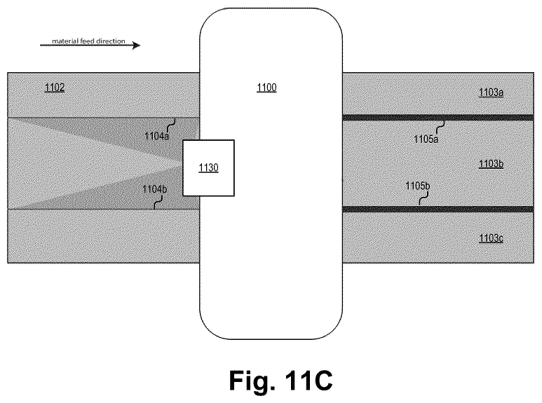

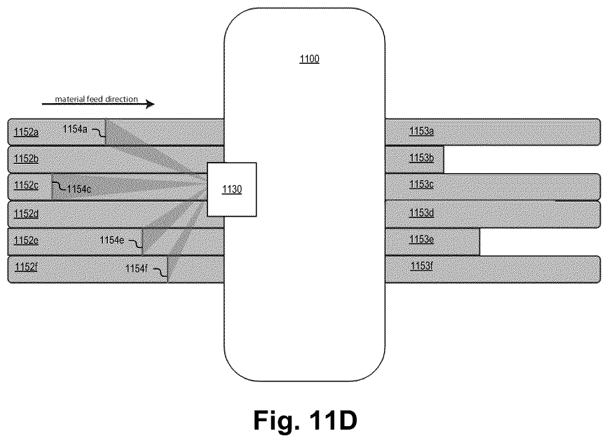

FIG. 11A shows an example free-standing laser tool cutting a material according to some embodiments.

FIG. 11B shows another side view of an example free-standing laser tool cutting a material according to some embodiments. In FIG. 11B, some of the material 1102 has been passed through the free-standing laser tool 1100.

FIG. 11C shows a top view of an example free-standing laser tool 1100 cutting material 1102 according to some embodiments. In FIG. 11C, the projector 1130 has projected cut lines 1104a and 1104b onto the surface of material 1102 as the material 1102 is moved from left to right through the free-standing laser tool 1100. In operation, the free-standing laser tool 1100 cuts the material 1102 according to the cut lines 1104a and 1104b to create cuts 1105 and 1105b, respectively, thereby cutting the single material 1102 into three pieces 1103a, 1103b, and 1103c.

FIG. 11D shows another top view of an example free-standing laser tool 1100 cutting materials 1152a-f according to some embodiments. In FIG. 11D, the projector 1130 has projected (i) cut line 1154a onto material 1152a, (ii) cut line 1154c onto material 1152c, (iii) cut line 1154e onto material 1152e, and (iv) cut line 1154f onto material 1152f. The materials 1152a-f in the example shown in FIG. 11D are wooden planks. As the materials 1152a-f are moved from left to right through the free-standing laser tool 1100, the free-standing laser tool 1100 cuts the materials 1152a-f according to the cut lines, thereby cutting the materials to the different lengths specified by the cut lines to generate finished materials 1153a-f.

The free-standing laser tool 1100 uses rollers 1008a-c or a belt to advance a material 1102 toward the free-standing laser tool 1100. In this way, the user can line up several 2×4 planks side-by-side and individually rip, crosscut, bevel, and/or profile each one automatically, in one pass. The free-standing laser tool's 1100 rollers 1108a-c and high-power (e.g., 300-watt) laser 1112 can give the user the ability to prep hundreds of boards and sheets in hours. In some examples, the free-standing laser tool 1100 has an automatic power feeder that accommodates 48″ sheet stock of 8′ or longer and/or up to 12 2×4 boards laid side by side and wide side up, portable infeed and outfeed tables for high efficiency, a high-power laser emitter for fast processing speed, and/or any of the other laser tool features mentioned herein.

In some examples, material 1102 (e.g., wood or other material) can be fed through manually, or a mechanism (e.g., power rollers 1108a-c) can be used to automatically feed the material 1102 through the free-standing laser tool 1100.

After one or more desired cut points are determined, the free-standing laser tool 1100 projects the cut point(s) 1104 onto the material 1102 to show the user where the cut will be. In other examples, the free-standing laser tool 1100 can engrave one or more lines on the material 1102. In further examples, the free-standing laser tool 1100 can image the location of the cut point(s) and use that image as a reference without actually marking the material 1102 or projecting any cut point(s) on the material 1102.

For example, if the user wants a cross cut a 2×4″ plank to 72″ in length, the user could place the wood onto the base of the free-standing laser tool 1100 such that one end is on the base and feed through the free-standing laser tool 1100 until the free-standing laser tool 1100 has determined the length of 72″ has been determined.

In another example, if the user wants to rip a 2×6″ plank to be 4.5″ wide, the user could place the wood onto the base of the free-standing laser tool 1100 such that the free-standing laser tool 1100 can see at least one edge of the wood, and then the free-standing laser tool 1100 (using sensors) can measure the distance from the at least one edge.

In yet another example, a user can use a tape measure to measure from the end of the material 1102 and the free-standing laser tool 1100 can determine the point on the wood that matches the target dimension as shown by the tape measure reading.

In some embodiments, the free-standing laser tool 1100 has the dimensions of a traditional table saw but uses an array of diode lasers combined to generate hundreds of watts of power (e.g., 300 W or another suitable power) to cut through typical job-site material (e.g., ¾″ plywood, 2×4 studs, finished or unfinished plywood or hardwoods like cherry and walnut, etc.).

The free-standing laser tool 1100 in some examples include multiple laser heads (diode arrays), where each head is defined by its ability to position a laser beam, to speed up processing of materials. As with the handheld laser straight-line cutter 900, handheld laser omni-directional saw 1000, and other laser tools disclosed herein, the free-standing laser tool 1100 is designed with power density and air flow considerations in mind. The free-standing laser tool 1100 can be AC powered and use independently-driven rollers 1108a-c and/or a belt drive.

The rollers 1108a-c can vary in height (motorized, springs, etc.) to accommodate different material thickness, and different material-moving mechanisms (robotic digits or claws, omni-directional rotating spheres, etc) can be used in place of rollers. In operation, the free-standing laser tool 1100 can drill/bore holes, cut in straight lines, etc. and do three-dimensional engraving, which can be a two-step process. For example, the free-standing laser tool 1100 can first cut and analyze the material 1102 surface and then do a second pass to smooth out the cut. The free-standing laser tool 1100 can also do angle cuts by angling the laser 1112 and/or by engraving the edge down to create a shallow angle.

The free-standing laser tool 1100 in some embodiments is connected to a server or any other networked computer or computing system. This server may be responsible for executing a portion or the entirety of the processing functions, including but not limited to, the computation of cutting trajectories, the generation of preview images, and other related tasks. For example, the free-standing laser tool 1100 in some examples is configured to communicate with a server (e.g., remote/cloud server system 220 shown in FIG. 2 or other suitable remote/cloud system)

The server may also be equipped with the capability to monitor and record the usage of the free-standing laser tool 1100. This usage data can be linked to various payment models, such as a subscription-based system or a pay-per-use scheme. The server may also have the ability to disable the free-standing laser tool 1100 in certain circumstances, such as when a report of theft is received. This is just one example of the potential cloud-based functionalities that can be integrated into the system.

In addition to the aforementioned functionalities, the server may also be configured to provide real-time updates on the operational status of the free-standing laser tool 1100, including but not limited to, the current power consumption of the free-standing laser tool 1100, the condition of its components, and the estimated time to complete a cutting task.

The server may also be capable of storing a history of past cutting tasks, which can be used to optimize future cutting trajectories, predict maintenance needs, or provide usage statistics for the free-standing laser tool 1100. This data can be accessed by the user or by an authorized third party, such as a service provider or a tool manufacturer, for analysis or troubleshooting purposes.

Furthermore, the server may also be configured to receive and process commands from the user or an authorized third party. These commands can be used to remotely control the free-standing laser tool 1100, adjust its settings, or initiate specific cutting tasks.

The server may also be capable of integrating with other cloud-based services, such as inventory management systems, to automatically order replacement parts or supplies when they are needed.

The server may also be capable of supporting multiple tools simultaneously, allowing for coordinated operation in a workshop setting. This could include synchronizing the operation of multiple tools, distributing tasks among tools, or managing the sharing of resources among tools.

The server may also be capable of providing a user interface, accessible via a web browser or a dedicated application, which allows the user to interact with the tool, monitor its status, and control its operation.

As noted above, the free-standing laser tool 1100 can use any of the various laser tool features disclosed and described herein. The following paragraphs provide examples of various features and combinations that can be used. It is important to note that these are merely examples and that other/different features and combinations can be used.

In one embodiment the free-standing laser tool is much higher power than at least some of the laser tools described above and is designed to take large pieces of wood (e.g., 4′×8′ sheets, etc.) as pass-through. The tool can be the size of a traditional table saw, although other dimensions are possible. The tool includes a head in the main body of the tool that includes an array of solid-state laser diodes to generate hundreds of watts of power (e.g., 300 W). Multiple laser heads (diode arrays) can be used to speed up processing. Rollers can be used to move material through the cutter. The rollers can be driven independently and/or be a belt drive and can vary in height (motorized, springs, etc.) to accommodate for different material thickness. The main body can also include a cooling system (e.g., fans, liquid cooling) and a controller. The tool of this embodiment is typically powered using mains power.

In one embodiment, any of the saw products described herein act as a self-contained unit (e.g., motion planning, image processing, UI, etc. all done locally). In another embodiment, many of the processing functions (e.g., motion planning, image processing, etc.) are done remotely on a network-connected processing device and commands are transmitted to the portable printer for execution. The primary user interface in this embodiment may in one embodiment be a touchscreen on the top of the printer; however, additional interface(s) may be used (e.g., an interface on a network connected computer, tablet, phone, etc.).

The free-standing laser tool of this embodiment can drill, bore holes, cut in straight lines, etc., as well as do 3D engraving. 3D engraving may be used in a two-step process. In this case, it might engrave the surface; then, it might analyze the engraving, and perform a second engraving pass where material density caused the first engraving to be uneven.

The laser may be able to be angled to produce angle cuts and can engrave edge down to create shallow angle. The smart cutting machine can track uses and provides functionality based on uses.

### H. Laser Tube

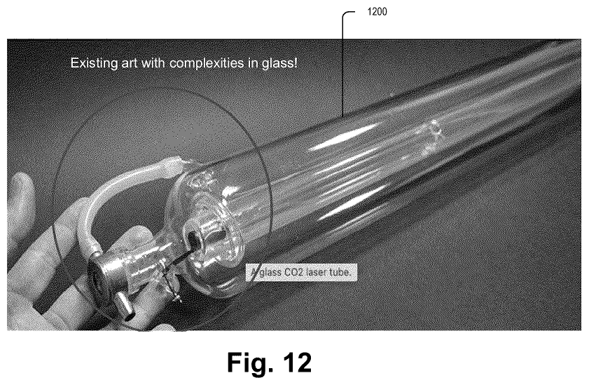

FIG. 12 shows a perspective view of an example laser tube 1200. As shown in FIG. 12, today's laser glass tubes 1200 are complex, imprecise, hand-blown structures. Straight lengths of glass tubing, which have been saw cut, are connected and sealed into a single structure through hand blown glass techniques.

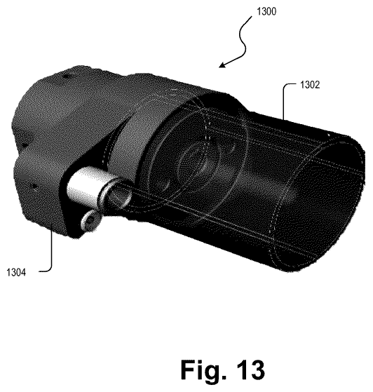

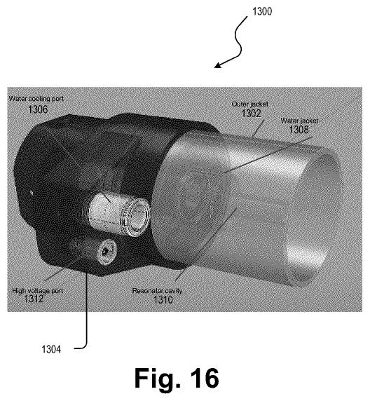

FIG. 13 shows a perspective view of an example laser tube 1300 according to some embodiments. The laser tube 1300 is manufactured by replacing the glass blown structures of the traditional laser tube 1200 shown in FIG. 12 with the alternative configuration shown in FIG. 13, pushing the complexity to the end cap structure 1304 which is bonded to the outer jacket 1302 of the laser tube 1300. The end cap structure 1304 joins the three primary glass tubes of the laser tube 1300: the outer gas jacket 1302, the resonator cavity 1310 (FIG. 16), and the water jacket 1308 (FIG. 16).

The end cap structure 1304 simultaneously serves to seal the internal gas mixture of the laser tube 1300 from the outside atmosphere, while also routing the gas internally for gas circulation needed for CO₂ recombination.

Made from conductive metals such as Kovar which are favorably CTE (coefficient of thermal expansion) matched to the glass and bonded using form in place adhesives, the end cap structure 1304 also includes and/or acts as electrodes. In a traditional glass CO₂ laser tube 1200, the electrodes are placed inside the glass tube. A glass feed through is blown onto the outer jacket in order to seal the metal conductor to the outside for an electrical connection. The metal endcap structure 1304 in laser tube 1300 eliminates the need for a feed through which is inherently susceptible to gas leakage. The endcap structure 1304 also acts as a holder for the rear mirror and output coupler optics, which through machined posts may be aligned by adjusting screws, acting as a sealed kinematic mount.

The configuration of the laser tube 1300 provides a lower cost, faster manufacturing process that produces a higher-quality product. This configuration also facilitates the manufacturing of CO₂ lasers in an automated fashion, rather than relying on lamp workers.

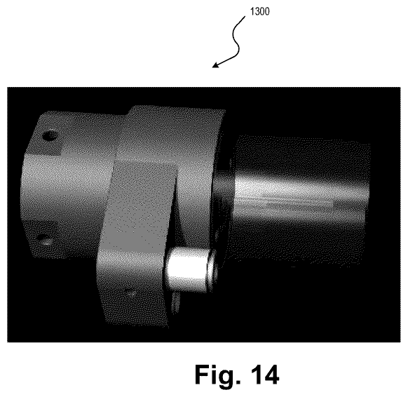

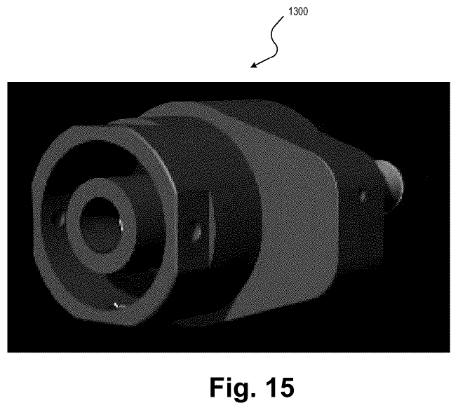

FIG. 14 shows a side view of an example laser tube 1300 according to some embodiments, FIG. 15 shows a rear view of an example laser tube 1300 according to some embodiments, and FIG. 16 shows another perspective view of an example laser tube 1300 according to some embodiments. In some figures a portion of the laser tube is also shown.

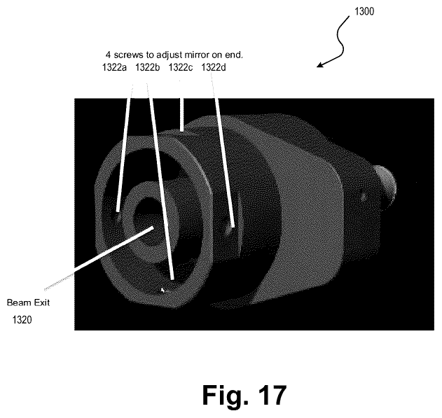

As shown in the annotated perspective view of FIG. 16, the laser tube 1300 (with end cap structure 1304) of this embodiment comprises a water cooling port 1306, an outer jacket 1302, a water jacket 1308, a resonator cavity 1310, and a high-voltage port 1312. Also, as shown in the annotated rear view of FIG. 17, the laser tube 1300 of some embodiments has a beam exit port 1320 and four screws 1322a-d to adjust the mirror.

### I. Example Laser Cutting Tool Embodiments

Many different laser cutting tool embodiments with many different features and functionalities are disclosed and described herein. Any feature and/or functionality described with reference to any one of the laser cutting tool embodiments disclosed herein can be implemented by any other of the laser cutting tool embodiments disclosed herein, in any combination, to the extent that a particular combination of features and/or functionality is not mutually exclusive.

This section summarizes several example laser cutting tool embodiments with various combinations of features and functions.

A laser tool according to some embodiments includes (i) at least one laser source configured to generate at least one laser beam having sufficient power to cut material, (ii) one or more processors, and (iii) tangible, non-transitory computer-readable memory comprising program instructions, wherein the program instructions, when executed by the one or more processors, cause the laser cutting tool to perform any of the laser cutting features and functions disclosed herein, in any combination.

The laser cutting tool may be any of the laser cutting tools disclosed and described herein, including but not limited to (i) the portable laser cutter 400 shown and described with reference to FIGS. 4A-B, 5, 6, 7, and 8A-B, (ii) the handheld laser straight-line cutter 900 shown and described with reference to FIGS. 9A-G, (iii) the handheld laser omni-directional saw 1000 shown and described with reference to FIGS. 10A-H, (iv) the free-standing laser tool 1100 shown and described with reference to FIGS. 11A-D, (v) or any of the other laser cutting tools disclosed herein.

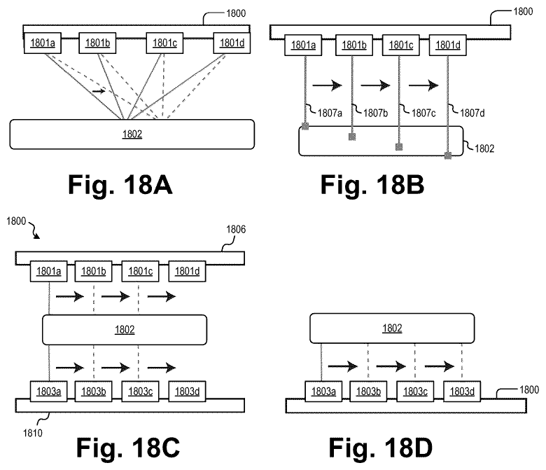

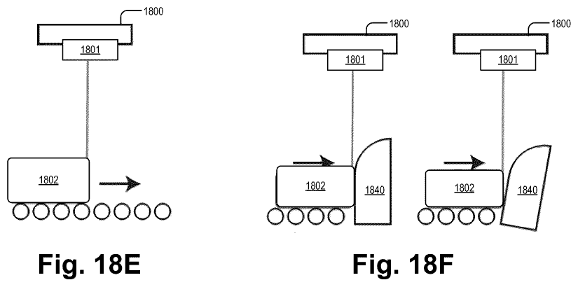

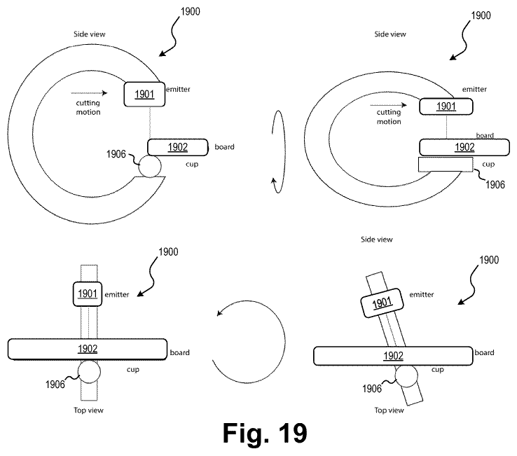

In some laser cutting tool embodiments, the laser cutting tool is configured to (i) cause a cutting path to be projected onto a surface of a material, and (ii) control the at least one laser source to apply the at least one laser beam onto the material sufficient to implement a cut (or a score, engraving, or any other application of the laser beam onto the material) along the cutting path projected onto the surface of the material. The material processed by the laser cutting tool may be any of the materials disclosed herein, including but not limited to material 140 (FIGS. 1A-B), material 602 (FIG. 6), material 902 (FIGS. 9A-G), material 1002 (FIGS. 10A-H), material 1102 (FIGS. 11A-C), material 1152a-f (FIG. 11D), material 1802 (FIGS. 18A-F), material 1902 (FIG. 19), or any other material that is capable of being processed by the laser cutting tools disclosed herein.

In some embodiments, the laser cutting tool controlling the at least one laser source to apply the at least one laser beam onto the material sufficient to implement a cut along the cutting path projected onto the surface of the material includes the laser cutting tool monitoring controlling the laser to ensure that the laser follows the cutting path. In some embodiments, the laser cutting tool is configured to use computer vision techniques to monitor both (i) the desired or expected cutting path projected onto the material and (ii) the actual cutting path of the laser as the laser cutting tool cuts the material. And if the laser cutting tool detects that the actual path of the laser has started to deviate from the desired or expected cutting path by more than some threshold amount, the laser cutting tool adjusts the application of the laser beam so as to cause the actual path of laser to more closely match (and in some instances to exactly match) the desired or expected cutting path projected onto the surface of the material.

The at least one laser may be any one or more lasers in any configuration that would be suitable for performing the laser cutting tool functions described herein. In some embodiments, the at least one laser is similar to or the same as the laser tube 1300 shown and described with reference to FIGS. 13-17. In some embodiments, and as described herein, the at least one laser may include several lasers, e.g., an array of lasers, as shown and described with reference to FIGS. 18A-D.

In some embodiments, the at least one laser comprises an individual laser or an array of lasers, where the individual laser or the array of lasers are components of a laser module that may also include other components for facilitating laser operation, e.g., control circuitry, sensors, mirrors, motors, lenses, cooling fans, or any other component(s) for facilitating laser control and operation. In some instances, the laser cutting tool is configured to use different interchangeable laser modules that have lasers (and related components) that are adapted for processing different types of materials. However, in other scenarios, the laser cutting tool has a fixed laser module that is not interchangeable with other laser modules. In some embodiments, the laser module is configurable to adjust laser output power and/or wavelength (e.g., via tunable lasers) to facilitate processing different types of materials.

For example, in some embodiments, the laser cutting tool includes a laser module configured for processing organic materials at a power of about 3.05 joules to 13.5 joules at wavelengths between about 400 nm to 470 nm, and in some instances, at a power of about 3.08 to 13.3 joules between 400-470 nm. In some configurations, the laser module is configured for processing organic material at a wavelength of between about 400 nm to 470 nm at a power greater than about 125-150 watts and less than about 625-650 watts with a feed rate of about 30-60 mm/sec, and in some instances, at a power between 150-650 watts and between 400-470 nm. The feed rate corresponds to the speed at which the laser beam moves relative to the material either by moving the organic material under the laser beam while the laser beam remains stationary, moving the laser beam over the organic material the organic material remains stationary, and/or moving both the laser beam and the organic material relative to each other during fabrication.

In some embodiments, the laser cutting tool includes a laser module configured for processing organic, non-metallic fibrous materials at wavelengths between about 250 nm to 500 nm, and in some instances, between about 266-480 nm. In some examples, the laser cutting tool includes a laser module configured for processing materials with lignin content greater than about 12-18% at wavelengths between about 250 nm to 500 nm, and in some instances, processing materials having a lignin content greater than 15% at wavelengths between about 266-480 nm.

In some examples, the laser cutting tool includes a laser module configured for applying a laser beam at a focal length greater than or equal to about 1 inch from the laser emitter, in some instances, at a focal length greater than or equal to 1.5 inches, and in some instances, at a focal length greater than or equal to 2 to 2.5 inches. In some embodiments, the focal length(s) of the laser beam(s) emitted by the laser module of the laser cutting tool is/are user-configurable based on the thickness of the material to be processed. The thickness of the material may be determined by sensors (e.g., optical sensors, electrical sensors, mechanical sensors, or any other suitable sensor) of the laser cutting tool and/or entered manually by a user via a user interface.

In some configurations, the laser module comprises a set of two or more laser diodes configured to emit laser light at wavelengths between about 300 nm and 500 nm, and in some instances between about 310-480 nm. In some instances, the laser module is configured to spatially combine the laser beams from the two or more laser diodes into a nearly singular beam, e.g., as shown and described with reference to FIG. 18A. In some embodiments, the laser module is configured to combine the two or more laser beams using dichroic elements to wavelength combine the laser light into a nearly singular beam. In some embodiments where individual laser beams are combined into the nearly singular laser beam, the individual laser beams emitted by the laser diodes are spaced between about 5 nm to 15 nm apart from each other, and in some instances, about 10 nm apart from each other.

The laser(s) of the laser module(s) of the laser cutting tool may be any type of laser suitable for cutting, scoring, and/or engraving the types of materials that would typically be processed by the laser cutting tool. For example, the lasers may be any suitable type of laser of (i) Carbon Dioxide (CO₂) lasers, (ii) a Quantum Cascade Lasers (QCL), (iii) semiconductor lasers, (iv) fiber lasers, (v) continuous lasers, (vi) pulsed lasers at various pulse frequencies, or (v) any other type or configuration of lasers now known or later developed that would be suitable for fabrication the type of materials described herein.

In some configurations the laser module is integrated with the laser cutting tool. In other configurations, some components of the laser module are integrated with the laser cutting tool while other components are separate from the laser cutting tool. For example, in some instances, the laser cutting tool includes a separate laser unit configured to generate laser light, and a set of fiber optic cables arranged to route the laser light from the laser unit to the laser cutting tool for application to the material.

As mentioned above, in some embodiments, the laser cutting tool is configured to cause the cutting path to be projected onto the surface of the material. In some examples, causing the cutting path to be projected onto the surface of the material includes the laser cutting tool projecting the cutting path onto the surface of the material via at least one of (i) a physical projector incorporated within the laser cutting tool or (ii) a physical projector separate from the laser cutting tool. For example, in some embodiments, the laser cutting tool includes an integrated projector configured to project a design (comprising a cutting path) onto the surface of a material in any of the manners shown and described herein, including but not limited to the methods shown in and described with reference to FIGS. 9C, 10B, 10C, 10H, 11A, 11B, 11C, and 11D.

In some embodiments, causing the cutting path to be projected onto the surface of the material comprises projecting the cutting path onto the surface of the material within an augmented reality space. In some embodiments where the cutting path is projected onto the surface of the material within an augmented reality space, a user wearing augmented reality glasses can view the cutting path “virtually” displayed onto the surface of the material.

In some embodiments, causing the cutting path to be projected onto the surface of the material comprises projecting the cutting path onto the surface of the material within a virtual reality space. In some embodiments where the cutting path is projected onto the surface of the material within a virtual reality space, a user wearing virtual reality glasses can view the cutting path “virtually” displayed onto a virtual rendering of the surface of the material.

In connection with causing the cutting path to be projected onto the surface of the material, some embodiments include the laser cutting tool detecting whether the projector configured to project the cutting path onto the surface of the material has moved relative to the material. Some embodiments additionally or alternatively include the laser cutting tool determining whether the material has been moved relative to the projector configured to project the cutting path onto the surface of the material. Some embodiments include the laser cutting tool determining both (i) whether the projector configured to project the cutting path onto the surface of the material has moved relative to the material and (ii) whether the material has been moved relative to the projector configured to project the cutting path onto the surface of the material.

In some embodiments, after the laser cutting tool has determined that the projector has moved relative to the material, the laser cutting tool causes the projector to update the projection of the cutting path so that the cutting path projected along the surface of the material after the projector was moved is substantially the same as the cutting path along the surface of the material before the projector was moved. Similarly, after the laser cutting tool has detected that the material has moved relative to the projector, the laser cutting tool causes the projector to update the projection of the cutting path such that the cutting path projected along the surface of the material after the material was moved is substantially the same as the cutting path along the surface of the material before the material was moved.

Recall that the projector may be integrated as a component of the laser cutting tool, or the projector may be separate from (but in communication with) the laser cutting tool. In other scenarios, causing the projector to update the projection includes one or more processors within the laser cutting tool either (i) controlling an integrated projector to update the projection or (ii) signaling an external projector to update the projection.

In operation, the laser cutting tool can determine whether the projector has moved relative to the material and/or whether the material has moved relative to the projector in several ways.

For example, the laser cutting tool in some embodiments employs computer vision techniques to detect movement of the material. For some embodiments where the material is moved as part of the fabrication process (e.g., as shown and described with reference to FIGS. 11A-D and 18A-F), the laser cutting tool employs computer vision techniques to monitor the movement of the material during fabrication so that the laser cutting tool is able to keep the projection of the cutting path in the same (or substantially the same) location on the surface of the material relative to the edges of the material and/or “landmarks” on the surface of the material (e.g., computer vision fiducials, marks or other surface features on the material such as holes, grain, or similar) as the material is moved during fabrication.

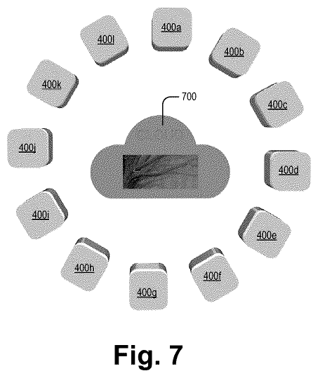

In another example, the laser cutting tool in some embodiments uses accelerometers, gyroscopes, or other suitable sensors to detect movement of the projector. For some embodiments where the laser cutting tool might move as part of the fabrication process (e.g., as shown and described with reference to FIGS. 6, 7, 8A-B, 9A-G, 10A-H), such as embodiments where the projector is a component of the laser cutting tool, the laser cutting tool is configured to update and/or adjust the projection of the cutting path on the surface of the material as the laser cutting tool (with the projector) moves.

In other embodiments where the projector is a component of the laser cutting tool, the laser may move while the projector stays in a fixed (or substantially fixed) position. But even in scenarios where the projector is intended to remain in a fixed position during fabrication, the projector may get knocked, nudged, or otherwise be moved unintentionally. In configurations where the projector includes accelerometers, gyroscopes, or other suitable motion detecting components, the laser cutting tool can use data from the motion detecting components to control the projection of the cutting onto the surface of the material by, for example, updating or adjusting the projection to offset the movement detected by the motion detecting components.

In some embodiments where the laser cutting tool causes the cutting path to be projected onto the surface of the material, the laser cutting tool is configured to determine one or more points of the cutting path based on one or more dimensions of the material detected by one or more sensors associated with the laser cutting tool. In such embodiments, the laser cutting tool may use (i) any suitable sensor and/or dimension detecting technique disclosed herein to determine dimensions of the material or (ii) any other sensor and/or dimension detection technique now known or later developed that is suitable for detecting and/or determining dimensions of material for fabrication by a laser cutting tool. For example, the laser cutting tool may use camera data (e.g., images or video) and computer vision techniques (e.g., structured light approaches similar to those described elsewhere herein) to determine one or more dimensions of the material. In other example, the laser cutting tool in some configurations may additionally or alternatively use laser ranging techniques. In operation, the laser cutting tool may use several dimension detecting techniques together in a coordinated manner to determine, detect, or otherwise assess the dimensions of the material to be fabricated.

In some embodiments, the at least one laser source is configured to apply the at least one laser beam to at least one of (i) a top surface of the material or (ii) a bottom surface of the material. FIGS. 18A-D show several example configurations of a laser cutting tool 1800 with different arrangements of downward firing and/or upward firing lasers.

FIG. 18A shows a side view of an example laser cutting tool 1800 with an arrangement of downward firing lasers 1801a-d according to some embodiments. In the example of FIG. 18A, four laser emitters can (i) steer beams at different angles, (ii) co-operate to focus energy on one area, or (iii) each cut or engrave separate areas of the material 1802.

In some examples, the laser cutting tool 1800 in FIG. 18A is configured to focus one or more (or all) of the downward firing lasers 1801a-d onto a single point on the surface of the material 1802 being processed by the laser cutting tool 1800. In this manner, the laser cutting tool 1800 can apply the power of multiple lasers to a single point on the surface of the material 1802, thereby enabling the laser cutting tool 1800 to cut the material 1802 more rapidly (as compared to a configuration where only a single laser beam is focused onto the single point on the material 1802), or process materials that may require high laser powers for effective processing.

In operation, and based on the requirements for a particular fabrication project, the laser cutting tool 1800 is configured to (i) focus each of the individual downward firing lasers 1801a-d onto the same location on the surface of the material 1802, and/or (ii) focus each of the individual downward firing lasers 1801a-d onto different locations on the surface of the material 1802.

The laser cutting tool 1800 of FIG. 18A is configured to use (i) any of the laser head movement and/or laser beam steering techniques disclosed herein to direct each of the downward firing lasers 1801a-d to one or more points on the surface of the material 1802, and/or (ii) any other laser beam steering and/or focusing technique now known or later developed that is suitable for directing and/or focusing a laser beam onto a particular point.

The configuration shown in FIG. 18A is particularly advantageous for scenarios where the material 1802 remains fixed during fabrication, such as the example described with reference to FIGS. 8A-B. The configuration in FIG. 18A is also advantageous when engraving a design onto the surface of the material 1802. However, the configuration shown in FIG. 18A is also advantageous in scenarios where the material 1802 is moved during fabrication, such as the examples described with reference to FIGS. 11A-D.

FIG. 18B shows a side view of an example laser cutting tool 1800 with an arrangement of downward firing lasers 1801a-d according to some embodiments. The laser cutting tool 1800 in FIG. 18B is configured to focus one or more (or all) of the downward firing lasers 1801a-d on to the surface of the material 1802 as the material is moved under each of the downward firing lasers 1801a-d.

FIG. 18C shows a side view of an example laser cutting tool 1800 with an arrangement of downward firing lasers 1801a-d and an arrangement of upward firing lasers 1803a-d. In the example of FIG. 18C, the downward firing lasers 1801a-d and the upward firing lasers 1803a-d can be controlled to operate in several ways.

For example, the downward firing lasers 1801a-d in FIG. 18C can be controlled to operate in the manner illustrated in FIG. 18A, where the laser cutting tool 1800 is configured use (i) any of the laser head movement and/or laser beam steering techniques disclosed herein to direct each of the downward firing lasers 1801a-d to one or more points on the top surface of the material 1802, and/or (ii) any other laser beam steering and/or focusing technique now known or later developed that is suitable for directing and/or focusing a laser beam onto a particular point. The downward firing lasers 1801a-d in FIG. 18C can additionally or alternatively be controlled to operate in the manner illustrated in FIG. 18B, where the laser cutting tool 1800 is configured to focus different downward firing lasers 1801a-d at different focal lengths, as described in more detail below.

Similarly, the upward firing lasers 1803a-d in FIG. 18C can be controlled to operate in the manner similar to the upward firing lasers 1801a-d illustrated in FIG. 18A, where the laser cutting tool 1800 is configured use (i) any of the laser head movement and/or laser beam steering techniques disclosed herein to direct each of the upward firing lasers 1803a-d to one or more points on the bottom surface of the material 1802, and/or (ii) any other laser beam steering and/or focusing technique now known or later developed that is suitable for directing and/or focusing a laser beam onto a particular point. The upward firing lasers 1803a-d in FIG. 18C can additionally or alternatively be controlled to operate in the manner similar to the downward firing lasers 1801a-d illustrated in FIG. 18B, where the laser cutting tool 1800 is configured to focus different upward firing lasers 1803a-d at different focal lengths, as described in more detail below in the context of the downward firing lasers 1801a-d. In operation, the upward firing lasers 1803a-d can be configured to operate in the same (or substantially the same) manner as the downward firing lasers 1801a-d.

Further, the laser cutting tool 1800 is configured to operate and control the downward firing lasers 1801a-d and the upward firing lasers 1803a-d in the same (or substantially the same) manner regardless of whether the laser cutting tool 1800 is being moved relative to the material 1802 or the material 1802 is being moved relative to the laser cutting tool 1800. For example, the laser cutting tool 1800 in FIG. 18C is configured to focus one or more (or all) of the downward firing lasers 1801a-d the top surface of the material 1802 and one or more (or all) of the upward firing lasers 1803a-d on the bottom surface of the material 1802 as the material 1802 is moved between the downward firing lasers 1801a-d and upward firing lasers 1803a-d. Similarly, the laser cutting tool 1800 in FIG. 18C is configured to focus one or more (or all) of the downward firing lasers 1801a-d the top surface of the material 1802 and one or more (or all) of the upward firing lasers 1803a-d on the bottom surface of the material 1802 as the laser cutting tool 1800 is moved over the material 1802 while the material 1802 is placed between the downward firing lasers 1801a-d and upward firing lasers 1803a-d

FIG. 18D shows a side view of an example laser cutting tool 1800 with an arrangement of upward firing lasers 1803a-d according to some embodiments. The laser cutting tool 1800 in FIG. 18D is configured to focus one or more (or all) of the upward firing lasers 1803a-d the bottom surface of the material 1802 as the material is moved over each of the upward firing lasers 1803a-d.

In some instances, laser cutting tool 1800 embodiments with upward firing lasers 1803a-d provide several safety benefits. For example, when cutting from the bottom (as shown in FIG. 18D), the material 1102 naturally covers the lasers 1803a-d, whereas when cutting from the top (as shown in FIGS. 18A-C), there is necessarily an air gap between the downward firing lasers 1801a-c and the material 1802. In some configurations with upward firing lasers, the top of the material 1102 may be covered with a protective surface (e.g., a spring loaded beam dump that pushes onto the material) to ensure a safe operating environment. Alternatively or additionally, protective curtains may be used to protect the user from excess laser power (e.g., when the laser cuts through the material).

In some of the examples shown in FIGS. 18B-D, the material 1802 is moved from left to right in the direction of the arrows. In other examples, the material 1802 can be moved from right to left in the opposite direction of the arrows. In the example shown in FIG. 18B, the ordering of the focal lengths of the focal lengths of the 1801a-d lasers can be reversed to facilitate moving the material 1802 from right to left. More particularly, the order focal lengths of the downward firing lasers 1801a-d can be changed from shallowest (on the left) to deepest (on the right) to instead be deepest (on the left) to shallowest (on the right) to facilitate processing the material 1802 by moving the material from left to right. In some examples, the direction of movement shown in FIGS. 18B-D is away from a user of the laser cutting tool 1800, whereas in other examples, the direction of movement shown in FIGS. 18B-D is toward the user of the laser cutting tool 1800. And in some instances, the laser cutting tool 1800 can be moved while the material 1802 remains stationary rather than moving the material 1802 rather than moving the material 1802 while the laser cutting tool 1800 remains stationary.

In some instances, one or more laser(s) are moved horizontally (x-direction) towards the user (as opposed to a traditional miter saw where the cut is made in the direction away from the user). FIGS. 18C-D show examples where laser beam moves across the material 1802 for a cross cut when (i) one or more lasers are fired downward from above the material (FIG. 18B); (ii) one or more lasers are fired downward from above the material and one or more lasers are fired upward from below the material (FIG. 18C); and (iii) one or more lasers are fired upward from below the material (FIG. 18D). These same techniques can be used moving away from the user, parallel from the user, at an angle, or in embodiments where the laser configuration is adjustable, in any other configuration the user chooses.

Accordingly, consistent with the examples shown in FIGS. 18A-D, in some embodiments where the at least one laser source comprises a first laser source and a second laser source, the laser cutting tool is configured to control the at least one laser source to apply at least one laser beam onto the material sufficient to implement a cut along the cutting path projected onto the surface of the material by (i) causing the first laser source to apply a first laser beam to a top surface of the material; and/or (ii) causing the second laser source to apply a second laser beam to a bottom surface of the material.

And further consistent with the examples depicted in FIGS. 18A-D, in some embodiments, the laser cutting tool includes a plurality of laser sources. In some such embodiments, the plurality of laser sources comprise at least one of (i) a first set of two or more laser sources (e.g., downward firing lasers) configured to apply a first set of two or more laser beams onto a top surface of the material and (ii) a second set of two or more laser sources (e.g., upward firing lasers) configured to apply a second set of two or more laser beams onto a bottom surface of the material.

In some embodiments that include upward and downward firing lasers, such as the example shown in FIG. 18C, the upward and downward firing lasers are configured so that the laser beam from an upward firing laser does not fire directly (or unnecessarily close to) into a downward firing laser, and vice versa, so as to avoid a situation where a downward firing laser damages an upward firing laser or vice versa.

For example, in some embodiments, the downward firing lasers and upward firing lasers are not positioned directly across from each other. Instead, the positions of the upward firing lasers are offset or staggered from the positions of the downward firing lasers. In particular, in some embodiments, the one or more upward firing lasers and the one or more downward firing lasers of the laser cutting tool are arranged so that application of the first laser beam(s) to the top surface of the material (via the one or more downward firing lasers) is offset from application of the second laser beam(s) to the bottom surface of the material (via the one ro more upward firing lasers) in a manner sufficient to avoid both (i) application of the first laser beam(s) to second laser source (i.e., the upward firing lasers) and (ii) application of the second laser beam(s) to the first laser source (i.e., the downward firing lasers).

In some configurations that include a plurality of laser sources, individual laser sources in the plurality of laser sources are configured to apply laser beams at differing focal lengths for materials having differing thicknesses.

For example, FIG. 18B shows a laser cutting tool embodiment with four downward firing lasers 1801a-d. In some embodiments, each of the downward firing lasers 1801a-d is configured with a different focal length, e.g., the focal length of laser 1801a is near the top surface of material 1802, the focal length of laser 1801b is about 33% below the top surface of the material 1802, the focal length of laser 1801c is about 67% below the top surface of the material 1802, and the focal length of laser 1801d is near the bottom surface of the material 1802. Since each of the downward firing lasers 1801a-d has a different focal length, the corresponding laser beams 1807a-d emitted from each of the downward firing lasers 1801a-d will have its maximum effectiveness at different distances from its corresponding laser source.

In some embodiments of the example shown in FIG. 18B, the focal lengths of the lasers 1801a-d are fixed, whereas in other embodiments, the focal lengths of the lasers 1801a-d are configurable. In either scenario, having different lasers with different focal lengths can reduce processing time. For example, as the material 1802 in FIG. 18B is moved from left to right, the material 1802 is exposed to laser beams having successively longer focal lengths. Thus, any given portion of the material 1802 is first exposed to laser beam 1807a emitted from laser 1801a, then laser beam 1807b emitted by laser 1801b, then laser beam 1807c emitted by laser 1801c, and finally laser beam 1807d emitted by laser 1801d. So, as the material 1802 moves from left to right, each successive laser is cutting deeper into the material 1802 than the previous laser. As result, the example laser cutting tool 1800 embodiment of FIG. 18B can cut completely through the material 1802 faster than an alternative embodiment with only a single laser, or with a set lasers all having the same focal length.

In some embodiments, the laser cutting tool is configured to control one or both of (i) the power of the one or more laser beam applied to the material and/or (ii) the speed at which the material is processed by the laser cutting tool, e.g., by controlling one or both of the speed at which the laser beam moves over the surface of the material and/or the speed at which the material moves under the laser beam. Controlling the laser power and/or processing speed while implementing the cut along the cutting path helps to ensure a high quality cut.

In some instances, the laser cutting tool is configured to control one or both of the laser power and/or the processing speed based on any one or more of (i) a material type of the material, (ii) a thickness of the material, (iii) a density of the material, (iv) an absorption coefficient of the material, (v) a power of the at least one laser beam, (vi) an indication from one or more sensors of whether the at least one laser beam has passed through a portion of the material, or (vii) a fabrication type (e.g., engraving, cutting, and so on).

For instance, for some types of material, a lower laser power applied for a longer amount of time may achieve a better fabrication result than a higher laser power applied for a shorter amount of time. However, for other types of material, a higher laser power applied for a shorter amount of time may achieve a better fabrication result than a lower laser power applied for a longer period of time. And some types of material may require a higher laser power applied for a longer period of time to achieve a fabrication result, whereas other types of material may only be able to withstand a lower laser power applied for a short period of time before becoming damaged. Similarly, for an engraving, it may be desirable to apply a lower power laser for a shorter duration of time (to avoid cutting through the material) as compared to a cutting, where it may be desirable to apply a higher laser power to cut through the material.

Accordingly, in some embodiments, the laser cutting tool is configured to control the speed at which at least one of (i) the at least one laser beam moves relative to the material, (ii) the laser cutting tool moves relative to the material, or (iii) the material moves relative to the laser cutting tool.

In some embodiments, the laser cutting tool is configured to monitor the status of the fabrication procedure, and take certain actions in response to detecting certain conditions that may arise during fabrication.

For example, in some configurations, the laser cutting tool includes a feedback system that alerts the user when the laser cutting tool is on course or deviating from the intended cut line during fabrication. In some such embodiments, the alert includes any include any more or more of (i) a visual alert, such as a change in the projected image with an alert or with arrows to guide the user, (ii) an auditory alert, such as a beep or a change in pitch, (iii) a haptic alert, such as a vibration that cautions the user that the laser tool is deviating from an intended or expected path, or (iv) any other type of alert now known or later developed that is suitable for alerting a user of the laser tool that the laser tool has deviated from its intended or expected path.

Traditional circular saws provide a type of natural feedback to the saw operator. For instance, the saw is typically initially slightly more difficult to push when the saw initially starts to cut the material, the saw becomes slightly easier to push as long as the saw follows a straight line, the saw becomes harder to push (or perhaps starts to bind) if/when pushed off the straight line, and the saw operator can tell when the saw has cut all the way through the material. A skilled saw operator uses this natural feedback when operating the saw to help create high quality and consistent cuts with the saw.

To provide a similar user experience with a laser cutting tool, in some embodiments where the laser cutting tool is configured to move over the top (and/or bottom) surface of the material via wheels or similar rolling members during fabrication, the feedback includes introducing feedback via the wheels (or similar rolling members). For example, if the laser cutting tool detects that the user is moving the laser cutting tool too quickly over the material to perform an effective cut (or score or engraving, depending on the design), the laser cutting tool may introduce user feedback that includes a “braking” type of function applied to the wheels so as to reduce the speed at which the laser cutting tool is moving over the surface of the material (or at least to encourage the user to slow down). Similarly, if the laser cutting tool detects that the user is moving the laser cutting tool too slowly over the material, the laser cutting tool may introduce user feedback that includes applying a drive force to the wheels to increase the speed at which the laser cutting tool is moving over the surface of the material (or at least to encourage the user to speed up) so as to avoid damaging the material or to otherwise avoid a low quality fabrication result.

For example, while applying the at least one laser beam onto the material sufficient to implement the cut along the cutting path, the laser cutting tool in some embodiments is configured to detect at least one of (i) whether the laser cutting tool has been moved relative to the material or (ii) whether the material has been moved relative to the laser cutting tool.

If the laser cutting tool detects that it has been moved relative to the material, the laser cutting tool next determines whether the laser cutting tool can continue to apply the at least one laser beam onto the material sufficient to implement the cut along the cutting path.

Then, if the laser cutting tool determines that it can continue to apply the at least one laser beam onto the material sufficient to implement the cut along the cutting path after the laser cutting tool has been moved relative to the material, then the laser cutting toll continues to control and apply the laser beam onto the surface of the material sufficient to implement the cut along the cutting path. But if the laser cutting tool determines that it cannot continue to apply the at least one laser beam onto the material sufficient to implement the cut along the cutting path after the laser cutting tool has been moved relative to the material, then the laser cutting tool in some embodiments will shut off the at least one laser beam.

Similarly, in some embodiments, after the laser cutting tool detects that the material has been moved relative to the laser cutting tool, the laser cutting tool next determines whether it can continue to apply the at least one laser beam onto the material sufficient to implement the cut along the cutting path.

If the laser cutting tool determines that it can continue to apply at least one laser beam onto the material sufficient to implement the cut along the cutting path after the material has been moved relative to the laser cutting tool, then the laser cutting tool in some embodiments continues to control and apply the laser beam onto to the material sufficient to implement the cut along the cutting path. But if the laser cutting tool determines that it cannot continue to apply the at least one laser beam onto the material sufficient to implement the cut along the cutting path after the material has been moved relative to the laser cutting tool, then the laser cutting tool in some embodiments will shut off the at least one laser beam.

In some embodiments, the laser cutting tool is configured to control at least one laser source to apply at least one laser beam onto the material sufficient to implement a cut along the cutting path projected onto the surface of the material via at least one of (i) a single-dimensional rail system (e.g., moving in only the X direction or only the Y direction), (ii) a multi-dimensional rail system (e.g., moving in both the X direction and the Y direction), or (iii) a galvanometer configured to steer the laser beam.

In some embodiments, the cutting path projected onto the surface of the material is one of several cutting paths in a broader design. For example, the design depicted in FIGS. 8A-B is quite complicated and includes many cutting paths.

Accordingly, in some embodiments, causing a cutting path to be projected onto the surface of the material includes the laser cutting tool causing a design to be projected onto the surface of the material, where the design comprises the cutting path.

In some embodiments, the cutting path comprises one or more of (i) a cross cut, (ii) a rip cut, (iii) one or more holes, (iv) one or more notches, (v) a straight cut, (vi) a miter cut, (vii) a bevel cut, (viii) one or more engravings, or (ix) curves of arbitrary shape and complexity, which also may be cut with a bevel. In operation, the cutting path may be arranged to cut any type of cut now known or later developed that can be cut via a laser cutting tool.

After the cutting path has been projected onto the surface of the material, a user may wish to modify the cutting path (or the design containing the cutting path) in some way.

Accordingly, in some embodiments, the laser cutting tool is configured to receive one or more modifications to the cutting path via at least one user interface associated with the laser cutting tool. The user interface may be any of the laser cutting tool interfaces disclosed herein, including but not limited to (i) a touchscreen on the laser cutting tool, (ii) a touchscreen or other input device of a computing device separate from the laser cutting tool but configured to control the configuration and operation of the laser cutting tool, (iii) an interactive voice interface that receives and processes voice commands for execution by the laser cutting tool, a (iv) a “projected” touchscreen, whereby a user provides inputs and/or commands to the laser cutting tool by interacting with the design projected on the surface of the material, and/or (v) any combination of one or more of the foregoing user interface methods.

After receiving the one or more modifications to the cutting path, the laser cutting tool in some embodiments (i) generates a modified cutting path based on the one or more modifications, and (ii) causes the modified cutting path to be projected onto the surface of the material.

As mentioned above, the laser cutting tool embodiments described in this section may be similar to or the same as any of the laser cutting tool embodiments disclosed herein, including but not limited to any of (i) the portable laser cutter 400 shown and described with reference to FIGS. 4A-B, 5, 6, 7, and 8A-B, (ii) the handheld laser straight-line cutter 900 shown and described with reference to FIGS. 9A-G, (iii) the handheld laser omni-directional saw 1000 shown and described with reference to FIGS. 10A-H, (iv) the free-standing laser tool 1100 shown and described with reference to FIGS. 11A-D, (v) or any of the other laser cutting tools disclosed herein.

Accordingly, in some embodiments, the laser cutting tool additionally includes (i) a base configured to support at least a portion of the material while the laser cutting tool (a) causes the cutting path to be projected onto the surface of the material and (b) controls the at least one laser source to apply the at least one laser beam onto the material sufficient to implement the cut along the cutting path projected onto the surface of the material, and/or (ii) an arm configured to apply the at least one laser beam onto the material while at least a portion of the material is supported on the base.

In some embodiments where the at least one laser beam includes a first laser beam and a second laser beam, and while at least a portion of the material is supported on the base, (i) the arm is configured to apply the first laser beam onto a top of the material and (ii) the base is configured to apply the second laser beam onto a bottom of the material.

For example, the laser cutting tool 1800 embodiment shown in FIG. 18C includes a base 1810 and an arm 1806. In operation, the arm 1806 includes downward firing lasers 1801a-d arranged to apply laser beams to the top of material 1802, and the base 1810 includes upward firing lasers 1803a-d arranged to apply laser beams to the bottom of material 1802. Although the laser cutting tool 1800 embodiment shown in FIG. 18C includes several downward firing lasers 1801a-d in the arm 1806 and several upward firing lasers 1803a-d in the base 1810, other embodiments may have more or fewer downward firing lasers in the arm and/or more or fewer upward firing lasers in the base. For example, some laser cutting tool embodiments may include a single downward firing laser in the arm and a single upward firing laser in the base. Some embodiments may include one or more only downward firing lasers, and some embodiments may include one or more only upward firing lasers.

In some embodiments, the laser cutting tool additionally includes at least one riving knife configured to fit within a kerf created by the at least one laser beam while implementing the cut along the cutting path projected onto the surface of the material.

For example, FIG. 18E shows a side view of an example laser cutting tool 1800 with rollers according to some embodiments, and FIG. 18F shows a side view of a laser cutting tool 1800 with rollers and a riving knife 1840 according to some embodiments.

In some configurations, the riving knife 1840 has a thickness equal to the minimum kerf of the laser emitted by the laser cutting tool 1800. In operation, the riving knife 1840 can be rotated at any angle and is designed to move with the laser emitter. The riving knife 1840 may be made of any material that (i) is thin enough to fit within the minimum kerf of the laser, (ii) absorbs laser power at the emitted wavelength of the laser, (iii) tends to not reflect laser light, and (iv) is able to dissipate heat effectively. Example materials include tungsten, carbon, graphite, and stainless steel, but any other suitable material could be used as well.

In some embodiments, the riving knife 1840 also incorporates a beam dump. A beam dump is any mechanism configured to absorb laser power safely. The cup shown and described with reference to FIGS. 9B-G and 10B-D is a particular implementation of a beam dump that can be used with the riving knife 1840 in some instances. However, the riving knife 1840 may additionally incorporate a beam dump structure separate from any cup structure.

In some embodiments, the laser cutting tool additionally includes at least one beam dump configured to absorb laser power of the at least one laser source that passes through the kerf while implementing the cut along the cutting path projected onto the surface of the material. For example, in some embodiments, the beam dump is similar to or the same as the cup components shown and described herein, including but not limited to cup 906 (FIGS. 9B-G), cup 1006 (FIGS. 10B-G), or cup 1906 (FIG. 19).

In some embodiments, the riving knife 1840 can be used to determine the feed rate of the material through the laser cutting tool 1800 such that the laser only moves (or the material 1802 is only allowed to move in the case where the laser cutting tool 1800 is fixed and material 1802 moves) when the laser beam emitted from the laser 1801 has cut down to the riving knife 1840.

That can be accomplished because the riving knife 1840 is physically pushed back when the riving knife 1840 detects the incident laser beam or any other sensor mechanism as shown in FIG. 18F.

In operation, power is lost if the laser beam emitted from the laser 1801 hits the riving knife 1840. Therefore, it can be advantageous to avoid scenarios where the laser beam hits the riving knife 1840 to avoid power loss. In the right hand side example of FIG. 18F, the riving knife 1840 is tilted to ensure the laser beam emitted from the laser 1801 does not hit the riving knife 1840 until the laser beam has cut through the material 1802, rather than allowing the laser beam to graze the riving knife 1840 as in the left hand side example of FIG. 18F. However, both riving knife 1840 embodiments shown in the right hand side and left hand side examples shown in FIG. 18F can be used the laser cutting tool 1800.

In some embodiments, the laser cutting tool additionally includes a cooling system configured to pass pneumatic air across at least one laser diode of the at least one laser source and out of a nozzle at an air pressure sufficient to blow fumes and debris away from where the at least one laser beam is applied onto the material. In some embodiments, the cooling system comprises a liquid cooling system in addition to or instead of an air cooling system. In some examples, the cooling system comprises a cooling unit integrated with the laser cutting tool. In other configurations, the cooling system comprises a cooling unit separate from the laser cutting tool, where the separate cooling unit supplies chilled air and/or liquid to the laser cutting tool (or components thereof, such as the laser module) via cables, hoses, or similar.

FIG. 19 shows side and top views of an example laser cutting tool 1900 with a cup 1906 according to some embodiments.

The laser cutting tool 1900 is configured for compound miter functionality. In operation, compound miter functionality can be achieved by tilting the laser emitter and/or steering the laser beam with galvanometers, as described earlier.

In some examples, when the laser is tilted, the beam dump (or cup 1906) is also moved based on the laser orientation. For example, as shown in FIG. 19, the cup 1906 is moved to accommodate the orientation of the emitter 1901 relative to the material 1902 being cut.

### J. Additional Embodiments

The following paragraphs provide additional embodiments. It should be noted that these embodiments (and the other embodiments presented herein) are merely examples, and the details presented herein should not be read into the claims unless expressly recited. Also, any of the embodiments disclosed in this document can be used alone or in combination, in all variations.

One embodiment relates to the use of a laser tool to engrave a piece of material (e.g., to engrave a square onto a piece of pine). In such situations, one may expect that the laser would ablate a fixed amount of the material, say one millimeter. However, the material may, instead, ablate an amount of material proportional to the density of the material. So, if the tool is used to engrave a knot in a piece of wood, it may result in a raised circle that has only been ablated by half a millimeter, while the rest of the wood (not containing the knot) is ablated by a millimeter. In one embodiment, a multi-pass engraving strategy is used. In operation, after an engraving is finished, the tool can perform a scan of the surface height using any suitable scanning technique to determine the new height. Then, based on the wattage of the laser used in the engraving to achieve that height, the wattage of the laser can be adjusted to achieve the desired result. For example, if 40 watts lowered part of the material by one millimeter and another part by half a millimeter, a second pass can be used to lower the height another half-millimeter on the raised area only; or the power can be adjusted if the second pass needs to ablate more or less material. This makes the final engraving more uniform. With this embodiment, the laser tool does an initial engraving, scans that engraving, and then does one or more additional engraving passes to get to a desired/consistent height or some other measurements. There can also be a physical distance measurement tool that goes over the workpiece and scans its height (e.g., a camera that uses depth sensing, lasers to measure height, etc.). The measurements from the physical distance camera can then be fed back into the laser cutting machine to adjust the parameters for an additional cut

Another aspect of the invention pertains to laser tools that incorporate a pass-through slot for the introduction of material into the tool. One of the challenges associated with the use of a pass-through slot is the prevention of laser light from escaping through the slot. Various mechanisms, such as brushes, fingers, or other obstructions, can be employed to block the light from exiting the slot.

In one embodiment, the pass-through slot is designed with a variable opening. This opening can be adjusted using springs, motorized incursions, or other similar mechanisms, so that the size of the opening is approximately equal to the dimensions of the material being fed through it. For instance, if a thin sheet of plywood is being inserted into the pass-through slot, curtains or other flexible barriers can be lowered from the top and sides of the slot until they make contact with the plywood.

In another embodiment, the pass-through slot may be equipped with sensors that can detect the size and shape of the material being inserted. These sensors can then send signals to a control system, which adjusts the size of the opening accordingly. This can be achieved using a variety of mechanisms, such as motorized curtains, adjustable panels, or inflatable barriers.

In yet another embodiment, the pass-through slot may be designed with multiple layers of light-blocking mechanisms, so that if light passes one barrier it is obstructed by another. This could include a combination of fixed obstructions, such as brushes or fingers, and adjustable obstructions, such as curtains or panels. This multi-layer design can provide additional assurance that no laser light will escape from the slot, even if one of the obstructions fails or is not perfectly aligned with the material.

In some embodiments, the pass-through slot may also be designed to prevent other types of light, such as ambient light or infrared light, from entering or exiting the slot. This can be achieved using various types of light-blocking materials, coatings, or filters.

In some embodiments, the pass-through slot may also be designed to prevent dust, debris, or other particles from exiting or entering the slot. This can be achieved using various types of seals, filters, or cleaning mechanisms.

It should be noted that these are merely examples of the potential designs and functionalities of the pass-through slot, and that other designs and functionalities may be implemented without departing from the scope of the invention.

In yet another embodiment, the laser tool comprises a smart detector of light leakage. For example, if the laser uses blue light, then the case may be orange to block the blue light from exiting. That means that when the laser is off, only orange light should be present. When the laser is on, only orange light and blue light should be present. If there is blue light present when the laser is off, or green light present at any time, that can indicate that there is an opening (e.g., due to a partially-open pass-through slot) allowing external light into the case. If external light can enter the case, it also means that laser light might be able to exit the case. So, in one embodiment, the laser tool has one or more sensors inside the case that can detect light colors therein as a proxy for light leaks. If the tool is operated in a dark room, the above smart detector may sense a false negative, as the absence of other colors of light does not necessarily mean there is no opening allowing for a light leak. So, in another embodiment, a light sensor can be placed on the external surface of the tool to detect whether or not there is ambient light and, hence, whether or not the indication of the absence of light by the internal sensor can be relied upon to indicate the absence of light leak.

Further, a reverse strategy can be used, where the external sensor can detect the color and frequency of any laser light that might be leaking out of the case. For example, the pass-through slot can have a double wall, where the second wall has a sensor on it that detects if there is any laser light bouncing around the cavity between the walls. The sensor can detect the frequency and coherence of the light. The light can be modulated for this purpose (e.g., at 37 megahertz or kilohertz), and the external sensor can look for that frequency; or it can look for the frequency of laser light, or look for coherent light; or the sensor might block outside light, so any light present can be assumed to be laser light. If the external sensor detects that some laser light is escaping, the tool can shut down. By way of analogy, this system can be thought of similar to an airlock chamber, but for light instead of air. In one possible configuration where there is one detector, light may be scattering around but not touch the detector. So, a diffuser can be placed in the light lock (e.g., a diffusive material hanging down in the case). That way, if the laser hits the diffusive material, the laser will scatter onto the detector.

Another aspect of the invention pertains to a safety feature that can be incorporated into the laser tool. The laser tool may be designed without a fully protective casing, relying instead on specific human behaviors for safe operation. In one embodiment, the tool is equipped with a safety feature that can detect the presence of people in its vicinity. If people are detected, the tool can either prevent operation or issue a safety warning, which could be auditory, visual, or both. The warning could be displayed on a screen, emitted as a siren, or communicated through other suitable means.

The tool can detect the presence of people using a variety of methods. One such method could involve the use of an infrared thermal machine-vision camera. This method could be particularly useful in situations where the tool is a stationary table laser saw or planer that uses an automatic feed mechanism to advance materials into the tool, eliminating the need for the user to be present at the tool. The tool could be configured to initiate the advancement and cutting of the material only when the level of thermal energy within a certain radius of the tool, such as six feet, falls below a specified threshold. Other methods for detecting the presence of people could include the use of motion sensors, ultrasonic sensors, pressure sensors embedded in the floor, or a combination of these. The tool could also use machine learning algorithms to analyze the data from these sensors and distinguish between different types of movement, such as the movement of a person versus the movement of a machine.

In another embodiment, the tool can also detect whether the detected individuals are wearing safety glasses. This could be achieved using a variety of methods, such as visual recognition algorithms, infrared sensors, or other suitable detection mechanisms. The tool could be configured to prevent operation or issue a safety warning if it detects that safety glasses are not being worn.

Methods for detecting safety glasses could include the use of cameras combined with image recognition algorithms, which can identify the shape and position of the glasses on the person's face. The tool could also use infrared sensors to detect the presence of glasses by measuring the reflection of infrared light off the glasses, or similar approaches for glasses optimized for different frequencies. Another method could involve the use of radio frequency identification (RFID) tags embedded in the glasses, which can be detected by an RFID reader in the tool.

Furthermore, the tool can also determine whether the safety glasses being worn are of the appropriate type for the laser in use. This could be achieved using a variety of methods, such as analyzing the spectral characteristics of the glasses, comparing the glasses to a database of approved glasses, identifying a marker on the glasses like a QR code printed on them, querying for a transponder embedded in the glasses, or other suitable methods. The tool could be configured to prevent operation or issue a safety warning if it detects that the glasses being worn are not of the appropriate type.

Methods for determining the type of glasses could include the use of spectrometers to analyze the light transmission characteristics of the glasses, or the use of RFID tags that contain information about the type of glasses. The tool could also use machine learning algorithms to compare the image of the glasses to a database of images of approved glasses.

In some embodiments, the tool may also be equipped with additional safety features, such as a physical barrier that automatically deploys when people are detected, an emergency stop button, or a remote control system that allows the tool to be deactivated from a distance.

It should be noted that these are merely examples of the potential safety features that can be incorporated into the laser tool, and that other safety features may be implemented without departing from the scope of the invention.

As mentioned above, techniques other than infrared thermal detection can be used to determine if there are people near the tool. For example, a machine-vision camera can look for a specific type of safety glasses that people near the tool would be wearing. Alternatively, the safety glasses can have a transmitter/transponder/receiver and be Bluetooth connected. The detection of safety glasses can indicate that people are near the tool, so the tool should be shut off, or the detection of safety glasses can indicate that people near the tool are adequately protected because of the safety glasses, so the tool can operate. As an example of the safety feature in practice, consider the situation in which the laser tool (e.g., planer, cutter, engraver, etc.) is used at a job site. If a person comes up to the tool's operator, the tool could turn off, as it would detect someone nearby who is not wearing safety glasses. Once that person puts on safety glasses or leaves the area, the tool can resume operation. So, in this example, the safety glasses serve as a wireless interlock.

Another embodiment relates to the cup mentioned above that can be used to collect laser light exiting the workpiece. As mentioned above, when using a high-powered laser (e.g., 300 watt) in a tool, such as the straight-line cutter and omni-directional cutter described above, the laser will not only cut through the material but will dangerously continue past the material and into the ground or whatever is underneath the material. A cup connected to the tool (e.g., using a C-shaped arm or magnetically coupled to the main body) can capture the escaping light. However, the cup can become very hot from the collected energy. So, in one embodiment, a beam dump is used to transform the light to a safe form. By way of analogy, 100 watts in one form (a laser) can be harmful, but 100 watts in another form (a light bulb) may not be. Any suitable type of beam dump can be used. For example, one type of beam dump has a lens (e.g., a hemispherical lens or a magnifying-glass-style convex lens) that spreads out the collected light and prevents the user from touching it until there is a suitable distance and the light is diverged enough to be safe. As another example, the beam dump can scatter the light using any suitable mechanism, such as, for example, a clear glass block that is filled with tiny reflective spheres, each of which takes part of the laser beam and shoots it off in a different direction. So, if 110 watts goes into the block, perhaps 100 watts can be diffused as light, with only 10 watts being retained as heat. Of course, these are merely examples, and other types of beam dumps can be used, including, but not limited to, those that use diffusion holographic elements, optical elements, and/or scattering/reflecting elements. More generally, any suitable technology can be used that redirects light energy instead of absorbing all of the beam as heat to accomplish this alternative to a traditional beam dump which simply heats up. Alternatively, because light is more dangerous when it is coherent, a fluorescence strategy can be used that involves a crystal that absorbs energy and re-emits it into different frequencies to scatter and decohere the light.

In another embodiment, a safety feature is provided to detect whether metal is in or potentially will be entering the housing of the laser. Metal can be unexpectedly present (e.g., if there is a nail head in a piece of wood being cut), and the presence of metal in the tool can be a safety hazard because it can reflect the laser in a dangerous way. So, in one embodiment, a metal detector is provided (e.g., in the tool or external to the tool (e.g., covering the material feed)) to detect if there is or potentially will be metal present in the housing of the laser tool. The tool can be configured with different operating modes that can set different detection thresholds. For example, if the tool is operating in a sheetrock mode where no metal is expected, any detected metal can cause the tool to issue an alert and/or shut down. Any suitable type of technology can be used to detect metal, such as, but not limited to, LIDAR, X-ray, RF frequency detection, electromagnetic radiation detected at certain frequencies, etc. In addition to looking for metal, the detector can be configured to detect pockets of air or other inclusions (e.g., a crack in the wood filled with termites). Also, the detector can be used to identify the material, so the tool can automatically configure the appropriate (e.g., power, fan, etc.) settings for cutting the material and/or issue an alert if the detected material is not what the tool was expecting (e.g., sheetrock instead of plywood, or vice versa). Also, mirrors or other reflective surfaces that pose a particular hazard can be detected using one or more internal cameras or other devices that detect reflected or scattered light at a certain frequency, such as blue light.

Another embodiment relates to a drywall-based laser cutter that is capable of cutting several sheets of material all at once. In general, a feeder feeds pieces of material into a laser tool, such as the standalone table saw style cutter. An entire sheet of plywood or drywall can be fed to the laser tool, which can cut in any arbitrary shape or engrave and cut it at any arbitrary depth. Several pieces of material can be placed adjacent (e.g., ten 2×4s side by side), fed to the tool all at once, and the tool can cut them to different lengths or configurations (mitered, beveled, etc.)

This can be used to help a construction project run more efficiently. For example, consider a tool that can cut a stack of 12 2×4s or sheetrock to the correct size and configuration (e.g., double miter across). If the plans for the construction of a house specify a certain number of 2×4s with certain bevel and angle features, that information can be programmed into the tool, and the tool can automatically cut the automatically-fed materials to the correct specification. Alternatively, the tool or an external processor can analyze blueprints to determine what is needed. With this information, the tool can make the required cuts. As yet another alternative, a user can use the camera on their phone (e.g., and its autofocus sensor) instead of using a measuring tape to measure distances and output that information as a “cut file” that the tool can use to cut the material to size or to cut a hole into the material.

In another embodiment, an axial fan is used to provide air flow to the nozzle of the tool, especially when the tool is used to cut thick materials. The use of an axial fan can be preferred over the use of compressed air, as an axial fan provides static pressure which, when fed through a nozzle, provides laminar flow that can be beneficial when cutting thicker material. This can result in a more-efficient tool with cleaner cuts. Also, in environments where an external air compressor is used to supply shop air under pressure, the tool can detect whether or not a desired air pressure is available. If it is available, the tool can use that air. If it is not available, the tool can modify the operation of the compressor accordingly or use a different air source, instead of just turning the laser tool off. Even if the result is suboptimal, at least the laser tool is still operating.

Another embodiment can be used to turn a sheet of plywood, drywall, or other sheet material, even a stack of 2×4s, into a display surface that behaves like a touch screen. For example, a galvanometer-based laser projector, or a traditional projector used for screens such as a DLP or other video or movie projector, can project lines, images, and other details onto the surface. This projector can be standalone or can be housed inside of a tool. This allows the user to visualize cuts before they are made. Additionally, cameras on the device can track the user's fingers. So, the user can draw a line on the material with their fingertip and can resize the line by pinching-and-zooming zoom with two fingers. Also, if the user wants to take a measurement, the user can touch two reference points with their fingers, and the measurement can be projected onto the surface. To draw a circle, the user can sketch a rough circle with their finger tip, and it will snap to become a perfect circle. These gestures are just examples, and an entire language of gestures and hand signals can be used to represent various drafting tools, such as, but not limited to, a speed square, a tape measure, a ruler, or freehand sketching. Standard computer graphics techniques such as snapping, grids, and alignment tools can allow for precise layouts using imprecise hand gestures.

The camera can capture the dimensions of the material, so the dimensions can be added as well. For example, the dimensions of a piece of plywood can be displayed along the edges of the plywood. If a user draws a line, the tool can measure the distance between that line and the edge of the plywood. The user can use a hand gesture to drag the line and watch the number change. They can also indicate the measurement, for example, by showing on their fingers how many inches they would like it to be.

The cameras can also pick up markings on the material. So, for example, the user can draw a line, and it can be registered by the camera and incorporated into the design, potentially displaying a glowing line on top of the pencil ruled line. If the user wants to draw rough sketch with their fingers they can, then sketch dimensions directly onto the material and see the projection change to accommodate their drawing.

The user can choose a file such as a DXF, SVG, JPG, or PDF and project that onto the material, and then use hand gestures to resize and place it on the material. The results of this design process can have many uses. It can be exported as an image or as a design file in one of those file types. It can also be used directly with a tool that can accommodate the image. For example, the projector can be in a router-type device (e.g., omni-directional cutter) that is capable of plunging into the material and cutting in any direction. When the user moves the device into position, the router bit, laser beam, or other cutting tool can start cutting exactly where the line is, even if the user moves it slightly off center, as the cut occurs exactly on the virtual line that the user indicated.

In another example, the user can draw a single line that is projected from a projector located on the movable saw (e.g., straight-line cutter), then lock the projection of the line in place relative to the material. Unlike traditional circular saws that project a laser line, once the line is locked into place relative to the material, even moving the circular saw and its attached projector (or similar device (e.g., straight-line cutter)) will not move the line as the projection adjusts. This allows the user to carefully trace the target line, then have that line remain steady as they manually guide the blade down the line.

The device can be picked up, and motion compensation can allow the image to continue to be projected on the surface. To enable this, sensors, such as accelerometers and gyroscopes, can be used. It may also be beneficial to have cameras that have redundant fields of vision and projectors that overlap. This allows the tool to be rotated while continuing to both view and project on the material. Further, the user's hand can get in the way of the projector or the camera, so another camera/projector can take over while another one is obstructed. This can also be accomplished using virtual reality or augmented reality headsets instead of laser projectors.

As can be seen from the above, many embodiments and alternatives can be used, and they can be used alone or in combination. These various embodiments and alternatives include, but are not limited to, the use of LIDAR to measure layer height for 3D engraving; a passthrough slot with variable opening; smart detection of light leakage using external and/or sensors; detection of a human within a certain distance of the tool (e.g., using a camera, a motion sensor, a thermal detector, etc.) that generates an alert or causes the tool to shut down, which allows the tool to leak more light; a laser dump/beam trap that scatters light, making in decoherent by striking different surfaces or uses a thin film coating to render it decoherent; a metal detector that ensures metal is not or will not enter the machine and reflect/scatter the laser; the use of AI to detect mirrors in the cavity of the tool; a laser cutter that cuts drywall and other materials to a certain width and according to a certain frequency; a roller drive system to feed material to the tool; an axial fan that provides laminar flow air to the nozzle; a port to an external air compressor, so that if air is not present, it can slow down and use an internal air assist; the use of sensors (e.g., ultrasound, X-ray, radar, etc.) to identify material composition; the use of cameras to detect if humans in the area are not wearing safety glasses, which can be detectable and distinguishable from ordinary sunglasses); a system that automatically measures/identifies the shape of something (e.g., a drawing of a wall shape) and transmits instructions to the laser too to cut material (e.g., wood/sheetrock) correctly; a hand saw with a beam dump that is also a sensor that modulates the beam, intensity; or pulse speed; an alert system that signals if the tool is going too fast so it will not cut through the material; a kerf splitter close to the laser beam, so it starts to bind if the tool is going too fast; a cup/beam dump that routes the beam back to the body, which has a cooled beam dump, rather than dissipating the heat there; a fiber behind the kerf splitter; a cut-through detection method; a cup that is a parabolic mirror, so that it reshapes the beam and sends it back to the head; a capture cup that is magnetically coupled (no kerf splitter), where the cup is a beam trap and the tool can detect the cup's presence and shut down if the cup is not present); a tool that detects material, edges, etc., generates a layout of a design on the material, and detects voids under the “router;” a tool that projects lines onto the surface of the material to show how the user can cut a straight line; a cup, paired with the tool, that is driven by thermal, or PV cells, or some other way to get energy from the beam; a puck that is a passive crystal to change frequency and, perhaps, reflect light back up, and can pulse until reflected light is seen and then repeat; selective magnets can be used for the puck so it works when only the front edge is on; the application of mist around a beam to measure stray laser energy refracted anywhere through the mist area (e.g., for use in a magnetized router); an air filter hookup for a job site tool to prevent odors; and a glass tube design.

### CONCLUSIONS

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A laser cutting tool comprising:
at least one laser source configured to generate at least one laser beam having sufficient power to cut material;
one or more processors; and
tangible, non-transitory computer-readable memory comprising program instructions, wherein the program instructions, when executed by the one or more processors, cause the laser cutting tool to perform functions comprising:
causing a cutting path to be projected onto a surface of a material; and
controlling the at least one laser source to apply the at least one laser beam onto the material sufficient to implement a cut along the cutting path projected onto the surface of the material.

2. The laser cutting tool of claim 1, wherein causing the cutting path to be projected onto the surface of the material comprises at least one of:
projecting the cutting path onto the surface of the material via at least one of (i) a physical projector incorporated within the laser cutting tool or (ii) a physical projector separate from the laser cutting tool; or
projecting the cutting path onto the surface of the material within an augmented reality space.

3. The laser cutting tool of claim 2, wherein causing the cutting path to be projected onto the surface of the material comprises:
detecting at least one of (i) whether a projector configured to project the cutting path onto the surface of the material has moved relative to the material or (ii) the material has been moved relative to the projector configured to project the cutting path onto the surface of the material;
after detecting that the projector has moved relative to the material, updating the projection of the cutting path such that the cutting path projected along the surface of the material after the projector was moved is substantially the same as the cutting path along the surface of the material before the projector was moved; and
after detecting that the material has moved relative to the projector, updating the projection of the cutting path such that the cutting path projected along the surface of the material after the material was moved is substantially the same as the cutting path along the surface of the material before the material was moved.

4. The laser cutting tool of claim 2, wherein causing the cutting path to be projected onto the surface of the material comprises:
detecting at least one of (i) whether a laser cutting tool operator has moved relative to the material or (ii) the material has been moved relative to the laser cutting tool operator;
after detecting that the laser cutting tool operator has moved relative to the material, updating the projection of the cutting path projected along the surface of the material within one of an augmented reality space or a virtual reality space viewable by the laser cutting tool operator such that the cutting path projected along the surface of the material within one of the augmented reality space or the virtual reality space after the laser cutting tool operator has moved is substantially the same as the cutting path along the surface of the material within one of the augmented reality space or the virtual reality space before the laser cutting tool operator moved; and
after detecting that the material has moved relative to the laser cutting tool operator, updating the projection of the cutting path projected along the surface of the material within one of the augmented reality space or the virtual reality space viewable by the laser cutting tool operator such that the cutting path projected along the surface of the material within one of the augmented reality space or the virtual reality space after the material has moved is substantially the same as the cutting path along the surface of the material within one of the augmented reality space or the virtual reality space before the material was moved.

5. The laser cutting tool of claim 1, wherein causing the cutting path to be projected onto the surface of the material comprises:
determining one or more points of the cutting path based on one or more dimensions of the material detected by one or more sensors associated with the laser cutting tool.

6. The laser cutting tool of claim 5, wherein the at least one laser source is configured to apply the at least one laser beam to at least one of (i) a top surface of the material or (ii) a bottom surface of the material, wherein the at least one laser source comprises a first laser source and a second laser source, and wherein controlling the at least one laser source to apply the at least one laser beam onto the material sufficient to implement a cut along the cutting path projected onto the surface of the material comprises:
causing the first laser source to apply a first laser beam to a top surface of the material; and
causing the second laser source to apply a second laser beam to a bottom surface of the material.

7. The laser cutting tool of claim 6, wherein application of the first laser beam to the top surface of the material is offset from application of the second laser beam to the bottom surface of the material in a manner sufficient to avoid both (i) application of the first laser beam to second laser source and (ii) application of the second laser beam to the first laser source.

8. The laser cutting tool of claim 1, wherein the at least one laser source comprises a plurality of laser sources, and wherein the plurality of laser sources comprise at least one of (i) a first set of two or more laser sources configured to apply a first set of two or more laser beams onto a top surface of the material and (ii) a second set of two or more laser sources configured to apply a second set of two or more laser beams onto a bottom surface of the material.

9. The laser cutting tool of claim 8, wherein individual laser sources in plurality of laser sources are configured to apply laser beams at differing focal lengths for materials having differing thicknesses.

10. The laser cutting tool of claim 1, wherein controlling the at least one laser source to apply the at least one laser beam onto the material sufficient to implement a cut along the cutting path projected onto the surface of the material comprises:
controlling one or more of a power of the at least one laser beam or a speed at which the at least one laser beam and the material move relative to each other while applying the at least one laser beam onto the material to implement the cut along the cutting path based on one or more of (i) a material type of the material, (ii) a thickness of the material, (iii) a density of the material, (iv) an absorption coefficient of the material, (v) a power of the at least one laser beam, or (vi) an indication from one or more sensors of whether the at least one laser beam has passed through a portion of the material.

11. The laser cutting tool of claim 10, wherein controlling a speed at which the at least one laser beam and the material move relative to each other while applying the at least one laser beam onto the material to implement the cut along the cutting path comprises:
controlling a speed at which at least one of (i) the at least one laser beam moves relative to the material, (ii) the laser cutting tool moves relative to the material, or (iii) the material moves relative to the laser cutting tool.

12. The laser cutting tool of claim 1, wherein controlling the at least one laser source to apply the at least one laser beam onto the material sufficient to implement a cut along the cutting path projected onto the surface of the material comprises:
while applying the at least one laser beam onto the material sufficient to implement the cut along the cutting path, detecting at least one of (i) whether the laser cutting tool has been moved relative to the material or (ii) whether the material has been moved relative to the laser cutting tool;
after detecting that the laser cutting tool has been moved relative to the material, (i) determining whether the laser cutting tool can continue to apply the at least one laser beam onto the material sufficient to implement the cut along the cutting path, (ii) after determining that the laser cutting tool can continue to apply the at least one laser beam onto the material sufficient to implement the cut along the cutting path after the laser cutting tool has been moved relative to the material, controlling application of the at least one laser beam such that the at least one laser beam continues to be applied onto to the material sufficient to implement the cut along the cutting path, and (iii) after determining that the laser cutting tool cannot continue to apply the at least one laser beam onto the material sufficient to implement the cut along the cutting path after the laser cutting tool has been moved relative to the material, shutting off the at least one laser beam; and
after detecting that the material has been moved relative to the laser cutting tool, (i) determining whether the laser cutting tool can continue to apply the at least one laser beam onto the material sufficient to implement the cut along the cutting path, (ii) after determining that the laser cutting tool can continue to apply the at least one laser beam onto the material sufficient to implement the cut along the cutting path after the material has been moved relative to the laser cutting tool, controlling application of the at least one laser beam such that the at least one laser beam continues to be applied onto to the material sufficient to implement the cut along the cutting path, and (iii) after determining that the laser cutting tool cannot continue to apply the at least one laser beam onto the material sufficient to implement the cut along the cutting path after the material has been moved relative to the laser cutting tool, shutting off the at least one laser beam.

13. The laser cutting tool of claim 1, wherein controlling the at least one laser source to apply the at least one laser beam onto the material sufficient to implement a cut along the cutting path projected onto the surface of the material comprises:
controlling application of the at least one laser beam onto the material via at least one of (i) a multi-dimensional rail system or (ii) a galvanometer.

14. The laser cutting tool of claim 1, wherein causing a cutting path to be projected onto the surface of the material comprises:
causing a design to be projected onto the surface of the material, wherein the design comprises the cutting path.

15. The laser cutting tool of claim 1, wherein the cutting path comprises one or more of (i) a cross cut, (ii) a rip cut, (iii) one or more holes, (iv) one or more notches, or (v) one or more engravings.

16. The laser cutting tool of claim 1, wherein the functions further comprise:
after the cutting path has been projected onto the surface of the material, receiving one or more modifications to the cutting path via at least one user interface associated with the laser cutting tool; and
after receiving the one or more modifications to the cutting path, generating a modified cutting path based on the one or more modifications and causing the modified cutting path to be projected onto the surface of the material.

17. The laser cutting tool of claim 1, further comprising:
a base configured to support at least a portion of the material while the laser cutting tool (i) causes the cutting path to be projected onto the surface of the material and (ii) controls the at least one laser source to apply the at least one laser beam onto the material sufficient to implement the cut along the cutting path projected onto the surface of the material; and
an arm configured to apply the at least one laser beam onto the material while at least a portion of the material is supported on the base.

18. The laser cutting tool of claim 17, wherein the at least one laser beam comprises a first laser beam and a second laser beam, wherein while at least a portion of the material is supported on the base, (i) the arm is configured to apply the first laser beam onto a top of the material and (ii) the base is configured to apply the second laser beam onto a bottom of the material.

19. The laser cutting tool of claim 17, further comprising:
at least one riving knife configured to fit within a kerf created by the at least one laser beam while implementing the cut along the cutting path projected onto the surface of the material; and
at least one beam dump configured to absorb laser power of the at least one laser source that passes through the kerf while implementing the cut along the cutting path projected onto the surface of the material.

20. The laser cutting tool of claim 1, further comprising:
a cooling system configured to pass pneumatic air across at least one laser diode of the at least one laser source and out of a nozzle at an air pressure sufficient to blow fumes and debris away from where the at least one laser beam is applied onto the material.
